(19) United States
(12) Patent Application Publication
(10) Pub. No.: US 2024/0419783 A1
(43) Pub. Date: Dec. 19, 2024

(54) SYSTEMS AND METHODS FOR COMPARTMENTALIZATION

(71) Applicant: Dover Microsystems, Inc., Wayland, MA (US)

(72) Inventor: Andrew Sutherland, Portland, OR (US)

(73) Assignee: Dover Microsystems, Inc., Wayland, MA (US)

(21) Appl. No.: 18/747,314

(22) Filed: Jun. 18, 2024

Related U.S. Application Data
(60) Provisional application No. 63/509,000, filed on Jun. 19, 2023.

(51) Int. Cl. G06F 21/53

(52) U.S. Cl. CPC G06F 21/53; G06F 2221/033

(57) ABSTRACT

Systems and methods for compartmentalization. In some embodiments, in response to receiving a compartment update request, a target compartment of a compartment transition triggering the compartment update request may be determined, and a compartment configuration corresponding to the target compartment may be loaded, wherein the compartment configuration indicates at least one address range associated with the target compartment.

### RELATED APPLICATION

This application claims the benefit under 35 U.S.C. 119 (e) of U.S. Provisional Application No. 63/509,000, entitled “SYSTEMS AND METHODS FOR COMPARTMENTALIZATION,” filed on Jun. 19, 2023, bearing Attorney Docket No. D0821.70022US00, which is incorporated herein by reference in its entirety.

### BACKGROUND

Computer security has become an increasingly urgent concern at all levels of society, from individuals to businesses to government institutions. Security professionals are constantly playing catch-up with attackers. As soon as a vulnerability is reported, security professionals rush to patch the vulnerability. Individuals and organizations that fail to patch vulnerabilities in a timely manner (e.g., due to poor governance and/or lack of resources) become easy targets for attackers.

Some security software monitors activities on a computer and/or within a network, and looks for patterns that may be indicative of an attack. Such an approach does not prevent malicious code from being executed in the first place. Often, the damage has been done by the time any suspicious pattern emerges.

### SUMMARY

In accordance with some embodiments, a computer-implemented method is provided, comprising acts of: in response to receiving a compartment update request, determining, by compartment check hardware, a target compartment of a compartment transition triggering the compartment update request; and loading, by the compartment check hardware, a compartment configuration corresponding to the target compartment, wherein the compartment configuration indicates at least one address range associated with the target compartment.

In accordance with some embodiments, a system is provided, comprising processing hardware configured to perform any of the methods described herein. The processing hardware may include one or more processors programmed by executable instructions, one or more programmable logic devices programmed by bitstreams, and/or one or more logic circuits fabricated into semiconductors.

In accordance with some embodiments, at least one computer-readable medium is provided, having stored thereon any of the bitstreams described herein.

In accordance with some embodiments, at least one computer-readable medium is provided, having stored thereon at least one netlist for any of the bitstreams and/or fabricated logic described herein.

In accordance with some embodiments, at least one computer-readable medium is provided, having stored thereon at least one hardware description that, when synthesized, produces any of the netlists described herein.

In accordance with some embodiments, at least one computer-readable medium is provided, having stored thereon any of the executable instructions described herein.

### BRIEF DESCRIPTION OF DRAWINGS

FIG. 1 shows an illustrative hardware system 100 for enforcing policies, in accordance with some embodiments.

FIG. 2 shows an illustrative software system 200 for enforcing policies, in accordance with some embodiments.

FIG. 3 shows illustrative compartment check hardware 300, in accordance with some embodiments.

FIG. 4A shows an illustrative process 400 for a compartment configuration update, in accordance with some embodiments.

FIG. 4B shows an illustrative process 450 for a compartment check, in accordance with some embodiments.

FIG. 5A shows an illustrative process 500 for generating one or more compartment configurations, in accordance with some embodiments.

FIG. 5B shows an illustrative process 520 for annotating object code, in accordance with some embodiments.

FIG. 5C shows an illustrative process 540 for initializing compartment check hardware, in accordance with some embodiments.

FIG. 6A shows an illustrative hardware block 600 implementing a policy check function, in accordance with some embodiments.

FIG. 6B shows an illustrative array 650 of bits, in accordance with some embodiments.

FIG. 7A shows an illustrative arrangement 700 of functions, in accordance with some embodiments.

FIG. 7B shows an illustrative conversion block 750, in accordance with some embodiments.

FIG. 8 shows an illustrative process 800 for selecting an encode function and a parameter, in accordance with some embodiments.

FIG. 9A shows an illustrative arrangement 900 of functions, in accordance with some embodiments.

FIG. 9B shows an illustrative output function block 910, in accordance with some embodiments.

FIG. 9C shows an illustrative array 920 of bits, in accordance with some embodiments.

FIG. 10A shows an illustrative arrangement 1000 of functions, in accordance with some embodiments.

FIG. 10B shows an illustrative conversion block 1010, in accordance with some embodiments.

FIG. 10C shows an illustrative conversion block 1020, in accordance with some embodiments.

FIG. 11 shows, schematically, an illustrative computer 1100 on which any aspect of the present disclosure may be implemented.

### DETAILED DESCRIPTION

This application may include subject matter related to that of International Patent Application No. PCT/US2020/013678, filed on Jan. 15, 2020, titled “SYSTEMS AND METHODS FOR METADATA CLASSIFICATION,” bearing Attorney Docket No. D0821.70013WO00, which is hereby incorporated by reference in its entirety.

This application may include subject matter related to that of International Application No. PCT/US2023/020132, filed on Apr. 27, 2023, entitled “SYSTEMS AND METHODS FOR ENFORCING ENCODED POLICIES,” bearing Attorney Docket No. D0821.70019WO00 which is hereby incorporated by reference in its entirety.

Many security vulnerabilities trace back to a computer architectural design where data and executable instructions are intermingled in the same memory. This intermingling allows an attacker to inject malicious code into a remote computer by disguising the malicious code as data. For instance, a program may allocate a buffer in a computer's memory to store data received via a network. If the program receives more data than the buffer can hold, but does not check the size of the received data prior to writing the data into the buffer, part of the received data would be written beyond the buffer's boundary, into adjacent memory. An attacker may exploit this behavior to inject malicious code into the adjacent memory. If the adjacent memory is allocated for executable code, the malicious code may eventually be executed by the computer.

Techniques have been proposed to make computer hardware more security aware. For instance, memory locations may be associated with metadata for use in enforcing security policies, and instructions may be checked for compliance with the security policies. For example, given an instruction executed by a processor, metadata associated with the instruction and/or metadata associated with one or more operands of the instruction may be checked to determine if the instruction is allowed. Such checking may be performed before or after the processor has finished executing the instruction. Additionally, or alternatively, appropriate metadata may be associated with an output of the instruction.

It should be appreciated that security policies are discussed above solely for purposes of illustration, as aspects of the present disclosure are not limited to enforcing any particular type of policy, or any policy at all. In some embodiments, one or more of the techniques described herein may be used to enforce one or more other types of policies (e.g., safety policies, privacy policies, etc.), in addition to, or instead of, security policies.

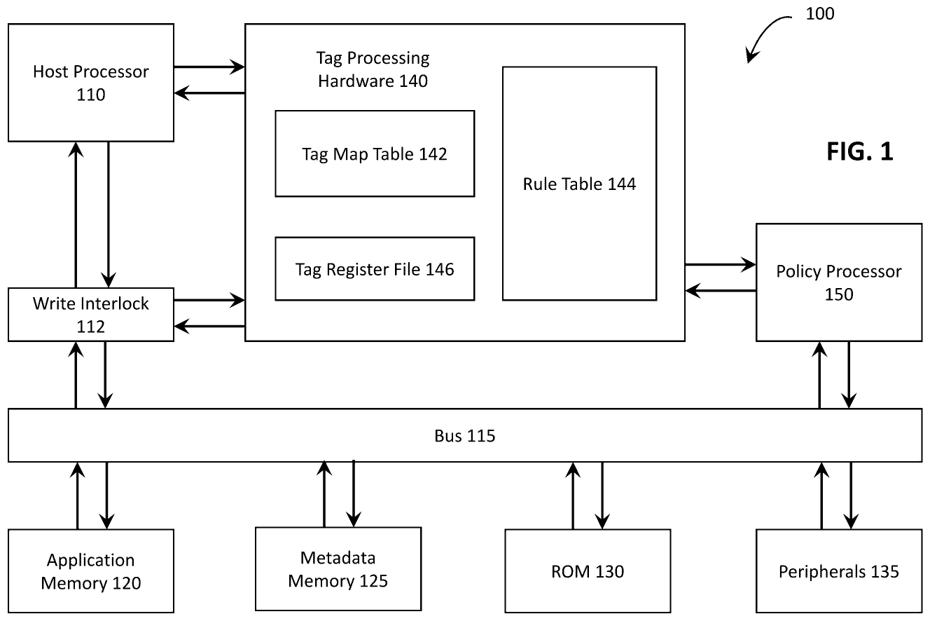

FIG. 1 shows an illustrative hardware system 100 for enforcing policies, in accordance with some embodiments. In this example, the system 100 includes a host processor 110, which may have any suitable instruction set architecture (ISA) such as a reduced instruction set computing (RISC) architecture or a complex instruction set computing (CISC) architecture. The host processor 110 may perform memory accesses via a write interlock 112. The write interlock 112 may be connected to a system bus 115 configured to transfer data between various components such as the write interlock 112, an application memory 120, a metadata memory 125, a read-only memory (ROM) 130, one or more peripherals 135, etc.

In some embodiments, data that is manipulated (e.g., modified, consumed, and/or produced) by the host processor 110 may be stored in the application memory 120. Such data may be referred to herein as “application data,” as distinguished from metadata used for enforcing policies. The latter may be stored in the metadata memory 125. It should be appreciated that application data may include data manipulated by an operating system (OS), instructions of the OS, data manipulated by one or more user applications, and/or instructions of the one or more user applications.

In some embodiments, the application memory 120 and the metadata memory 125 may be physically separate, and the host processor 110 may have no access to the metadata memory 125. In this manner, even if an attacker succeeds in injecting malicious code into the application memory 120 and causing the host processor 110 to execute the malicious code, the metadata memory 125 may not be affected. However, it should be appreciated that aspects of the present disclosure are not limited to storing application data and metadata on physically separate memories.

Additionally, or alternatively, metadata may be stored in the same memory as application data, and a memory management component may be used to implement an appropriate protection scheme to prevent instructions executing on the host processor 110 from modifying the metadata. Additionally, or alternatively, metadata may be intermingled with application data in the same memory, and one or more policies may be used to protect the metadata.

In some embodiments, tag processing hardware 140 may be provided to ensure that instructions executed by the host processor 110 comply with one or more policies. The tag processing hardware 140 may operate at hardware speed. For instance, the tag processing hardware 140 may be implemented using one or more programmable logic devices, such as field-programmable gate arrays (FPGAs) programed by bitstreams, and/or one or more logic circuits fabricated into semiconductors, and therefore may be capable of checking instructions at a speed that is comparable to a speed at which the instructions are executed by the host processor 110. Such checking may be performed for an instruction before or after the host processor 110 finishes executing the instruction.

In some embodiments, the tag processing hardware 140 may, on average, check one instruction for every N instructions executed by the host processor 110, where N may be 1, 2, 3, 4, 5, . . . , 10, . . . . The number N may be chosen based on a proportion of instructions to be checked. As an example, if every instruction is to be checked, then N may be 1.

Additionally, or alternatively, an upperbound may be provided for a measure of divergence. As an example, the tag processing hardware 140 may include a queue for storing instructions to be checked. Such a queue may, at any given time, store at most M instructions, where M may be 10, . . . 50, . . . , 100, . . . , 500, . . . . Thus, the tag processing hardware 140 may be at most M instructions behind the host processor 110 at any given time.

The tag processing hardware 140 may include any suitable component or combination of components. For instance, the tag processing hardware 140 may include a tag map table 142 that maps addresses in the application memory 120 to addresses in the metadata memory 125. For example, the tag map table 142 may map an address X in the application memory 120 to an address Y in the metadata memory 125. A value stored at the address Y may be referred to herein as a “metadata tag.”

In some embodiments, a value stored at the address Y may in turn be an address Z. Such indirection may be repeated one or more times, and may eventually lead to a data structure in the metadata memory 125 for storing metadata. Such metadata, as well as any intermediate address (e.g., the address Z), may also be referred to herein as “metadata tags.”

It should be appreciated that aspects of the present disclosure are not limited to a tag map table that stores addresses in a metadata memory. In some embodiments, a tag map table entry itself may store metadata, so that the tag processing hardware 140 may be able to access the metadata without performing a memory operation.

In some embodiments, a tag map table entry may store a selected bit pattern, where a first portion of the bit pattern may encode metadata, and a second portion of the bit pattern may encode an address in a metadata memory where further metadata may be stored. This may provide a desired balance between speed and expressivity. For instance, the tag processing hardware 140 may be able to check certain policies quickly, using only the metadata stored in the tag map table entry itself. For other policies with more complex rules, the tag processing hardware 140 may access the further metadata stored in the metadata memory 125.

Referring again to the example of FIG. 1, by mapping application memory addresses to metadata memory addresses, the tag map table 142 may create an association between application data and metadata. In one example, metadata stored at the metadata memory address Y and thus associated with application data stored at the application memory address X may indicate that the application data may be readable, writable, and/or executable. In another example, metadata stored at the metadata memory address Y and thus associated with application data stored at the application memory address X may indicate a type of the application data (e.g., integer, pointer, 16-bit word, 32-bit word, etc.). Depending on a policy to be enforced, any suitable metadata relevant for the policy may be associated with application data.

In some embodiments, a metadata memory address Z may be stored at the metadata memory address Y. Metadata to be associated with the application data stored at the application memory address X may be stored at the metadata memory address Z, instead of (or in addition to) the metadata memory address Y. For instance, a binary representation of a metadata label {RED} may be stored at the metadata memory address Z. By storing the metadata memory address Z in the metadata memory address Y, the application data stored at the application memory address X may be tagged with the metadata label {RED}.

In this manner, the binary representation of the metadata label {RED} may be stored only once in the metadata memory 125. For instance, if application data stored at another application memory address X′ is also to be tagged with {RED}, the tag map table 142 may map the application memory address X′ to a metadata memory address Y′ where the metadata memory address Z is also stored.

Moreover, in this manner, tag update may be simplified. For instance, if the application data stored at the application memory address X is to be tagged with a metadata label {BLUE} at a subsequent time, a metadata memory address Z′ may be written at the metadata memory address Y, to replace the metadata memory address Z, and a binary representation of the metadata label {BLUE} may be stored at the metadata memory address Z′.

Thus, the inventor has recognized and appreciated that a chain of metadata memory addresses of any suitable length N may be used for tagging, including N=0 (e.g., where a binary representation of a metadata label is stored at the metadata memory address Y itself).

The association between application data and metadata (also referred to herein as “tagging”) may be done at any suitable level of granularity, and/or variable granularity. For instance, tagging may be done on a word-by-word basis. Additionally, or alternatively, a region in memory may be mapped to a single metadata tag, so that all words in that region are associated with the same metadata. This may advantageously reduce a size of the tag map table 142 and/or the metadata memory 125. For example, a single metadata tag may be maintained for an entire address range, as opposed to maintaining multiple metadata tags corresponding, respectively, to different addresses in the address range.

In some embodiments, the tag processing hardware 140 may be configured to apply one or more rules to metadata associated with an instruction and/or metadata associated with one or more operands of the instruction to determine if the instruction is allowed. For instance, the host processor 110 may fetch and execute an instruction (e.g., a store instruction), and may queue a result of executing the instruction (e.g., a value to be stored) into the write interlock 112. Before the result is written into the application memory 120, the host processor 110 may send, to the tag processing hardware 140, an instruction type (e.g., opcode), a memory address from which the instruction is fetched, one or more memory addresses referenced by the instruction, and/or one or more register identifiers. Such a register identifier may identify a register used by the host processor 110 in executing the instruction, such as a register for storing an operand or a result of the instruction.

In some embodiments, destructive load instructions may be queued in addition to, or instead of, store instructions. For instance, subsequent instructions attempting to access a target address of a destructive load instruction may be queued in a designated memory region. If and when it is determined that the destructive load instruction is allowed, the queued instructions may be loaded for execution.

In some embodiments, a destructive load instruction may be executed, and data read from a target address may be captured in a buffer. If and when it is determined that the destructive load instruction is allowed, the data captured in the buffer may be discarded. If and when it is determined that the destructive load instruction is not allowed, the data captured in the buffer may be restored to the target address. Additionally, or alternatively, a subsequent read may be serviced by the buffered data.

It should be appreciated that aspects of the present disclosure are not limited to performing metadata processing on instructions that a host processor has finished executing (e.g., instructions that have been retired by the host processor's execution pipeline). In some embodiments, metadata processing may be performed on instructions before, during, and/or after the host processor's execution pipeline. Thus, an instruction executed by the host processor may be an instruction that is queued for execution, being executed within a pipeline, or retired.

In some embodiments, given an address received from the host processor 110 (e.g., an address from which an instruction is fetched, or an address referenced by an instruction), the tag processing hardware 140 may use the tag map table 142 to identify a corresponding metadata tag. Additionally, or alternatively, for a register identifier received from the host processor 110, the tag processing hardware 140 may access a metadata tag from a tag register file 146.

In some embodiments, if an application memory address does not have a corresponding entry in the tag map table 142, the tag processing hardware 140 may send a query to a policy processor 150. The query may include the application memory address, and the policy processor 150 may return a metadata tag for that application memory address. Additionally, or alternatively, the policy processor 150 may create a new tag map table entry for an address range including the application memory address. In this manner, the appropriate metadata tag may be made available, for future reference, in the tag map table 142 in association with the application memory address.

In some embodiments, the tag processing hardware 140 may send a query to the policy processor 150 to check if an instruction executed by the host processor 110 is allowed. The query may include one or more inputs, such as an instruction type (e.g., opcode) of the instruction, a metadata tag for a program counter, a metadata tag for an application memory address from which the instruction is fetched (e.g., a word in memory to which the program counter points), a metadata tag for a register in which an operand of the instruction is stored, and/or a metadata tag for an application memory address referenced by the instruction.

In one example, the instruction may be a load instruction, and an operand of the instruction may be an application memory address from which application data is to be loaded. The query to the policy processor 150 may include, among other things, a metadata tag for a register in which the address is stored, as well as a metadata tag for an application memory location referenced by the address.

In another example, the instruction may be an arithmetic instruction, and there may be one or more operands stored in one or more respective registers. The query to the policy processor 150 may include, among other things, a metadata tag for each of the one or more registers.

It should be appreciated that aspects of the present disclosure are not limited to performing metadata processing on a single instruction at a time. In some embodiments, multiple instructions in an ISA of the host processor 110 may be checked together as a bundle, for example, via a single query to the policy processor 150. Such a query may include sufficient information to allow the policy processor 150 to check all of the instructions in the bundle.

Similarly, a CISC instruction, which may include, semantically, multiple operations, may be checked via a single query to the policy processor 150. Such a query may include sufficient information to allow the policy processor 150 to check all of the constituent operations within the CISC instruction.

In some embodiments, the tag processing hardware 140 may transform one or more opcodes of an ISA used by the host processor 110 into one or more opcodes in an ISA designed for metadata processing. For instance, the tag processing hardware 140 may transform multiple opcodes in the ISA used by the host processor 110 (e.g., add, subtract, multiply, divide, square root, and, or, not, etc.) into a common opcode in the ISA designed for metadata processing (e.g., math). This common opcode may be used to query the policy processor 150, in addition to, or instead of, an opcode in the ISA used by the host processor 110.

The inventor has recognized and appreciated that, by having an ISA designated for metadata processing, a number of different input patterns to be handled by the tag processing hardware 140 may advantageously be reduced. Furthermore, a policy written against the ISA designated for metadata processing may be portable across ISAs of different host processors (e.g., by configuring the tag processing hardware 140 to provide a suitable transformation from such an ISA to the ISA designated for metadata processing). However, it should be appreciated that aspects of the present disclosure are not limited to having an ISA designated for metadata processing.

In some embodiments, the policy processor 150 may have loaded therein one or more policies. In response to a query from the tag processing hardware 140, the policy processor 150 may evaluate one or more of the policies to determine if an instruction giving rise to the query is allowed. For instance, the tag processing hardware 140 may send an interrupt signal to the policy processor 150, along with one or more inputs relating to the instruction (e.g., as described above). The policy processor 150 may store the inputs of the query in a working memory (e.g., in one or more queues) for immediate or deferred processing. For example, the policy processor 150 may prioritize processing of queries in some suitable manner (e.g., based on a priority flag associated with each query).

In some embodiments, the policy processor 150 may evaluate one or more policies on one or more inputs (e.g., one or more input metadata tags) to determine if an instruction is allowed. If the instruction is not allowed, the policy processor 150 may so notify the tag processing hardware 140. If the instruction is allowed, the policy processor 150 may compute one or more outputs (e.g., one or more output metadata tags) to be returned to the tag processing hardware 140.

As one example, the instruction may be a store instruction, and the policy processor 150 may compute an output metadata tag for an application memory address to which application data is to be stored. As another example, the instruction may be an arithmetic instruction, and the policy processor 150 may compute an output metadata tag for a register storing a result of executing the arithmetic instruction.

In some embodiments, the policy processor 150 may be programmed to perform one or more tasks in addition to, or instead of, those relating to evaluation of policies. For instance, the policy processor 150 may perform tasks relating to tag initialization, boot loading, application loading, memory management (e.g., garbage collection) for the metadata memory 125, logging, debugging support, and/or interrupt processing. One or more of these tasks may be performed in the background (e.g., between servicing queries from the tag processing hardware 140).

In some embodiments, the policy processor 150 may operate at software speed. For instance, the policy processor 150 may include a processor programmed by executable instructions to implement one or more of the functionalities described above. Thus, it may take hundreds, or even thousands, of processor cycles to check one instruction executed by the host processor 110.

In some embodiments, the tag processing hardware 140 may include a rule table 144 for mapping one or more inputs to a decision and/or one or more outputs. For instance, a query into the rule table 144 may be similarly constructed as a query to the policy processor 150 to check if an instruction executed by the host processor 110 is allowed. If there is a match, the rule table 144 may output a decision as to whether the instruction is allowed, and/or one or more output metadata tags (e.g., as described above in connection with the policy processor 150). Such a mapping in the rule table 144 may be created using a query response from the policy processor 150. However, that is not required. In some embodiments, one or more mappings may be installed into the rule table 144 ahead of time.

In some embodiments, the rule table 144 may be used to provide a performance enhancement. For instance, before querying the policy processor 150 with one or more input metadata tags, the tag processing hardware 140 may first query the rule table 144 with the one or more input metadata tags. In case of a match, the tag processing hardware 140 may proceed with a decision and/or one or more output metadata tags from the rule table 144, without querying the policy processor 150. This may provide a significant speedup.

If, on the other hand, there is no match in the rule table 144, the tag processing hardware 140 may query the policy processor 150, and may install a response from the policy processor 150 into the rule table 144 for potential future use. Thus, the rule table 144 may function as a cache. However, it should be appreciated that aspects of the present disclosure are not limited to implementing the rule table 144 as a cache.

In some embodiments, the tag processing hardware 140 may form a hash key based on one or more input metadata tags, and may present the hash key to the rule table 144. If there is no match, the tag processing hardware 140 may send an interrupt signal to the policy processor 150. In response to the interrupt signal, the policy processor 150 may fetch metadata from one or more input registers (e.g., where the one or more input metadata tags are stored), process the fetched metadata, and write one or more results to one or more output registers. The policy processor 150 may then signal to the tag processing hardware 140 that the one or more results are available.

In some embodiments, if the tag processing hardware 140 determines that an instruction (e.g., a store instruction) is allowed (e.g., based on a match in the rule table 144, or no match in the rule table 144, followed by a response from the policy processor 150 indicating no policy violation has been found), the tag processing hardware 140 may indicate to the write interlock 112 that a result of executing the instruction (e.g., a value to be stored) may be written to memory.

Additionally, or alternatively, the tag processing hardware 140 may update the metadata memory 125, the tag map table 142, and/or the tag register file 146 with one or more output metadata tags (e.g., as received from the rule table 144 or the policy processor 150). As one example, for a store instruction, the metadata memory 125 may be updated based on an address translation by the tag map table 142. For instance, an application memory address referenced by the store instruction may be used to look up a metadata memory address from the tag map table 142, and metadata received from the rule table 144 or the policy processor 150 may be stored to the metadata memory 125 at the metadata memory address.

As another example, where metadata to be updated is stored in an entry in the tag map table 142 (as opposed to being stored in the metadata memory 125), that entry in the tag map table 142 may be updated.

As another example, for an arithmetic instruction, an entry in the tag register file 146 corresponding to a register used by the host processor 110 for storing a result of executing the arithmetic instruction may be updated with an appropriate metadata tag.

In some embodiments, if the tag processing hardware 140 determines that the instruction represents a policy violation (e.g., based on no match in the rule table 144, followed by a response from the policy processor 150 indicating a policy violation has been found), the tag processing hardware 140 may indicate to the write interlock 112 that a result of executing the instruction should be discarded, instead of being written to memory.

Additionally, or alternatively, the tag processing hardware 140 may send an interrupt to the host processor 110. In response to receiving the interrupt, the host processor 110 may switch to any suitable violation processing code. For example, the host processor 100 may halt, reset, log the violation and continue, perform an integrity check on application code and/or application data, notify an operator, etc.

In some embodiments, the rule table 144 may be implemented with a hash function and a designated portion of a memory (e.g., the metadata memory 125). For instance, a hash function may be applied to one or more inputs to the rule table 144 to generate an address in the metadata memory 125. A rule entry corresponding to the one or more inputs may be stored to, and/or retrieved from, that address in the metadata memory 125. Such an entry may include the one or more inputs and/or one or more corresponding outputs, which may be computed from the one or more inputs at run time, load time, link time, or compile time.

In some embodiments, the tag processing hardware 140 may include one or more configuration registers. Such a register may be accessible (e.g., by the policy processor 150) via a configuration interface of the tag processing hardware 140. In some embodiments, the tag register file 146 may be implemented as configuration registers.

Additionally, or alternatively, there may be one or more application configuration registers and/or one or more metadata configuration registers. An application configuration register may be accessible by the host processor 110 and/or the policy processor 150, whereas a metadata configuration register may only be accessible by the policy processor 150. In this manner, software code executing on the host processor 110 may not have access to the metadata configuration register, and therefore may not be able to interfere with metadata processing.

Although certain details of implementation are described in connection with the example of FIG. 1, it should be appreciated that aspects of the present disclosure are not limited to using any particular component, or combination of components, or to any particular arrangement of components. For instance, in some embodiments, one or more functionalities of the policy processor 150 may be performed by the host processor 110. As an example, the host processor 110 may have different operating modes, such as a user mode for user applications and a privileged mode for an operating system. Policy-related code (e.g., tagging, evaluating policies, etc.) may run in the same privileged mode as the operating system, or a different privileged mode (e.g., with even more protection against privilege escalation).

Additionally, or alternatively, one or more functionalities implemented in software (e.g., via instructions executed by a processor, or otherwise at software speed) may instead be implemented in hardware (e.g., via programmable and/or fabricated logic, or otherwise at hardware speed), and/or vice versa. For instance, one or more functionalities implemented by the policy processor 150 may instead be implemented by the tag processing hardware 140, and/or vice versa.

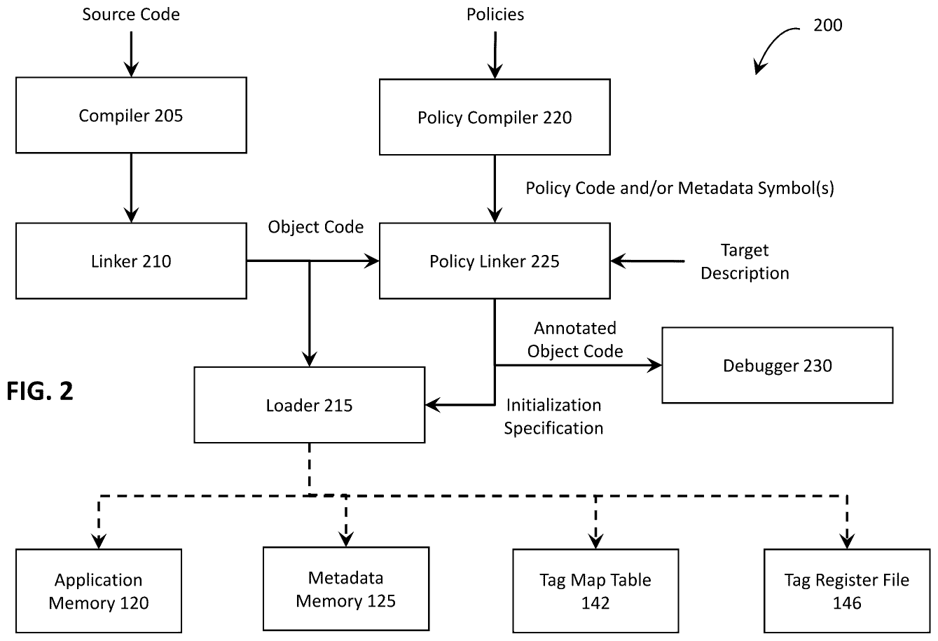

FIG. 2 shows an illustrative software system 200 for enforcing policies, in accordance with some embodiments. For instance, the software system 200 may be programmed to generate executable code and/or load the executable code into the illustrative hardware system 100 in the example of FIG. 1.

In the example of FIG. 2, the software system 200 includes a software toolchain having a compiler 205, a linker 210, and a loader 215. The compiler 205 may be programmed to process source code into executable code, where the source code may be in a higher-level language and the executable code may be in a lower-level language. The linker 210 may be programmed to combine multiple object files generated by the compiler 205 into a single object file to be loaded by the loader 215 into memory (e.g., the illustrative application memory 120 in the example of FIG. 1). Although not shown, the object file output by the linker 210 may be converted into a suitable format and stored in persistent storage, such as flash memory, hard disk, read-only memory (ROM), etc. The loader 215 may retrieve the object file from the persistent storage, and load the object file into random-access memory (RAM).

In some embodiments, the compiler 205 may be programmed to generate information for use in enforcing policies. For instance, as the compiler 205 translates source code into executable code, the compiler 205 may generate information regarding data types, program semantics and/or memory layout. As one example, the compiler 205 may be programmed to mark a boundary between one or more instructions of a function and one or more instructions that implement calling convention operations (e.g., passing one or more parameters from a caller function to a callee function, returning one or more values from the callee function to the caller function, storing a return address to indicate where execution is to resume in the caller function's code when the callee function returns control back to the caller function, etc.). Such boundaries may be used, for instance, during initialization to tag certain instructions as function prologue or function epilogue. At run time, a stack policy may be enforced so that, as function prologue instructions execute, certain locations in a call stack (e.g., where a return address is stored) may be tagged as FRAME locations, and as function epilogue instructions execute, the FRAME metadata tags may be removed. The stack policy may indicate that instructions implementing a body of the function (as opposed to function prologue and function epilogue) only have read access to FRAME locations. This may prevent an attacker from gaining control by overwriting a return address.

As another example, the compiler 205 may be programmed to perform control flow analysis, for instance, to identify one or more control transfer points and respective destinations. Such information may be used in enforcing a control flow policy.

As yet another example, the compiler 205 may be programmed to perform type analysis, and may apply type labels (e.g., Pointer, Integer, Floating-Point Number, etc.) to entities in object code output by the compiler 205. Such information may be used to enforce a policy that prevents misuse (e.g., using a floating-point number as a pointer). In some instances, type labels may be applied to symbols representing the entities. Additionally, or alternatively, type labels may be stored in a manner that associates the type labels with the entities. For instance, a type label may be stored in a manner that associates the type label with a relative address of an entity in the object code.

Although not shown in FIG. 2, the software system 200 may, in some embodiments, include a binary analysis component programmed to take, as input, object code produced by the linker 210 (as opposed to source code), and perform one or more analyses similar to those performed by the compiler 205 (e.g., control flow analysis, type analysis, etc.).

In the example of FIG. 2, the software system 200 further includes a policy compiler 220 and a policy linker 225. The policy compiler 220 may be programmed to translate one or more policies written in a policy language into policy code. For instance, the policy compiler 220 may output policy code in C or some other suitable programming language. Additionally, or alternatively, the policy compiler 220 may output one or more metadata labels referenced by the one or more policies.

In some embodiments, a metadata label may, at initialization, be associated with one or more memory locations, registers, and/or other machine state of a target system. For instance, the metadata label may be resolved into a binary representation of metadata to be loaded into a metadata memory or some other hardware storage (e.g., registers) of the target system, and an association may be created via a tag map table entry (e.g., as described in connection with the illustrative tag map table 142 in the example of FIG. 1). As discussed above, such a binary representation of metadata, or a pointer to a location at which the binary representation is stored, may be referred to herein as a “metadata tag.”

It should be appreciated that aspects of the present disclosure are not limited to resolving metadata labels at load time. In some embodiments, one or more metadata labels may be resolved statically (e.g., at compile time or link time). For example, the policy compiler 220 may process one or more applicable policies, and resolve one or more metadata labels defined by the one or more policies into a statically-determined binary representation. Additionally, or alternatively, the policy linker 225 may resolve one or more metadata labels into a statically-determined binary representation, or a pointer to a data structure storing a statically-determined binary representation. The inventor has recognized and appreciated that resolving metadata labels statically may advantageously reduce load time processing. However, aspects of the present disclosure are not limited to resolving metadata labels in any particular manner.

In some embodiments, the policy linker 225 may be programmed to process object code (e.g., as output by the linker 210), policy code (e.g., as output by the policy compiler 220), and/or a target description, to output an initialization specification. The initialization specification may be used by the loader 215 to securely initialize a target system having one or more hardware components (e.g., the illustrative hardware system 100 in the example of FIG. 1) and/or one or more software components (e.g., an operating system, one or more user applications, etc.).

In some embodiments, a target description may include descriptions of a plurality of named entities. A named entity may represent a component of a target system. As one example, a named entity may represent a hardware component, such as a configuration register, a program counter, a register file, a timer, a status flag, a memory transfer unit, an input/output device, etc. As another example, a named entity may represent a software component, such as a function, a module, a driver, a service routine, etc.

In some embodiments, the policy linker 225 may be programmed to search the target description to identify one or more entities to which a policy pertains. For instance, the policy may map certain entity names to corresponding metadata labels, and the policy linker 225 may search the target description to identify entities having those entity names.

Given an entity matching a certain entity name, the policy linker 225 may identify a description of the entity from the target description, and use the description to annotate, with one or more appropriate metadata labels, the object code output by the linker 210. For instance, the policy linker 225 may apply a Read label to a .rodata section of an Executable and Linkable Format (ELF) file, a Read label and a Write label to a .data section of the ELF file, and an Execute label to a .text section of the ELF file. Such information may be used to enforce a policy for memory access control and/or executable code protection (e.g., by checking read, write, and/or execute privileges).

It should be appreciated that aspects of the present disclosure are not limited to providing a target description to the policy linker 225. In some embodiments, a target description may be provided to the policy compiler 220, in addition to, or instead of, the policy linker 225. The policy compiler 220 may check the target description for errors. For instance, if an entity referenced in a policy does not exist in the target description, an error may be flagged by the policy compiler 220.

Additionally, or alternatively, the policy compiler 220 may search the target description for entities that are relevant for one or more policies to be enforced, and may produce a filtered target description that includes entities descriptions for the relevant entities only. For instance, the policy compiler 220 may match an entity name in an “init” statement of a policy to an entity description in the target description, and may remove from the target description (or simply ignore) entity descriptions with no corresponding “init” statement.

In some embodiments, the loader 215 may initialize a target system based on an initialization specification produced by the policy linker 225. For instance, referring to the example of FIG. 1, the loader 215 may load data and/or instructions into the application memory 120, and may use the initialization specification to identify metadata labels associated with the data and/or instructions being loaded into the application memory 120. The loader 215 may resolve the metadata labels in the initialization specification into respective binary representations, store the binary representations in a metadata memory (e.g., the illustrative metadata memory 125) and/or a register file (e.g., the illustrative tag register file 146), and/or create associations via tag map table entries (e.g., as described in connection with the illustrative tag map table 142).

However, as discussed above, it should be appreciated that aspects of the present disclosure are not limited to resolving metadata labels at load time. In some embodiments, a universe of metadata labels may be known during policy compilation or linking, and therefore metadata labels may be resolved at compile time (e.g., by the policy compiler 220) or at link time (e.g., by the policy linker 225), and may be stored in the initialization specification. This may advantageously reduce load time processing of the initialization specification.

In some embodiments, the policy linker 225 and/or the loader 215 may maintain a mapping of binary representations of metadata back to human-readable versions of metadata labels. Such a mapping may be used, for example, by a debugger 230. For instance, in some embodiments, the debugger 230 may be provided to display a human-readable version of an initialization specification, which may list one or more entities and, for each entity, a metadata label (e.g., a set of one or more metadata symbols) associated with the entity.

Additionally, or alternatively, the debugger 230 may be programmed to display assembly code annotated with metadata labels, such as assembly code generated by disassembling object code annotated with metadata labels. During debugging, the debugger 230 may halt a program during execution, and allow inspection of entities and/or metadata tags associated with the entities, in human-readable form. For instance, the debugger 230 may allow inspection of an entity involved in a policy violation and/or one or more metadata tags that caused the policy violation. The debugger 230 may do so using the mapping of binary representations of metadata back to metadata labels.

In some embodiments, a conventional debugging tool may be extended to allow review of issues related to policy enforcement, for example, as described above. Additionally, or alternatively, a stand-alone policy debugging tool may be provided.

In some embodiments, the loader 215 may load binary representations of metadata labels into the metadata memory 125, and may record a mapping between application memory addresses and metadata memory addresses in the tag map table 142. For instance, the loader 215 may create an entry in the tag map table 142 that maps an application memory address where an instruction is stored in the application memory 120, to a metadata memory address where metadata associated with the instruction is stored in the metadata memory 125. Additionally, or alternatively, the loader 215 may store metadata in the tag map table 142 itself (as opposed to the metadata memory 125), to allow access to such metadata without performing any memory operation.

In some embodiments, the loader 215 may initialize the tag register file 146 in addition to, or instead of, the tag map table 142. For instance, the tag register file 146 may include a plurality of registers corresponding, respectively, to a plurality of entities. The loader 215 may identify, from the initialization specification, metadata associated with the entities, and store the metadata in the respective registers in the tag register file 146.

Referring again to the example of FIG. 1, the loader 215 may, in some embodiments, load policy code (e.g., as output by the policy compiler 220) into the metadata memory 125 for execution by the policy processor 150. Additionally, or alternatively, a separate memory (not shown in FIG. 1) may be provided for use by the policy processor 150, and the loader 215 may load policy code and/or associated data into the separate memory.

In some embodiments, upon completion of loading of metadata and policy code, the loader 215 may notify the illustrative tag processing hardware 140 in the example of FIG. 1. In response, the tag processing hardware 140 may begin enforcing one or more policies according to the metadata and the policy code.

In some embodiments, a metadata label may be based on multiple metadata symbols. For instance, an entity may be subject to multiple policies, and may therefore be associated with different metadata symbols corresponding, respectively, to the different policies. The inventor has recognized and appreciated that it may be desirable that metadata labels consisting of the same set of metadata symbols be resolved by the loader 215 to the same binary representation (which may be referred to herein as a “canonical” representation). For instance, a metadata label {A, B, C} and a metadata label {B, A, C} may be resolved by the loader 215 to the same binary representation. In this manner, metadata labels that are syntactically different but semantically equivalent may have the same binary representation.

The inventor has further recognized and appreciated it may be desirable to ensure that a binary representation of metadata is not duplicated in metadata storage. For instance, as described above, the illustrative rule table 144 in the example of FIG. 1 may map input metadata tags to output metadata tags, and, in some embodiments, the input metadata tags may be metadata memory addresses where binary representations of metadata are stored, as opposed to the binary representations themselves. The inventor has recognized and appreciated that if the same binary representation of metadata is stored at two different metadata memory addresses X and Y, the rule table 144 may not recognize an input pattern having the metadata memory address Y as matching a stored mapping having the metadata memory address X. This may result in a large number of rule misses, which may degrade system performance.

Moreover, the inventor has recognized and appreciated that having a one-to-one correspondence between binary representations of metadata and their storage locations may facilitate metadata comparison. For instance, equality between two pieces of metadata may be determined simply by comparing metadata memory addresses, as opposed to comparing binary representations of metadata. This may result in significant performance improvement, especially where the binary representations are large (e.g., many metadata symbols packed into a single metadata label).

Accordingly, in some embodiments, the loader 215 may, prior to storing a binary representation of metadata (e.g., into the metadata memory 125), check if the binary representation of metadata has already been stored. If the binary representation of metadata has already been stored, instead of storing it again at a different storage location, the loader 215 may refer to the existing storage location. Such a check may be done at startup and/or when a program is loaded subsequent to startup (with or without dynamic linking).

Additionally, or alternatively, a similar check may be performed when a binary representation of metadata is created as a result of evaluating one or more policies (e.g., by the policy processor 150). If the binary representation of metadata has already been stored, a reference to the existing storage location may be used (e.g., installed in the rule table 144).

In some embodiments, the loader 215 may create a hash table mapping hash values to storage locations. Before storing a binary representation of metadata, the loader 215 may use a hash function to reduce the binary representation of metadata into a hash value, and check if the hash table already contains an entry associated with the hash value. If so, the loader 215 may determine that the binary representation of metadata has already been stored, and may retrieve, from the hash table entry, information relating to the binary representation of metadata (e.g., a pointer to the binary representation of metadata, or a pointer to that pointer).

If the hash table does not already contain an entry associated with the hash value, the loader 215 may store the binary representation of metadata (e.g., to a register or a location in a metadata memory), create a new entry in the hash table in association with the hash value, and store appropriate information in the new entry (e.g., a register identifier, a pointer to the binary representation of metadata in the metadata memory, a pointer to that pointer, etc.).

However, it should be appreciated that aspects of the present disclosure are not limited to using a hash table to keep track of binary representations of metadata that have already been stored. Additionally, or alternatively, other data structures may be used, such as a graph data structure, a sorted list, an unsorted list, etc. Any suitable data structure or combination of data structures may be selected based on any suitable criterion or combination of criteria, such as access time, memory usage, etc.

It should be appreciated that the techniques introduced above and/or described in greater detail below may be implemented in any of numerous ways, as these techniques are not limited to any particular manner of implementation. Examples of implementation details are provided herein solely for purposes of illustration. Furthermore, the techniques disclosed herein may be used individually or in any suitable combination, as aspects of the present disclosure are not limited to any particular technique or combination of techniques.

For instance, while examples are described herein that include a compiler (e.g., the illustrative compiler 205 and/or the illustrative policy compiler 220 in the example of FIG. 2), it should be appreciated that aspects of the present disclosure are not limited to using a compiler. In some embodiments, a software toolchain may be implemented as an interpreter. For example, a lazy initialization scheme may be implemented, where one or more default labels (e.g., {DEFAULT}, {PLACEHOLDER}, etc.) may be used for tagging at startup, and a policy processor (e.g., the illustrative policy processor 150 in the example of FIG. 1) may evaluate one or more policies and replace the one or more default labels in a just-in-time manner.

As discussed above, many security vulnerabilities arise from memory safety issues such as buffer overflow. Accordingly, in some embodiments, one or more policies are provided for memory protection. For instance, a read-write-execute (RWX) policy may be provided to set access permissions for memory locations.

In some embodiments, three metadata symbols, R, W, and X, may be declared in the RWX policy to represent, respectively, read, write, and execute permissions.

Additionally, or alternatively, the RWX policy may include one or more policy rules. For instance, the RWX policy may include the following rules written in a policy language, where + and − indicate, respectively, presence and absence of a metadata symbol.

```
RWX =
rule_1(op == [LOAD], code == [−R, −W, +X], env == [−R, −W, −X],
  addr == [−R, −W, −X], val == [−R, −W, −X], mem == [+R, −W, −X]
  −> env = env)
\hat{ } rule_2(op == [LOAD], code == [−R, −W, +X], env == [−R, −W, −X],
  addr == [−R, −W, −X], val == [−R, −W, −X], mem == [+R, +W, −X]
  −> env = env)
\hat{ } rule_3(op == [STORE], code == [−R, −W, +X], env == [−R, −W, −X],
  addr == [−R, −W, −X], val == [−R, −W, −X], mem == [+R, +W, −X]
  −> env = env)
\hat{ } rule_4(op == [−LOAD, −STORE], code == [−R, −W, +X], env ==
[−R, −W, −X],
  addr == [−R, −W, −X], val == [−R, −W, −X], mem == [−R, −W, −X]
  −> env = env)
```

In some embodiments, the illustrative policy compiler 220 in the example of FIG. 2 may analyze one or more policy rules to identify one or more valid combinations of metadata symbols. For instance, a combination indicated in an initialization statement may be considered valid. Additionally, or alternatively, a combination indicated in a policy rule output may be considered valid. Other combinations may be considered invalid.

In the above example, { }, {R}, {R, W}, and {X} are valid combinations, while other combinations are invalid. Thus, the RWX policy may have four possible metadata labels.

In the above example, each rule has six input slots.
The input slot op may correspond to an instruction type, such as LOAD, STORE, or (which may match any instruction type).
The input slot code may correspond to a metadata label associated with an instruction (e.g., a metadata label associated with a memory location from which the instruction is fetched).
The input slot env may correspond to a metadata label associated with a state of a host processor. Such a state may include one or more registers, such as a program counter, a control and status register, etc.
The input slot addr may correspond to a metadata label associated with a memory address used by an instruction (e.g., a metadata label associated with a register storing a memory address referencing a memory location from/to which data is to be loaded/stored).
The input slot val may correspond to a metadata label associated with a register used by an instruction (e.g., a metadata label associated with a register holding data to be stored to memory).
The input slot mem may correspond to a metadata label associated with a memory location referenced by an instruction (e.g., a memory location from/to which data is to be loaded/stored).

The policy rules in the above example may be described as follows.
1) The first policy rule may indicate that a load instruction is allowed if: (i) a memory location from which the load instruction is fetched is associated with the metadata label {X} (executable), and (ii) a memory location from which data is to be loaded is associated with the metadata label {R} (read only).
2) The second policy rule may indicate that a load instruction is allowed if: (i) a memory location from which the load instruction is fetched is associated with the metadata label {X} (executable), and (ii) a memory location from which data is to be loaded is associated with the metadata label {R, W} (read and write).
3) The third policy rule may indicate that a store instruction is allowed if: (i) a memory location from which the load instruction is fetched is associated with the metadata label {X} (executable), and (ii) a memory location to which data is to be stored is associated with the metadata label {R, W} (read and write).
4) The fourth policy rule may indicate that, if an instruction does not match any of the three rules above, then the instruction is allowed if: (i) the instruction is neither a load instruction nor a store instruction, and (ii) a memory location from which the instruction is fetched is associated with the metadata label {X} (executable).
5) If an instruction does not match any of the four rules above, the instruction may be flagged as a policy violation.

Thus, when enforced (e.g., by the illustrative tag processing hardware 140 in the example of FIG. 1), the RWX policy in this example may protect a memory location from accesses that are not permitted. For instance, the RWX policy may disallow an instruction that attempts to write to a memory location that is tagged as being read only.

However, the RWX policy may not be able to provide more fine-grained access control. For instance, the RWX may not be able to allow a certain program to access a certain memory location, while preventing other programs from doing the same.

As an example, consider the following program with a global variable, password_accepted, and two functions, get_password and set_password. It may be desirable to allow the functions get_password and set_password to access a memory location where the global variable password_accepted is stored, while preventing other functions, such as buggy_code, from doing the same.

```
int password_accepted = 0;
bool get_password ( )
{
  if password_accepted == 1
  then
    Return true;
  else
    Return false;
}
bool set_password (bool val)
{
  if val
  then
    password_accepted = 1;
  else
    password_accepted = 0;
}
// buggy_code should not have access to global memory where
// password_accepted is stored
void buggy_code (int offset)
{
      int temp[8];
      int* array_idx = &temp;
        // bad code accesses local array without bounds checking
      array_idx += offset;
        // bug when array_idx, advanced by offset, points to
        password_accepted
      *array_idx = 1;
        // Write 1 to address pointed to by array_idx
}
int malicious_attack( )
{
    buggy_code(235748); // bad value pointing to password_accepted
}
```

If the RWX policy is used to protect a memory location where the variable password_accepted is stored, for example, by tagging that memory location as being read only, then the function buggy_code may be prevented from writing to the memory location. However, the function set_password may also be prevented from doing so.

Accordingly, in some embodiments, a compartmentalization policy may be provided for more fine-grained access control. For instance, the compartmentalization policy may maintain one or more compartments, and may associate with each compartment a respective metadata symbol that is colloquially referred to as a “color.” A load/store instruction may be allowed if a color associated with an address register of the load/store instruction matches a color associated with an application memory location referenced by a memory address stored in the address register.

As an example, the compartmentalization policy may have the following policy rule.

```
cptColorCheck (op == [LOAD], code == [CptMemAccess],
  addr == [(CptPtr ptr_color)], memr == [(CptMem mem_color)]
  | ptr_color != mem_color
  −> fail “Pointer and Memory colors do not match”)
```

In this example, there are four input slots, and there is no output slot (because the cptColorCheck rule does not involve any metadata update). However, it should be appreciated that aspects of the present disclosure are not limited to having any particular number of input slot(s), or at all. Likewise, aspects of the present disclosure are not limited to having any particular number of output slot(s), or at all.

The above cptColorCheck rule may indicate that a load instruction is disallowed if: (i) a memory location from which the load instruction is fetched is associated with a metadata label CptMemAccess (indicating the load instruction is executed within a compartment maintained by the compartmentalization policy), (ii) an address register of the load instruction (which address register stores a memory address from which data is to be loaded) is associated with a metadata label indicative of a first color, (iii) a memory location referenced by the memory address is associated with a metadata label indicative of a second color, and (iv) the first and second colors do not match.

Thus, when enforced (e.g., by the illustrative tag processing hardware 140 in the example of FIG. 1), the compartmentalization policy in this example may prevent a thread executing in a certain compartment from accessing memory locations associated with a different compartment.

The inventor has recognized and appreciated that, while the above compartmentalization approach may be effective, there may be performance and/or other challenges. For instance, when a number of compartments increases, so does a number of colors used to differentiate between different compartments. This may in turn increase a number of distinct metadata symbols, which may give rise to various challenges in metadata processing.

As described in connection with the example of FIG. 1, the illustrative tag processing hardware 140 may send a query to the illustrative policy processor 150 to check if an instruction executed by the illustrative host processor 110 is allowed. The query may include one or more inputs, such as an instruction type (e.g., opcode) of the instruction, a metadata tag for a program counter (which may be a designated register of the host processor 110), a metadata tag for an application memory address from which the instruction is fetched (e.g., a word in memory to which the program counter points), a metadata tag for a register in which an operand of the instruction is stored, a metadata tag for a register in which a result of the instruction is stored, a metadata tag for a register in which an application memory address used by the instruction is stored (e.g., an address referencing an application memory location from/to which the instruction is attempting to load/store data), and/or a metadata tag for the application memory location referenced by the application memory address used by the instruction.

In some embodiments, the policy processor 150 may have loaded therein one or more policies, such as the RWX policy and/or the compartmentalization policy described above. In response to a query from the tag processing hardware 140, the policy processor 150 may evaluate one or more of the policies based on one or more inputs in the query from the tag processing hardware 140, to determine if an instruction giving rise to the query is allowed. If the instruction is not allowed, the policy processor 150 may so notify the tag processing hardware 140. If the instruction is allowed, the policy processor 150 may compute one or more outputs to be returned to the tag processing hardware 140. Additionally, or alternatively, the policy processor 150 may store the one or more inputs and/or the one or more corresponding outputs in the illustrative rule table 144 for future reference.

It should be appreciated that an entry in the rule table 144 may be different from a policy rule in a policy. Indeed, a single policy rule may sometimes induce multiple entries in the rule table 144. For instance, the cptColorCheck rule in the above example may induce multiple rule entries, where each entry may correspond to a pair of matching colors.

Assuming there are three colors, and no other policy is concurrently enforced, the induced rule entries may be represented (in human-readable form) as follows.
<{LOAD}, {CptMemAccess}, {RED}, {RED}>
<{LOAD}, {CptMemAccess}, {BLUE}, {BLUE}>
<{LOAD}, {CptMemAccess}, {YELLOW}, {YELLOW}>

Thus, as a number of compartments grows, a number of colors, and hence a number of induced rule entries for the cptColorCheck rule, may also grow.

Policy rules in a policy may be referred to herein as “symbolic” rules. For instance, the cptColorCheck rule in the above example may be considered a symbolic rule.

Moreover, a symbolic rule may be instantiated with different combinations of metadata labels to obtain different “concrete” rules. For instance, rule entries in the rule table 144, such as the three rule entries in the above example, may be considered concrete rules.

The inventor has recognized and appreciated that the policy processor 150 may, in some instances, execute hundreds (or even thousands) of instructions to evaluate one or more policies on just one instruction executed by the host processor 110. Accordingly, in some embodiments, the host processor 110 may be stalled to allow the policy processor 150 to catch up. However, this may create an undesirable delay for some real time applications. For example, the host processor 110 may be on an electric vehicle, and may control circuit switching that takes place thousands of times per second to keep an electric motor running smoothly. Such time sensitive control operations may be disrupted if the host processor 110 is stalled waiting for policy evaluation to be completed.

The inventor has further recognized and appreciated that, although the rule table 144 may be used to speed up accesses to concrete rules, such a speedup may be available only after a concrete rule has already been identified by the policy processor 150 and installed into the rule table 144. When the tag processing hardware 140 queries the rule table 144 with a certain pattern of one or more inputs for the first time, the rule table 144 may indicate there is no match, and the tag processing hardware 140 may request that the policy processor 150 perform policy evaluation on the one or more inputs, which may cause an undesirable delay.

Accordingly, in some embodiments, one or more concrete rules may be identified and installed into a rule table ahead of time, before such rules are requested by the tag processing hardware 140 (e.g., before run time). For instance, the illustrative policy compiler 220, the illustrative policy linker 225, and/or the illustrative loader 215 in the example of FIG. 2 may be programmed to identify one or more concrete rules at compile, link, and/or load time, respectively. Additionally, or alternatively, the policy compiler 220, the policy linker 225, and/or the loader 215 may be programmed to resolve metadata labels in one or more identified concrete rules. The one or more concrete rules, with binary representations substituted for the respective metadata labels, may be loaded into the rule table 144.

The inventor has recognized and appreciated that, for a concrete rule that is computed ahead of time, run time performance may be improved because the tag processing hardware 140 may be able to retrieve that concrete rule from the rule table 144, without invoking the policy processor 150. On the other hand, for a concrete rule that is not computed ahead of time, the tag processing hardware 140 may not find a match in the rule table 144, and may, in response, simply query the policy processor 150. Thus, run time performance may be no worse than that observed in an implementation where no pre-computation is performed.

In sum, computing and installing concrete rules ahead of time may improve run time performance in some cases, without imposing any penalty in other cases. Moreover, because a concrete rule may be computed in the same way regardless of when the computation takes place (e.g., either before or at run time), there may be no negative impact to security, safety, or any other relevant property.

However, the inventor has recognized and appreciated a number of challenges in identifying and installing concrete rules ahead of time. For instance, the inventor has recognized and appreciated that a number of possible metadata labels may grow rapidly with a number of distinct metadata symbols.

With reference to the illustrative RWX policy described above, there may be three distinct metadata symbols, R, W, and X, from which four different metadata labels may be generated (i.e., { }, {R}, {R, W}, and {X}). Moreover, since each symbolic rule in the RWX policy may have five input slots for metadata labels (e.g., code, env, addr, val, and mem), a total of 4\hat{ }5=1,024 different input patterns may be possible.

For a more complex policy or a combination of multiple policies, there may be many more distinct metadata symbols. As an example, if the illustrative RWX policy is enforced along with the illustrative compartmentalization policy described above, there may be at least six metadata symbols (e.g., R, W, X, RED, BLUE, and YELLOW), and at least 4*4=16 different metadata labels (e.g., { }, {R}, {R, W}, {X}, {RED}, {R, RED}, {R, W, RED}, {X, RED}, {BLUE}, {R, BLUE}, {R, W, BLUE}, {X, BLUE}, {YELLOW}, {R, YELLOW}, {R, W, YELLOW}, and {X, YELLOW}). Thus, a total of 16\hat{ }5=1,048,576 different input patterns may be possible (assuming five input slots).

In practice, many more colors may be used by a compartmentalization policy, and many more policies may be enforced in parallel, which may result in an astronomical number of different input patterns. It may be impractical to evaluate each of these input patterns to determine if the input pattern leads to a concrete rule. Moreover, there may be so many concrete rules that a large chip area may be taken up by an on-chip random access memory (RAM) for storing the rule table 144. This may not be possible for chip designs with limited area.

Accordingly, in some embodiments, a compartmentalization policy may be provided that does not detect compartment violation by comparing colors. Instead, the compartmentalization policy may include one or more policy rules configured to detect an instruction that should be checked for potential compartment violation. In response to detecting such an instruction, the tag processing hardware 140 may send a request to a hardware block configured to perform compartment checks.

The inventor has recognized and appreciated that such a compartmentalization policy may be provided using relatively few metadata symbols, and therefore may induce relatively few concrete rules. As a result, less chip area may be used for storing concrete rules, compared to an approach based on color comparisons.

The inventor has further recognized and appreciated that compartment checks may be relatively simple to perform in hardware (e.g., via programmable or fabricated logic, or otherwise at hardware speed). Therefore, only a small amount of chip area may be used to implement a hardware block for compartment checks. In most instances, the area reduction due to fewer concrete rules may be far greater than the area taken up by the hardware block for compartment checks.

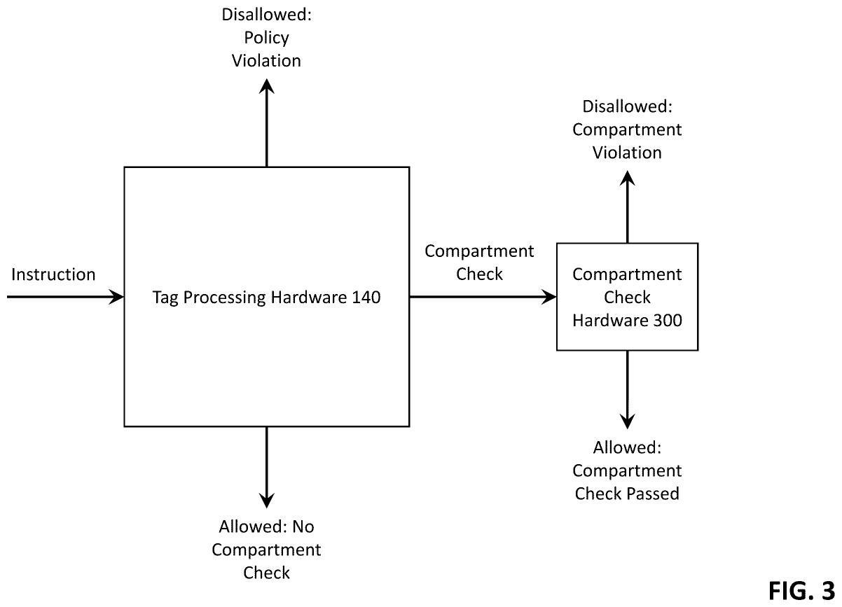

FIG. 3 shows illustrative compartment check hardware 300, in accordance with some embodiments. For instance, the compartment check hardware 300 may be invoked by the illustrative tag processing hardware 140 in the example of FIG. 1 to check an instruction for potential compartment violation.

In some embodiments, the tag processing hardware 140 may receive an instruction to be checked, such as an instruction executed by the illustrative host processor 110 in the example of FIG. 1. The tag processing hardware 140 may be configured to check the instruction for compliance with one or more policies, such as one or more security policies (e.g., RWX, compartmentalization, stack protection, etc.), one or more safety policies, etc.

In some embodiments, the tag processing hardware 140 may be configured to determine whether to invoke the compartment check hardware 300 to check the instruction. For instance, the tag processing hardware 140 may be configured to enforce a compartmentalization policy having one or more policy rules that, when matched, cause the tag processing hardware 140 to invoke the compartment check hardware 300.

It should be appreciated that aspects of the present disclosure are not limited to matching a policy rule in any particular manner. In some embodiments, a policy rule for invoking the compartment check hardware 300 may be matched in software. For instance, the tag processing hardware 140 may construct an input pattern based on the instruction to be checked, and may query the illustrative policy processor 150 with the input pattern, as described in connection with the example of FIG. 1. In response to determining that the input pattern matches one or more policy rules of a compartmentalization policy, the policy processor 150 may invoke the compartment check hardware 300.

Additionally, or alternatively, a policy rule for invoking the compartment check hardware 300 may be matched in hardware. As an example, the tag processing hardware 140 may construct an input pattern based on the instruction to be checked, and may match the input pattern against one or more concrete rules stored in the illustrative rule table 140 in the example of FIG. 1. As another example, the tag processing hardware 140 may include a policy check function implemented in hardware (e.g., via programmable or fabricated logic, or otherwise at hardware speed), as further described below, and may apply the policy check function to an input pattern constructed based on the instruction to be checked.

Referring again to the example of FIG. 3:
1) the tag processing hardware 140 may determine that the instruction violates a policy being enforced, and therefore the tag processing hardware 140 may output a signal indicating that the instruction is disallowed;
2) the tag processing hardware 140 may determine that the instruction does not violate any policy being enforced, and does not match one or more selected policy rules of the compartmentalization policy, and therefore the tag processing hardware 140 may output a signal indicating that the instruction is allowed, without invoking the compartment check hardware 300; or
3) the tag processing hardware 140 may determine that the instruction does not violate any policy being enforced, and matches at least one of one or more selected policy rules of the compartmentalization policy, and therefore the tag processing hardware 140 may send a compartment check request to the compartment check hardware 300.

In some embodiments, the compartment check request may include information regarding the instruction to be checked. Such information may be used by the compartment check hardware 300 to determine whether the instruction presents a compartment violation. If the compartment check hardware 300 determines that the instruction presents a compartment violation, the compartment check hardware 300 may output a signal indicating that the instruction is disallowed. Otherwise, the compartment check hardware 300 may output a signal indicating that the instruction is allowed.

In some embodiments, a buffer (e.g., a first-in-first-out buffer) may be placed between the tag processing hardware 140 and the compartment check hardware 300 to store requests (e.g., compartment check requests) to be processed by the compartment check hardware 300. In this manner, the tag processing hardware 140 may proceed to process other instructions while waiting for the compartment check hardware 300 to check an instruction.

Although certain details of implementation are described in connection with the example of FIG. 3, it should be appreciated that aspects of the present disclosure are not limited to any particular manner of implementation. In some embodiments, logic for determining whether to invoke the compartment check hardware 300 may be implemented directly, as opposed to via policy enforcement. For instance, instead of expressing such logic as a policy to be enforced by the tag processing hardware 140, such logic may be implemented in hardware (e.g., via programmable or fabricated logic, or otherwise at hardware speed). This may allow compartment checks to be performed even if there is no tag processing hardware (e.g., where a chip design does not have sufficient area to implement the tag processing hardware 140).

Additionally, or alternatively, a compiler for translating source code into executable code (e.g., the illustrative compiler 205 in the example of FIG. 2) may be configured to insert, into the executable code, one or more instructions to cause a host processor (e.g., the illustrative host processor 110 in the example of FIG. 1) to invoke the compartment check hardware 300. For instance, the compartment check hardware 300 may include a software-accessible interface, such as one or more software-accessible registers and/or memory locations, and the compiler may be configured to insert one or more instructions to access such register(s) and/or memory locations.

In some embodiments, a register or a memory location designated for interfacing with the compartment check hardware 300 may be accessible by code running in a user mode. Thus, the compiler may simply insert a load or store instruction indicating an address for the designated register or memory location.

Additionally, or alternatively, a register or a memory location designated for interfacing with the compartment check hardware 300 may only be accessible by code running in a privileged mode, which may be the same privileged mode as an operating system, or a different privileged mode (e.g., with even more protection against privilege escalation). Thus, the compiler may insert a system call (and/or one or more other instructions) to switch to the privileged mode, in addition to, or instead of, a load or store instruction indicating an address for the designated register or memory location.

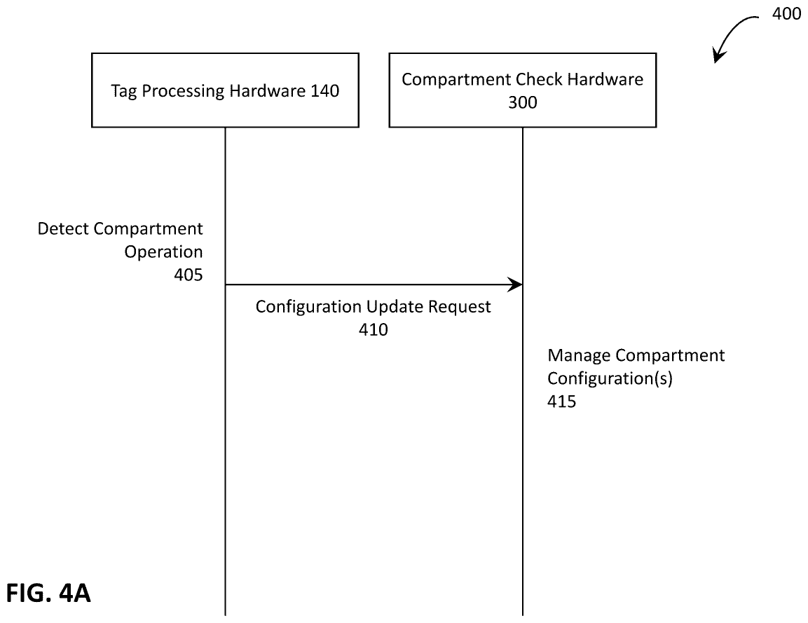

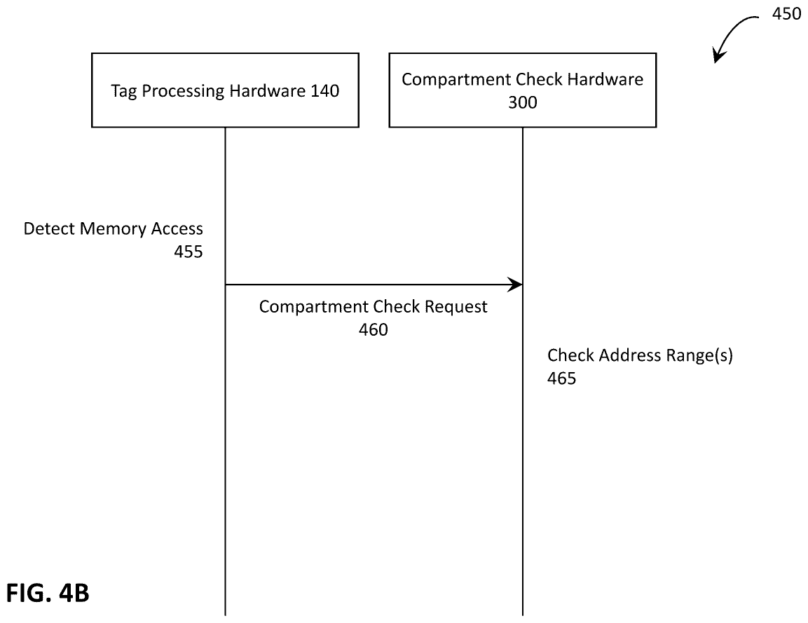

FIG. 4A shows an illustrative process 400 for a compartment configuration update, in accordance with some embodiments. For instance, the process 400 may take place between the illustrative tag processing hardware 140 in the example of FIG. 1 and the illustrative compartment checking hardware 300 in the example of FIG. 3.

At act 405, the tag processing hardware 140 may detect a compartment operation. For instance, the tag processing hardware 140 may detect a compartment transition, which may include:
1) a transfer of control from a source compartment to non-compartment code (thus, a compartment exit);
2) a transfer of control from a source compartment to a target compartment different from the source compartment (thus, both a compartment entry and a compartment exit); or
3) a transfer of control from non-compartment code to a target compartment (thus, a compartment entry).

Additionally, or alternatively, the tag processing hardware 140 may detect an address range being dynamically allocated or deallocated for a compartment.

A compartment operation (e.g., a compartment entry, a compartment exit, or a memory allocation) may be detected in any suitable manner. In some embodiments, one or more compartment decomposition rules may be applied to partition one or more functions into one or more compartments. For instance, the illustrative get_password and set_password functions described above may belong to a first compartment, whereas the illustrative buggy_code function described above) may belong to a second compartment different from the first compartment.

It should be appreciated that not every function may belong to a compartment. A function that does not belong to any compartment may be referred to herein as “non-compartment code”.

Compartment decomposition may be done statically (e.g., by analyzing source code and/or object code prior to execution) and/or dynamically (e.g., at run time). A resulting compartment may be assigned a respective identifier. Additionally, or alternatively, a compartment may be associated with one or more address ranges where code and/or data of the compartment may be stored. Accordingly, an instruction fetched from a code address range of the compartment may be deemed an instruction executing in the compartment. Such an instruction may be allowed to access one or more data address ranges of the compartment, but not other address ranges.

Additionally, or alternatively, a control flow analysis may be performed (e.g., by the illustrative complier 205 in the example of FIG. 2) to produce a compartment transition graph. For instance, a control flow analysis may be used to produce a control flow graph, which may in turn be used to produce a compartment transition graph.

In some embodiments, each node in a control flow graph may represent a block of code (e.g., a sequence of instructions from a branch target to a next branch instruction, with no intervening branch instruction). An edge from a source node to a target node may represent a branch instruction at the end of a block of code represented by the source node, and the branch instruction may jump to the beginning of a block of code represented by the target node.

In some embodiments, a node in a compartment transition graph may represent a compartment, which may include one or more blocks of code. Additionally, or alternatively, an edge from a source node to a target node may represent an allowed compartment transition from a source compartment (represented by the source node) to a target compartment (represented by the target node).

Thus, given a first compartment and a second compartment, there may be an edge from the first compartment to the second compartment in the compartment transition graph if there is an edge in the control flow graph from a node representing a first block of code in the first compartment, to a node representing a second block of code in the second compartment.

In some embodiments, object code of a compartment may be annotated (e.g., by the illustrative policy linker 225 in the example of FIG. 2) with one or more metadata labels to facilitate enforcement of a compartmentalization policy. For instance, the compartmentalization policy may include a compartment entry rule for detecting a metadata symbol (e.g., CptEntry) indicating a compartment entry, and an entry point to the compartment (e.g., an entry point to a function in the compartment) may be annotated with a metadata label comprising that metadata symbol. Additionally, or alternatively, the compartmentalization policy may include a compartment exit rule for detecting a metadata symbol (e.g., CptExit) indicating a compartment exit, and an exit point from the compartment (e.g., a return from a function in the compartment) may be annotated with a metadata label comprising that metadata symbol.

In some instances, a compartment may include multiple functions. Thus, there may be multiple entry points to, and/or multiple exit points from, the compartment. Each of the entry point(s) and the exit point(s) may be annotated accordingly. However, it should be appreciated that aspects of the present disclosure are not limited to having a compartment that includes multiple functions. In some instances, a compartment may include only a single function or a block of code (e.g., a sequence of instructions from a branch target to a next branch instruction, with no intervening branch instruction).

It should also be appreciated that a compartment that includes multiple functions may not always have multiple entry points or multiple exit points. In some instances, a function in a compartment may only be called by another function within the same compartment. Such a function may not be annotated for compartment exit or compartment entry.

```
// Trigger compartment check hardware to switch compartments
ccuTransitions =
  ccuCptEntry (op == [BRANCH], code == [CptEntry] −> cmd =
  CPT_ENTRY)
  \hat{ } ccuCptExit (op == [BRANCH], code == [CptExit] −> cmd =
  CPT_EXIT)
```

In the above example, when the illustrative host processor 110 in the example of FIG. 1 executes an instruction to enter into (or exit from) a compartment, the tag processing hardware 140 may check the instruction by constructing an input pattern based on the instruction, and the input pattern may match the compartment entry rule (or the compartment exit rule). This may indicate that a compartment entry (or exit) has been detected.

The inventor has recognized and appreciated that a common metadata symbol (e.g., CptEntry or CptExit) may be used to indicate entry or exit into any compartment, as opposed to having a different metadata symbol (colloquially, a different color) corresponding to a respective compartment. In this manner, even if there are many compartments, a total number of metadata symbols may remain small, and less chip area may be used for storing concrete rules.

Referring again to the example of FIG. 4A, in response to detecting a compartment operation, the tag processing hardware 140 may, at act 410, send a configuration update request to the compartment check hardware 300.

The configuration update request may be triggered in any suitable manner. For instance, the compartment entry rule or the compartment exit rule in the above example, when matched at act 405, may cause the tag processing hardware 140 to send the configuration update request via a CPT_ENTRY signal or a CPT_EXIT signal.

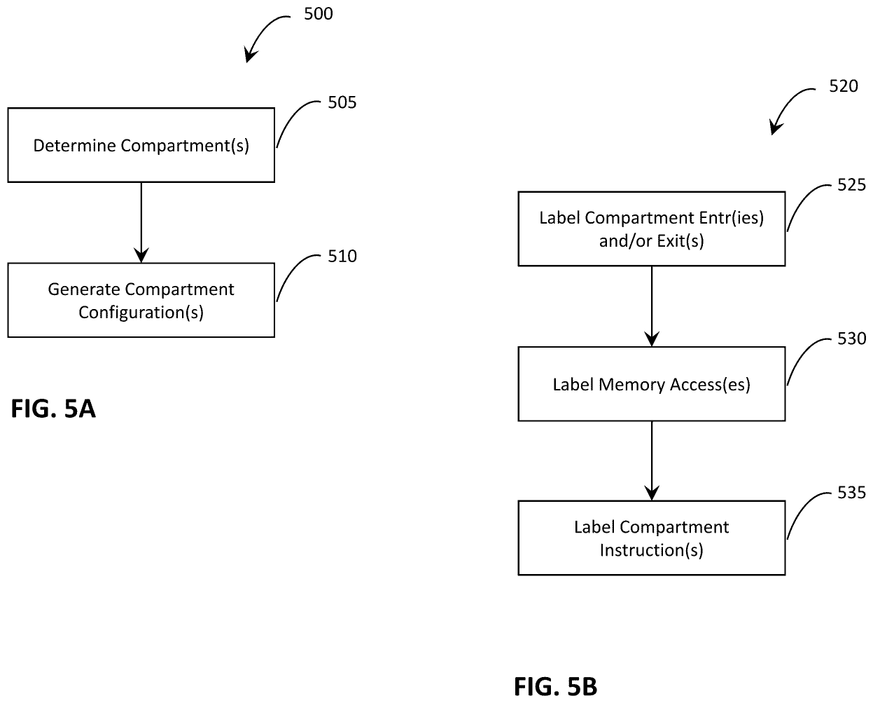

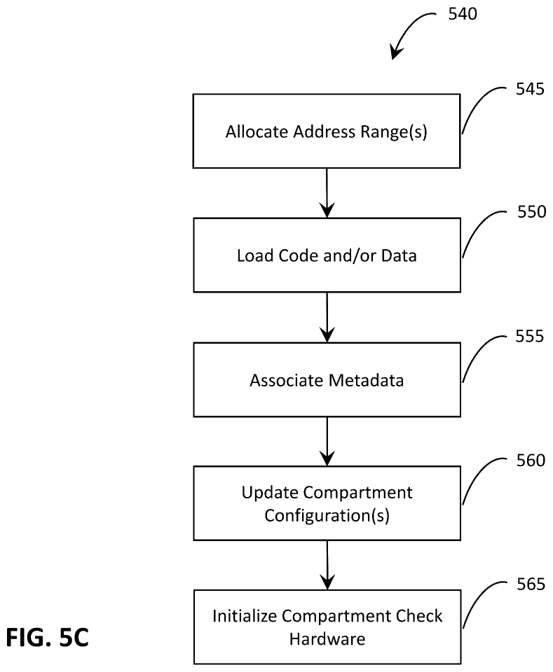

The configuration update request may include any suitable information. For instance, the compartment operation detected at act 410 may include a compartment transition, which may involve an entry into a target compartment (e.g., from non-compartment code or a source compartment) and/or an exit from a source compartment (e.g., to non-compartment code or a target compartment). The configuration update request may include information that may be used by the compartment check hardware 300 to determine the target compartment and/or the source compartment, such as one or more suitable identifiers (e.g., a global identifier and/or a local identifier as described below in connection with the example of FIG. 5A).

As an example, an instruction representing the compartment transition may be a branch instruction, and the configuration update request may include a target address of the branch instruction. The compartment check hardware 300 may match the target address of the branch instruction to a compartment identifier (which may identify the target compartment). For instance, the compartment check hardware 300 may store a mapping of address ranges to identifiers of respective compartments. The address ranges may be sorted in an appropriate manner (e.g., by start address) to facilitate matching.

Additionally, or alternatively, the configuration update request may include an address from which the branch instruction is fetched. The compartment check hardware 300 may match the address from which the branch instruction is fetched to an identifier (which may identify the source compartment).

In some embodiments, the compartment operation detected at act 410 may include a dynamic allocation or deallocation of an address range for a compartment. The configuration update request may include information that may be used by the compartment check hardware 300 to determine the compartment, such as one or more suitable identifiers of the compartment (e.g., a global identifier and/or a local identifier as described below in connection with the example of FIG. 5A). Additionally, or alternatively, the configuration update request may include information regarding the dynamically allocated or deallocated address range, such as a start address, an end address, a size, etc.

It should be appreciated that aspects of the present disclosure are not limited to a configuration update request with any particular piece of information, or any particular combination of information. For instance, given a start address of an address range, an end address may be derived from a size of the address range, and vice versa.

The tag processing hardware 140 may send the configuration update request to the compartment check hardware 300 in any suitable manner. For instance, an interface to the compartment check hardware 300 may include one or more registers that are accessible to the tag processing hardware 140. The tag processing hardware 140 may write a selected value (e.g., 1) into a first register to signal that a new configuration update request is awaiting processing. Additionally, or alternatively, the tag processing hardware 140 may write relevant information (e.g., a target address of a branch instruction triggering the configuration update request) into one or more second registers.

In some embodiments, the compartment check hardware 300 may poll the first register periodically to determine whether a new configuration update request is awaiting processing. In response to detecting the selected value in the first register, the compartment check hardware 300 may determine that a new configuration update request is awaiting processing, and may retrieve the relevant information from the one or more second registers.

In some embodiments, once the relevant information has been retrieved, the compartment check hardware 300 may reset the first register, for example, to a default value. The tag processing hardware 140 may check whether the first register has been reset to the default value before sending another configuration update request.

However, it should be appreciated that aspects of the present disclosure are not limited to using one or more registers as an interface to the compartment check hardware 300. Additionally, or alternatively, the tag processing hardware 140 may send the configuration update request to the compartment check hardware 300 via one or more bus interfaces.

Referring again to the example of FIG. 4A, upon receiving the configuration update request, the compartment check hardware 300 may, at act 415, manage one or more compartment configurations. For instance, in case of a compartment entry, the compartment check hardware 300 may determine an identifier of a target compartment (e.g., using information obtained based on the configuration update request), and may load a compartment configuration of the target compartment (e.g., from a main memory to a memory local to the compartment check hardware 300). As an example, the configuration update request may indicate a target address of a branch instruction, which may be matched to a compartment identifier, as described in connection with act 410. The compartment check hardware 300 may then use the identifier to select a compartment configuration to be loaded.

In some embodiments, prior to loading the compartment configuration of the target compartment, the compartment check hardware 300 may check if the compartment transition is allowed. For instance, the compartment check hardware 300 may maintain a compartment transition graph. In case of a transfer of control from a source compartment to the target compartment, the compartment check hardware 300 may check if a transition from the source compartment to the target compartment is present in the compartment transition graph. If such a transition is present, the compartment check hardware 300 may output a signal indicating that an instruction representing the compartment transition is allowed, and may proceed to load the compartment configuration of the target compartment.

If, instead, no transition from the source compartment to the target compartment is present in the compartment transition graph, the compartment check hardware 300 may output a signal indicating that an instruction representing the compartment transition is disallowed.

In some embodiments, the compartment transition graph may include one or more nodes representing non-compartment code. Thus, a compartment entry from non-compartment code to a target compartment may be checked by the compartment check hardware 300 as described above.

However, it should be appreciated that aspects of the present disclosure are not limited to representing non-compartment code as a node in the compartment transition graph. Additionally, or alternatively, a compartmentalization policy may be provided to enable the compartment check hardware 300 upon entry to a target compartment from non-compartment code, and/or to disable the compartment check hardware 300 upon exit from a source compartment to non-compartment code.

A compartment transition graph may be obtained in any suitable manner. For instance, as described in connection with act 405, the compartment transition graph may be generated via a control flow analysis (e.g., by the illustrative complier 205 in the example of FIG. 2). The compartment transition graph may then be included in an initialization specification (e.g., by the illustrative policy linker 225 in the example of FIG. 2), and may be stored at a memory location accessible the compartment check hardware 300 (e.g., by the illustrative loader 215 in the example of FIG. 2).

A compartment configuration may include any suitable information, such as one or more address ranges associated with a corresponding compartment. For instance, a compartment configuration may indicate one or more code address ranges, which may be allocated for storing instructions of a corresponding compartment. Additionally, or alternatively, the compartment configuration may indicate one or more data address ranges, which may be allocated for storing data manipulated by the instructions of the corresponding compartment.

As an example, the illustrative buggy_code function described above may have a compartment configuration as follows.

```
{
Compartment_name: “buggy_code”
Code_address_range
  Min: 157484
  Max: 157490
Data_address_range
  Min: 123456
  Max: 123789
}
```

In some embodiments, the compartment check hardware 300 may maintain a collection of compartment configurations (e.g., in a memory local to the compartment check hardware 300). Such a collection may be populated initially with compartment configurations that are statically generated (e.g., by analyzing source code, object code, a compartment transition graph that is statically generated, etc.). At run time, the compartment check hardware 300 and/or one or more functions of a runtime library (e.g., malloc) may add, remove, and/or update compartment configurations in the collection.

It should be appreciated that aspects of the present disclosure are not limited to loading a compartment configuration in response to detecting a compartment transition. In some embodiments, one or more compartment configurations may be pre-loaded (e.g., by predicting one or more compartments that may be encountered in the near future, for instance, within one, two, three, . . . compartment transition(s)). In response to a compartment transition, the compartment check hardware 300 may determine if any pre-loaded compartment configuration is associated with a target compartment of the compartment transition. If so, that compartment configuration may be designated as a current compartment configuration. Otherwise, a compartment configuration for the target compartment may be loaded. In this manner, run time performance may be improved.

In some embodiments, the compartment check hardware 300 may use a compartment transition graph to select one or more compartment configurations to be pre-loaded. For instance, given a current compartment, the compartment check hardware 300 may use a compartment transition graph to identify one or more compartments reachable from the current compartment via at most N compartment transitions (N=1, 2, 3, . . . ). The value N may be selected, statically or dynamically, depending on how much memory is available for storing pre-loaded compartment configurations.

In some embodiments, the compartment check hardware 300 may maintain a stack of compartment configurations, where a compartment configuration at the top of the stack may be designated as a current compartment configuration. In response to a compartment transition from a source compartment to a target compartment, the compartment check hardware 300 may push a compartment configuration of the target compartment onto the stack. Additionally, alternatively, in response to a compartment transition from the target compartment back to the source compartment, the compartment check hardware 300 may pop the compartment configuration of the target compartment off the stack.

The inventor has recognized and appreciated that performance may be improved by maintaining a stack of compartment configurations. For instance, a compartment configuration for a source compartment may remain available in memory, and need not be loaded again when execution returns back to the source compartment.

However, the inventor has also recognized and appreciated that maintaining a stack of compartment configurations may increase memory usage and therefore chip area. Accordingly, in some embodiments, the compartment check hardware 300 may maintain a stack of compartment identifiers, in addition to, or instead of, a stack of compartment configurations. For instance, in case of a compartment exit from a source compartment, a compartment configuration of the source compartment may be removed from memory (e.g., by freeing an address range where the compartment configuration is stored), while an identifier of the source compartment may be maintained, and may be used by the compartment check hardware 300 to load the compartment configuration of the source compartment when execution returns back to the source compartment.

Referring again to act 415 in the example of FIG. 4A, the compartment check hardware 300 may, in some embodiments, update a compartment configuration. For instance, the configuration update request may be triggered by a memory allocation or deallocation for a compartment. The compartment check hardware 300 may determine an identifier of the compartment (e.g., using information obtained based on the configuration update request), and may determine if a compartment configuration of the compartment is already loaded. If not, the compartment check hardware 300 may load such a compartment configuration.

Additionally, or alternatively, the compartment check hardware 300 may use information obtained based on the configuration update request to update the compartment configuration. For instance, the compartment check hardware 300 may add, delete, or modify an address range in the compartment configuration, using a start address, an end address, a size, etc. of the address range.

FIG. 4B shows an illustrative process 450 for a compartment check, in accordance with some embodiments. For instance, the process 450 may take place between the illustrative tag processing hardware 140 in the example of FIG. 1 and the illustrative compartment checking hardware 300 in the example of FIG. 3. Additionally, or alternatively, the process 450 may take place following the illustrative process 400 in the example of FIG. 4A.

At act 455, the tag processing hardware 140 may detect a memory access that should be checked for possible compartment violation. For instance, as described in connection with the example of FIG. 3, the tag processing hardware 140 may perform a policy check on an instruction executed by the illustrative host processor 110 in the example of FIG. 1. This may include checking an input pattern constructed based on the instruction against a compartmentalization policy.

In some embodiments, the compartmentalization policy may include one or more policy rules configured to detect an instruction that is executing in a compartment, and is attempting to access memory. For instance, the compartmentalization policy may include a compartment memory check rule for detecting a metadata symbol (e.g., CptMemAccess) indicating a memory access attempted by an instruction executing in a compartment.

```
// Trigger compartment check hardware to check access to compartment
object
ccuMemoryAccessCheck =
  ccuCompartmentLoad (code == [CptMemAccess], addr == [CptPtr],
  memr == [CptMem]
  −> cmd = CPT_MEM_CHECK)
  & ccuCompartmentStore (code == [CptMemAccess], addr == [CptPtr],
  memw == [CptMem]
  −> cmd = CPT_MEM_CHECK)
```

Additionally, or alternatively, one or more store and/or load instructions of a function belonging to a compartment may be annotated with a metadata label comprising the metadata symbol of the compartment memory check rule (e.g., CptMemAccess). As an example, with reference to the illustrative buggy_code function described above, a store instruction in object code corresponding to the following source code may be annotated with a metadata label comprising the metadata symbol CptMemAccess.
*array_idx=1; //Write 1 to address at array_idx

Thus, when the illustrative host processor 110 in the example of FIG. 1 executes the store instruction, the tag processing hardware 140 may check the store instruction by constructing an input pattern based on the store instruction, and the input pattern may match the compartment memory check rule.

The inventor has recognized and appreciated that a common metadata symbol (e.g., CptMemAccess) may be used to indicate an attempt to access memory by an instruction executing in any compartment, as opposed to having a different metadata symbol (colloquially, a different color) corresponding to a respective compartment. In this manner, even if there are many compartments, a number of metadata symbols may remain small, and less chip area may be used for storing concrete rules.

Referring again to the example of FIG. 4B, in response to detecting an attempt to access memory by an instruction executing in any compartment, the tag processing hardware 140 may, at act 460, send a compartment check request to the compartment check hardware 300. The compartment check request may include any suitable information, such as a memory address from which the instruction is fetched, a memory address that the instruction is attempting to access, etc.

The compartment check request may be triggered in any suitable manner. For instance, the compartment memory check rule in the above example, when matched at act 455, may cause the tag processing hardware 140 to send the compartment check request via a CPT_MEM_CHECK signal.

The tag processing hardware 140 may send the configuration update request to the compartment check hardware 300 in any suitable manner, for example, by writing to one or more registers accessible to the compartment check hardware 300, or via a bus interface (e.g., as described in connection with the configuration update request in the example of FIG. 4A). At act 465, upon receiving the compartment check request, the compartment check hardware 300 may identify an appropriate compartment configuration for use in checking the instruction triggering the compartment check. In some embodiments, only one compartment configuration may be loaded at a time (e.g., a compartment configuration for a current compartment) in a memory local to the compartment check hardware 300. Such a compartment configuration may be used to check the instruction.

In some embodiments, multiple configurations may be loaded simultaneously (e.g., to improve run time performance) in a memory local to the compartment check hardware 300. For instance, one or more compartment configurations may be cached for recently encountered compartments. Additionally, or alternatively, one or more compartment configurations may be pre-loaded for compartments that are likely to be encountered in the near future (e.g., as described in connection with the example of FIG. 4A). One of the cached compartment configuration(s) and/or the pre-loaded compartment configuration(s) may be designated as a current compartment configuration, which may be used to check the instruction at act 465.

The compartment check hardware 300 may use the identified compartment configuration to check the instruction in any suitable manner. For instance, the compartment check request may include a memory address from which the instruction is fetched, and the identified compartment configuration may include one or more code address ranges for storing instructions belonging to a corresponding compartment. Accordingly, the compartment check hardware 300 may check the memory address from which the instruction is fetched against the one or more code address ranges in the compartment configuration.

As an example, with reference to the illustrative compartment configuration described in connection with the example of FIG. 4A (for the illustrative buggy_code function), the compartment check hardware 300 may check the memory address from which the instruction is fetched against the code address range 157484-157490.

Additionally, or alternatively, the compartment check request may include a memory address that the instruction is attempting to access, and the identified compartment configuration may include one or more data address ranges that instructions executing in the corresponding compartment may be allowed to access. Accordingly, the compartment check hardware 300 may check the memory address being accessed against the one or more data address ranges in the compartment configuration.

As an example, with reference to the illustrative compartment configuration described in connection with the example of FIG. 4A (for the illustrative buggy_code function), the compartment check hardware 300 may check the memory address being accessed against the data address range 123456-123789.

In some embodiments, if the memory address from which the instruction is fetched belongs to a code address range in the compartment configuration, and the memory being accessed belongs to a data address range in the compartment configuration, the compartment check hardware 300 may output a signal indicating that the instruction is allowed. Otherwise, the compartment check hardware 300 may output a signal indicating that the instruction is disallowed.

However, it should be appreciated that aspects of the present disclosure are not limited to performing both checks. In some embodiments, only one, or none, of these checks, and/or one or more other checks may be performed.

Although certain details of implementation are described in connection with the examples of FIGS. 4A-4B, it should be appreciated that aspects of the present disclosure are not limited to any particular manner of implementation. In some embodiments, a compartmentalization policy may include one or more other policy rules, in addition to, or instead of, the illustrative compartment entry rule and/or the illustrative compartment exit rule described in connection with the example of FIG. 4A, and/or the illustrative compartment check rule described in connection with the example of FIG. 4B.

For instance, the inventor has recognized and appreciated that it may be desirable to check: (A) whether an instruction executing in a compartment is attempting to access a memory address that is not associated with any compartment, and/or (B) whether an instruction that is not executing in any compartment is attempting to access a memory address that is associated with a compartment. One or both of these checks may be performed in addition to, or instead of, checking whether an instruction executing in a compartment is attempting to access a memory address that is not associated with that compartment (e.g., as described in connection with the example of FIG. 4B).

The inventor has further recognized and appreciated that (A) and (B) above may be checked without reference to any compartment configuration, and therefore may be checked via policy enforcement with relatively few metadata symbols (e.g., CptPtr and CptMem), and hence without significant increase in chip area. Accordingly, in some embodiments, a compartmentalization policy may include one or more of the illustrative policy rules below.

```
compartment TypeCheck =
  // (A) Non-compartment memory may not be accessed via compartment
  pointers
  checkNonCompartmentLoad(code == _, addr == [CptPtr], memr ==
  [−CptMem]
  −> fail “Pointer to compartment object cannot read data outside
  the object.”)
  & checkNonCompartmentStore(code == _, addr == [CptPtr],
  memw == [−CptMem]
  −> fail “Pointer to compartment object cannot write data outside
  the object.”)
  // (B) Compartment memory may not be accessed via non-compartment
  pointers
  & checkCompartmentLoad(code == _, addr == [−CptPtr], memr ==
  [CptMem]
  −> fail “Non-compartment pointer cannot read data from
  compartment object.”)
  & checkCompartmentStore(code == _, addr == [−CptPtr], memw ==
  [CptMem]
  −> fail “Non-compartment pointer cannot write data to compartment
  object.”)
```

Additionally, or alternatively, one or more other policies may be enforced by the tag processing hardware 140 in addition to, or instead of, a compartmentalization policy. For instance, the tag processing hardware 140 may enforce the illustrative RWX policy described above along with a compartmentalization policy described in connection with any of the examples of FIGS. 3-5, such as the illustrative compartmentalization policy below.

```
/*
  * Copyright (C) 2017-2023 Dover Microsystems, Inc.
  * All rights reserved.
  *
  * Use and disclosure subject to license.
  */
module coreguard.cpt :
/*
  *
  */
import :
coreguard.metadata_common
metadata:
// Commands to trigger compartment check hardware
```

| | |
|---|---|
| Accelerator | CCUcmdT = CPT_ENTRY \| CPT_EXIT \| CPT_MEM_CHECK |

// metadata for compartment type checking

| | |
|---|---|
| data (cpt) | CptMemoryT<fixed> = CptMem |
| | // Memory belonging to a compartment |
| data (cpt, mem) | CptPointerT<flow> = CptPtr |
| | // Pointer used within a compartment |

// metadata for triggering CCU cmds

| | |
|---|---|
| data (code) | CptCodeT<fixed> = |
| | // Instructions representing compartment entries |
| | CptEntry |
| | // Instructions representing compartment exits |
| | \| CptExit |
| | // Instructions to be checked for potential |
| | compartment violations |
| | \| CptMemAccess |

```
export:
cptPolicy
policy:
// main compartment policy
cptPolicy =
  // Check policy metadata for compartment operations
  compartment TypeCheck
  // Trigger memory access checks
  & ccuMemoryAccessCheck
  // Trigger switching between compartments
  & ccuTransitions
compartment TypeCheck =
  // Non-compartment memory may not be accessed via compartment
  pointers
  checkNonCompartmentLoad (code == _, addr == [CptPtr], memr == [−
  CptMem]
  −> fail “Pointer to compartment object cannot read data outside
  the object.”)
  & checkNonCompartmentStore (code == _, addr == [CptPtr], memw ==
  [−CptMem]
  −> fail “Pointer to compartment object cannot write data outside
  the object.”)
  // Compartment memory may not be accessed via non-compartment
  pointers
  & checkCompartmentLoad (code == _, addr == [-CptPtr], memr ==
  [CptMem]
  −> fail “Non-compartment pointer cannot read data from
  compartment object.”)
  & checkCompartmentStore (code == _, addr == [-CptPtr], memw ==
  [CptMem]
  −> fail “Non-compartment pointer cannot write data to compartment
  object.”)
// Trigger compartment check hardware to check access to compartment
object
ccuMemoryAccessCheck =
  ccuCompartmentLoad (code == [CptMemAccess], addr == [CptPtr],
  memr == [CptMem]
  −> cmd = CPT_MEM_CHECK)
  & ccuCompartmentStore (code == [CptMemAccess], addr == [CptPtr],
  memw == [CptMem]
  −> cmd = CPT_MEM_CHECK)
// Trigger compartment check hardware to switch compartments
ccuTransitions =
  ccuCptEntry (op == [BRANCH] , code == [CptEntry] −> cmd =
  CPT_ENTRY)
  \hat{ } ccuCptExit (op == [BRANCH], code == [CptExit] −> cmd =
  CPT_EXIT)
require:
init application. data. ucCompartment
{CptMemAccess}:(code)
```

FIG. 5A shows an illustrative process 500 for generating one or more compartment configurations, in accordance with some embodiments. For instance, the process 500 may be performed by the illustrative compiler 205 in the example of FIG. 2, which may be programmed to process source code into corresponding object code, along with one or more compartment configurations.

At act 505, the compiler 205 may determine one or more compartments. This may be done in any suitable manner. For instance, the compiler 205 may treat each basic block of code (namely, a sequence of instructions from a branch target to a next branch instruction, with no other branch instruction intervening) as a separate compartment. Additionally, or alternatively, the compiler 205 may treat each function as a separate compartment. For instance, in some embodiments, even a subroutine may be treated as a separate compartment from a parent routine.

The inventor has recognized and appreciated that improved security may be provided by constructing compartments in a fine-grained manner (e.g., many compartments each containing a small portion of code). However, this may result in reduced performance, for example, due to frequent loading of compartment configurations from a main memory into a memory local to the compartment check hardware 300.

Accordingly, in some embodiments, run time profiling and/or simulation may be used to collect performance statistics, and the compiler 205 may be programmed to merge one or more compartments based on performance feedback (e.g., merging a source compartment and a target compartment of a compartment transition where performance degradation exceeds a selected threshold). This may be done iteratively to achieve a desired tradeoff between security and performance.

In some embodiments, the compiler 205 may associate a compartment with one or more identifiers. For instance, each compartment may be associated with a respective global identifier, such that no two compartments may share the same global identifier.

Additionally, or alternatively, a compartment may be associated with a local identifier relative to another compartment. For instance, as described in connection with act 405 in the example of FIG. 4A, the complier 205 may generate a compartment transition graph via a control flow analysis. Given a first compartment, the complier 205 may identify one or more second compartments such that the compartment transition graph includes a transition from the first compartment to a respective second compartment. Each such second compartment may be associated with a local identifier relative to the first compartment.

As an example, a source compartment S may have N possible target compartments T_1, . . . , T_N (N>=1) in the compartment transition graph. These target compartments may be associated with local identifiers 1, . . . , N, respectively, relative to the source compartment S. Given a target compartment X=T_i for some i=1, . . . , N, a global identifier for X may be different from the local identifier for X relative to S (namely, i).

As another example, a source compartment U may have M possible target compartments V_1, . . . , V_M (M>=1) in the compartment transition graph. These target compartments may be associated with local identifiers 1, . . . , M, respectively, relative to the source compartment U. The compartment X in the above example may be the same as the compartment V_j for some j=1, . . . , M (because the compartment transition graph may include a transition from S to X, as well as a transition from U to X.) The local identifier for X relative to S (namely, i) may be different from the local identifier for X relative to U (namely, j).

The inventor has recognized and appreciated that, as a number of compartments grows, longer bitstrings may be used to represent global identifiers for the compartments. By contrast, even as a number of compartments grows, a number of possible target compartments may remain relatively small for a typical source compartment, and therefore shorter bitstrings may be used to represent local identifiers for the target compartments relative to the source compartment. This may improve performance (e.g., faster operations such as comparison, lookup, transmission, etc.), and/or reduce resource consumption (e.g., power, memory, bandwidth, etc.).

Referring again to the example of FIG. 5A, the compiler 205 may, at act 510, generate one or more compartment configurations. As an example, a compartment configuration for a first compartment (e.g., the compartment S described in connection with act 505) may include a global identifier for the first compartment.

Additionally, or alternatively, the compiler 205 may use a compartment transition graph to identify one or more second compartments (e.g., the compartments T_1, . . . , T_N described in connection with act 505) such that the compartment transition graph includes a transition from the first compartment to a respective second compartment. (The compartment transition graph may be generated via a control flow analysis, as described in connection with act 405 in the example of FIG. 4A.) The complier 205 may then construct a data structure (e.g., a lookup table) that maps a global identifier of each second compartment (e.g., the global identifier of the compartment X=T_i described in connection with act 505) to a local identifier (e.g., i) for the second compartment relative to the first compartment, and/or a data structure (e.g., a lookup table) that maps a local identifier (e.g., i) for each second compartment relative to the first compartment to a global identifier of the second compartment (e.g., the global identifier of the compartment X=T_i). Such data structure(s) may be included in the compartment configuration for the first compartment.

As another example, a compartment configuration for a second compartment (e.g., the compartment X=T_i=V_j described in connection with act 505) may include a global identifier for the second compartment.

Additionally, or alternatively, the compiler 205 may use the compartment transition graph to identify one or more third compartments (e.g., the compartment S and/or the compartment U described in connection with act 505) such that the compartment transition graph includes a transition from a respective third compartment to the second compartment. The complier 205 may then construct a data structure (e.g., a lookup table) that maps a global identifier of each third compartment (e.g., the global identifier of the compartment S or the compartment U) to a local identifier (e.g., i or j, respectively) for the second compartment relative to the third compartment. Such a data structure may be included in the compartment configuration for the second compartment.

In some embodiments, a compartment configuration may include information that may be used to identify one or more address ranges for code belonging to a corresponding compartment. For instance, the compartment configuration may include, for each portion of such code, a name of an object file, and/or a location within the object file, where the portion of code may be found. The location within the object file may be indicated in any suitable manner, for example, via a name of a section (e.g., a .text section), a start offset and/or an end offset, etc.

Additionally, or alternatively, the compartment configuration may include information that may be used to identify one or more address ranges for data to be manipulated by the code of the corresponding compartment. For instance, the compartment configuration may include, for each portion of such data, a name of an object file, and/or a location within the object file, where the portion of data may be found. The location within the object file may be indicated in any suitable manner, for example, via a name of a section (e.g., a .data or .rodata section), a start offset and/or an end offset, etc.

It should be appreciated that a data address range may be initialized or uninitialized. For instance, a data address range for a global variable may be statically allocated but uninitialized, and therefore may have known offsets at compile time.

It should be appreciated that aspects of the present disclosure are not limited to using a compartment transition graph to generate a compartment configuration. In some embodiments, the compile 205 may generate a compartment configuration by analyzing source code and/or object code, in addition to, or instead of, a compartment transition graph.

Moreover, aspects of the present disclosure are not limited to having a compiler programmed to generate a compartment configuration. In some embodiments, a linker (e.g., the illustrative linker 210 in the example of FIG. 2) may be programmed to generate part or all of a compartment configuration.

FIG. 5B shows an illustrative process 520 for annotating object code, in accordance with some embodiments. For instance, the process 520 may be performed by the illustrative policy linker 205 in the example of FIG. 2, which may be programmed to annotate object code with one or more metadata labels. The object code may be received from the illustrative compiler 205 and/or the illustrative linker 210. The one or more metadata labels may be obtained based on policy code received from the illustrative policy compiler 220.

At act 525, the policy linker 205 may annotate the object code for one or more compartment entries and/or one or more compartment exits. For instance, the policy linker 205 may receive a compartment transition graph and/or one or more compartment configurations from the compiler 205 and/or the linker 210. The policy linker 205 may use the compartment transition graph and/or the one or more compartment configurations to identify one or more entry points to a compartment (e.g., an entry point to a function belonging to the compartment). The policy linker 205 may then annotate such an entry point with a metadata label comprising a metadata symbol (e.g., CptEntry) used by a compartment entry rule of a compartmentalization policy (e.g., as described in connection with act 405 in the example of FIG. 4A).

Additionally, or alternatively, the policy linker 205 may use the compartment transition graph and/or the one or more compartment configurations to identify one or more exit points from a compartment (e.g., a return from a function belonging to the compartment). The policy linker 205 may then annotate such an exit point with a metadata label comprising a metadata symbol (e.g., CptExit) used by a compartment exit rule of the compartmentalization policy (e.g., as described in connection with act 405 in the example of FIG. 4A).

In some embodiments, for a given entry point, the policy linker 205 may determine a global identifier for a source compartment (e.g., based on the compartment configuration of the source compartment). Additionally, or alternatively, the policy linker 205 may determine a global identifier for a target compartment (e.g., based on the compartment configuration of the target compartment). The policy linker 205 may annotate the entry point with a metadata label comprising a metadata symbol indicating the global identifier for the source compartment and/or a metadata symbol indicating the global identifier for the target compartment.

In this manner, when a compartment entry rule is triggered at the entry point, the illustrative tag processing hardware 140 and/or the illustrative policy processor 150 in the example of FIG. 1 may determine, based on metadata associated with the entry point, the global identifier for the source compartment and/or the global identifier for the target compartment.

As discussed above, the inventor has recognized and appreciated that it may be undesirable to have a large number of different metadata symbols. For instance, as a total number of different metadata symbols increases, longer bitstrings may be used to represent different metadata labels, and a total number of different concrete rules may also increase (as there may be more possibilities for each slot in a concrete rule). Thus, more registers and/or memory (and hence chip area) may be used to store metadata labels and/or concrete rules, and/or more bandwidth (e.g., bus interface bandwidth) may be used to communicate metadata labels and/or concrete rules. Additionally, or alternatively, more computation resources may be used to manipulate metadata labels and/or concrete rules (e.g., encoding, decoding, comparison, lookup, etc.).

Accordingly, the policy linker 205 may determine a local identifier for the target compartment relative to the source compartment (e.g., from the compartment configuration of the source compartment). As explained in connection with the example of FIG. 5A, the local identifier for the target compartment relative to the source compartment may be shorter than the global identifier for the target compartment. Therefore, it may be advantageous to annotate the entry point with a metadata label comprising a metadata symbol indicating the local identifier for the target compartment relative to the source compartment, instead of a metadata symbol indicating the global identifier of the target compartment.

In this manner, when a compartment entry rule is triggered at the entry point, the tag processing hardware 140 and/or the policy processor 150 may determine, based on metadata associated with the entry point, the global identifier for the source compartment and/or the local identifier for the target compartment relative to the source compartment. The tag processing hardware 140 and/or the policy processor 150 may then provide, to the illustrative compartment check hardware 300 in the example of FIG. 3, the global identifier for the source compartment and/or the local identifier for the target compartment relative to the source compartment (e.g., via a compartment update request, as described in connection with the example of FIG. 4A).

In some embodiments, the compartment check hardware 300 may have loaded therein a compartment configuration of the source compartment. The compartment configuration may include a data structure (e.g., a lookup table) that maps local identifiers of target compartments relative to the source compartment, to global identifiers of the respective target compartments (e.g., as described in connection with the example of FIG. 5A). The compartment check hardware 300 may use this data structure to map a local identifier of the target compartment to a global identifier of the target compartment, and may use the global identifier to select a compartment configuration to be loaded (e.g., at act 415 in the example of FIG. 4A).

Referring again to the example of FIG. 5B, the policy linker 205 may, at act 530, annotate the object code for one or more memory accesses. For instance, as described in connection with act 455 in the example of FIG. 4B, one or more store and/or load instructions of a function belonging to a compartment may be annotated with a metadata label comprising a metadata symbol (e.g., CptMemAccess) used by a compartment memory check rule of a compartmentalization policy.

At act 535, the policy linker 205 may annotate one or more instructions in the object code as belonging to a compartment. For instance, one or more instructions of a function belonging to a compartment may be annotated with a metadata label comprising a metadata symbol (e.g., CptCode) used by a compartment code rule of a compartmentalization policy.

In some embodiments, the compartment code rule, when triggered, may cause the tag processing hardware 140 and/or the policy processor 150 to send a request to the illustrative compartment check hardware 300 to check whether an address from which an instruction is fetched is within a code address range of a current compartment. If the address from which the instruction is fetched is not within any code address range of the current compartment, the instruction may be disallowed. Otherwise, the instruction may be allowed.

It should be appreciated that aspects of the present disclosure are not limited to annotating object code with any particular metadata symbol, or any metadata symbol at all. Any suitable policy, or no policy at all, may be enforced, with any suitable metadata symbol or combination of metadata symbols.

FIG. 5C shows an illustrative process 540 for initializing compartment check hardware, in accordance with some embodiments. For instance, the process 540 may be performed by the illustrative loader 215 in the example of FIG. 2 to initialize the illustrative compartment check hardware 300 in the example of FIG. 3.

As described in the connection with the example of FIG. 2, the loader 215 may load code and/or data from one or more object files into an application memory (e.g., the illustrative application memory 120 in the example of FIG. 1). Accordingly, at act 545, the loader 215 may allocate one or more address ranges in the application memory 120. Then, at act 550, the loader may load the code and/or the data into the one or more address ranges allocated at act 545.

At act 555, the loader 215 may associate appropriate metadata with the code and/or the data loaded at act 550. For instance, as described in the connection with the example of FIG. 2, the loader 215 may use an initialization specification provided by the illustrative policy linker 210 to identify one or more metadata labels (e.g., the metadata labels described in connection with the example of FIG. 5B) to be associated with the data and/or the code loaded at act 550.

As described in the connection with the example of FIG. 1, The loader 215 may resolve the one or more metadata labels into one or more respective binary representations, store the one or more binary representations in a metadata memory (e.g., the illustrative metadata memory 125) and/or a register file (e.g., the illustrative tag register file 146), and/or create associations via one or more tag map table entries (e.g., one or more entries in the illustrative tag map table 142).

In some embodiments, the loader 215 may associate appropriate metadata with one or more locations in the application memory 120 and/or one or more registers of the illustrative host processor 110 in the example of FIG. 1. For instance, the loader 215 may receive a compartment configuration generated by the illustrative compiler 205 and/or the illustrative linker 210 in the example of FIG. 2, and may use the compartment configuration to identify one or more address ranges for data to be manipulated by instructions of a corresponding compartment. The loader 215 may associate each identified address range with a metadata label comprising a metadata symbol (e.g., CptMem) used by a compartment memory check rule of a compartmentalization policy. Such a metadata label may be provided by the illustrative policy linker 225 in the example of FIG. 2.

Similarly, the loader 215 may use the compartment configuration to identify one or more address ranges for code belonging to the corresponding compartment. The loader 215 may associate each identified address range with a metadata label comprising a metadata symbol (e.g., CptCode) used by a compartment code rule of a compartmentalization policy. Such a metadata label may be provided by the policy linker 225.

The loader 215 may receive the compartment configuration in any suitable manner. For example, the policy linker 225 may receive the compartment configuration from the compiler 205 and/or the linker 210, and may provide the compartment configuration to the loader 215 (e.g., as part of an initialization specification).

Referring again to the example of FIG. 5C, the loader 215 may, at act 560, update one or more compartment configurations. For instance, a compartment configuration generated by the compiler 205 and/or the linker 210 may not include an address range in the application memory 120 that is allocated at load time by the loader 215. Accordingly, such an address range, once allocated, may be added to the compartment configuration.

For instance, the loader 215 may use a compartment configuration to identify one or more portions of code belonging to a corresponding compartment. For an identified portion of code, the loader 215 may update the compartment configuration with an address range into which the portion of code is loaded at act 550.

Additionally, or alternatively, the loader 215 may use the compartment configuration to identify one or more portions of data to be manipulated by the code of the corresponding compartment. For an identified portion of data, the loader 215 may update the compartment configuration with an address range into which the portion of data is loaded at act 550.

It should be appreciated that aspects of the present disclosure are not limited to allocating an address range at any particular time. Different address ranges may be allocated at different times, such as compile, link, load, and/or run time.

Referring again to the example of FIG. 5C, the loader 215 may, at act 565, initialize the compartment check hardware 300. As an example, the loader 215 may load a compartment transition graph into a main memory accessible to the compartment check hardware 300. The compartment transition graph may be generated by the compiler 205 and/or the linker 210 (e.g., as described in connection with the example of FIG. 5A), and may be provided to the loader 215 via the policy linker 225 (e.g., as part of an initialization specification).

In some embodiments, the main memory may be separated from the application memory 120 (e.g., physically, or logically via a suitable scheme enforced by a memory protection component). For instance, the main memory may be part of the illustrative metadata memory 125 in the example of FIG. 1.

As another example, the loader 215 may load one or more compartment configurations into the main memory accessible to the compartment check hardware 300. For instance, the loader 215 may use the compartment transition graph to identify an initial compartment configuration and/or one or more compartment configurations that are likely to be encountered in the near future (e.g., within one, two, three, . . . compartment transition(s)).

In some embodiments, compartment configurations may be loaded into memory in an encoded form. Any suitable encoding scheme may be used, which may output fixed-length or variable length encodings. For a variable-length encoding scheme, a designated marker may be used to indicate where a compartment configuration ends.

In some embodiments, the loader 215 may send an initialization signal to the compartment check hardware 300, for example, by writing to one or more registers accessible to the compartment check hardware 300, or via a bus interface (e.g., as described in connection with the configuration update request in the example of FIG. 4A). The initialization signal may indicate one or more address ranges at which the compartment check hardware 300 may access the one or more compartment configurations and/or the compartment transition graph loaded into a main memory by the loader 215.

Additionally, or alternatively, a suitable address range in the main memory may be allocated for each compartment configuration, and a start address of each such address range may be used as a global identifier for a corresponding compartment. In this manner, the compartment check hardware 300 may simply use a global identifier of a compartment to access a compartment configuration for that compartment from the main memory.

Although certain details of implementation are described in connection with the examples of FIGS. 5A-5C, it should be appreciated that aspects of the present disclosure are not limited to any particular manner of implementation. For instance, in some embodiments, the one or more compartment configurations and/or the compartment transition graph may be provided directly via an interface of the compartment check hardware 300. This may simplify the compartment check hardware 300, thereby reducing chip area. (For example, there may be no need to include logic for loading the one or more compartment configurations and/or the compartment transition graph.) However, a significant amount of data bandwidth may be used to transfer the one or more compartment configurations and/or the compartment transition graph via the interface of the compartment check hardware 300, and thus performance may be negatively impacted.

The inventor has recognized and appreciated that, in some instances, memory may be allocated and/or deallocated for a compartment at run time. As an example, even if a size of a portion of code is known at load time, the portion of code may not be loaded right away (e.g., due to on-demand loading), and an address range in the application memory 120 may not be known until later, when the portion of code is actually loaded. As another example, a size of a portion of data may not be known at load time due to dynamic variable declaration.

The inventor has further recognized and appreciated that, if an address range is allocated for a compartment at run time, the loader 215 may be unable to associate the address range with an appropriate metadata label at load time.

Accordingly, techniques are provided herein for using metadata processing (e.g., by the illustrative tag processing hardware 140 and/or the illustrative policy processor 150 in the example of FIG. 1) to determine whether to trigger a compartment check, while deferring details of the check to the illustrative compartment check hardware 300 in the example of FIG. 3. The former (i.e., whether to check) may be determined based on statically available information, whereas the latter (i.e., what to check) may be determined based on information that is available only at run time (e.g., addresses and/or sizes of dynamically allocated address ranges).

For instance, in some embodiments, one or more functions of a runtime library (e.g., malloc) may be used to associate an appropriate metadata label with an address range allocated for a compartment at run time. As an example, the address range may be allocated to hold a portion of data manipulated by one or more instructions belonging to the compartment, and therefore may be associated with a metadata label comprising a metadata symbol (e.g., CptMem) used by a compartment memory check rule of a compartmentalization policy to indicate compartment memory.

As another example, the address range may be allocated to hold a pointer used by one or more instructions belonging to the compartment, and therefore may be associated with a metadata label comprising a metadata symbol (e.g., CptPtr) used by the compartment memory check rule of the compartmentalization policy to indicate a compartment pointer.

In some embodiments, a selected instruction of a runtime library function (e.g., malloc) may be associated with a metadata label comprising a metadata symbol used by a memory allocation rule of a compartmentalization policy to indicate dynamic memory allocation. When such an instruction is executed by the illustrative host processor 110 in the example of FIG. 1, the tag processing hardware 140 may construct an input pattern based on the instruction, and the input pattern may match the memory allocation rule.

For instance, the runtime library function may calculate a start address, an end address, and/or a size of an address range being allocated, and may store such information to memory via one or more store instructions. Such a store instruction may be tagged as described above to trigger the memory allocation rule.

In some embodiments, the memory allocation rule, when triggered, may cause the tag processing hardware 140 and/or the policy processor 150 to associate a suitable metadata label with an allocated address range, such as a metadata label comprising a metadata symbol (e.g., CptMem or CptPtr) used by a compartment memory check rule of the compartmentalization policy.

Additionally, or alternatively, the memory allocation rule, when triggered, may cause the tag processing hardware 140 and/or the policy processor 150 to send a compartment update request to the compartment check hardware 300 (e.g., by writing to one or more registers accessible to the compartment check hardware 300, or via a bus interface). The compartment update request may notify the compartment check hardware 300 that an address range is being allocated for a compartment.

As an example, the compartment update request may include information that may be used by the compartment check hardware 300 to determine the address range (e.g., a start address, an end address, and/or a size of the address range). As another example, the compartment update request may include information that may be used by the compartment check hardware 300 to determine the compartment (e.g., a global identifier of the compartment).

Accordingly, the compartment check hardware 300 may select, load, and/or update a compartment configuration corresponding to the compartment (e.g., as described in connection with act 415 in the example of FIG. 4A).

It should be appreciated that aspects of the present disclosure are not limited to notifying the compartment check hardware 300 in any particular manner, or at all. In some embodiments, the runtime library function may store information relating to the address range (e.g., a start address, an end address, a size, etc.) to memory. As a result, such information may be present on a data bus of the host processor 110 for a certain duration of time. Accordingly, an instruction of the runtime library function may be selected for tagging so that the memory allocation rule may be triggered at an appropriate time, to cause the tag processing hardware 140 and/or the policy processor 150 to instruct the compartment check hardware 300 to capture the information relating to the address range from the data bus of the host processor 110.

Furthermore, aspects of the present disclosure are not limited to adding a newly allocated address range to a compartment configuration of an existing compartment. In some embodiments, the compartment check hardware 300 may create a new compartment for a newly allocated address range. As an example, if the runtime library function is called repeatedly (e.g., in a loop), a new compartment may be created for each instance of the runtime library function. This may simplify the compartment check hardware 300, thereby reducing chip area. (For example, there may be no need to include logic for handling multiple address ranges within the same compartment.)

Further still, aspects of the present disclosure are not limited to using metadata processing to trigger compartment updates. In some embodiments, a compiler (e.g., the illustrative compiler 205 in the example of FIG. 2) may be configured to insert one or more instructions into a runtime library function (e.g., malloc). For instance, one or more instructions may be inserted before or after an instruction that stores information relating to an address range (e.g., a start address, an end address, a size, etc.) to memory. Such inserted instruction(s), when executed, may cause the host processor 110 to send, to the compartment check hardware 300, a compartment update request similar to that sent by the tag processing hardware 140 and/or the policy processor 150, as described above.

Additionally, or alternatively, the compiler 205 may be configured to insert one or more instructions into a block of code corresponding to a compartment (e.g., at a start or an end of the block of code). The inserted instruction(s), when executed, may cause the host processor 110 to send, to the compartment check hardware 300, a compartment check request similar to that sent by the tag processing hardware 140 and/or the policy processor 150, as described in connection with the example of FIG. 4A.

In some embodiments, the compiler 205 may determine what instruction(s) to insert, and/or where to insert such instruction(s), based on a compartmentalization policy, similar to how the illustrative policy linker 225 in the example of FIG. 2 determines what metadata symbol(s) to apply, and/or where to apply such metadata symbol(s) (e.g., as described in connection with the example of FIG. 5B). For instance, the compiler 205 may insert an instruction to cause the host processor 110 to provide, to the compartment check hardware 300, a global identifier for a source compartment, a global identifier for a target compartment, and/or a local identifier for the target compartment relative to the source compartment.

The inventor has recognized and appreciated that triggering compartment updates or checks via inserted code executed by the host processor 110 may be slower and/or less secure than doing so via metadata processing by the tag processing hardware 140. However, this may allow compartment checks to be implemented in systems that lack sufficient resources (e.g., power, chip area, etc.) to implement any tag processing hardware.

Although examples of compartments are provided throughout that include both a data address range and a code address range, it should be appreciated that aspects of the present disclosure are not so limited. In some embodiments, a compartment may include one or more data address ranges only. For instance, when a runtime library function (e.g., malloc) is called at run time to allocate a data address range, a new compartment may be created for the allocated data address range (e.g., as described in connection with the example of FIG. 4A), and may be associated with a local identifier relative to a compartment that has called the runtime library function to allocate the address range (hereafter, the calling compartment).

Additionally, or alternatively, the runtime library function may return a pointer that points to the allocated data address range, and the pointer may be associated with a metadata label comprising a metadata symbol indicating the local identifier of the new compartment relative to the calling compartment. As the pointer is returned to the calling compartment, a compartment configuration of the calling compartment may be updated to map the local identifier of the new compartment to a global identifier of the new compartment. Additionally, or alternatively, a compartment configuration of the new compartment may be updated with a global identifier of the calling compartment.

In some embodiments, when a load instruction is executed that attempts to access the allocated data address range, a compartment check request may be triggered (e.g., as described in connection with the example of FIG. 4B). For instance, the compartment check request may indicate a global identifier of the new compartment, which may be used by the compartment check hardware 300 to load the compartment configuration of the new compartment. The compartment check hardware 300 may obtain the global identifier of the calling compartment from the compartment configuration of the new compartment. The compartment check hardware 300 may then load the compartment configuration of the calling compartment, and/or check whether an address from which the load instruction is fetched is within a code address range of the calling compartment.

Additionally, or alternatively, the compartment check request may indicate a compartment identifier associated with a pointer used by the load instruction, and the compartment check hardware 300 may check whether that compartment identifier matches the local identifier of the new compartment relative to the calling compartment.

In some embodiments, a compartment may include one or more code address ranges only. For instance, a block of code may have no data address range that is statically allocated. When a data address range is dynamically allocated for such a block of code, a new compartment may be created for the data address range, and may be accessible from a compartment for the block of code via a local identifier, as described above.

As described above, the tag processing hardware 140 in the example of FIG. 1 may, in some embodiments, include a policy check function implemented in hardware (e.g., via programmable or fabricated logic, or otherwise at hardware speed). Such a policy check function may be applied to an input pattern constructed based on an instruction to be checked to determine if the instruction is allowed. In some embodiments, if the instruction is allowed, the policy check function may provide an output pattern.

Thus, a policy check function may be used instead of, or in addition to, the illustrative policy processor 150 and/or the illustrative rule table 144 in the example of FIG. 1.

As described in connection with the example of FIG. 1, the rule table 144 may be implemented using a hash function and a selected memory, such as an on-chip RAM. For instance, a rule entry may include an input pattern in binary form (e.g., with one or more respective binary representations substituted for one or more input metadata labels). Additionally, or alternatively, the rule entry may include an output pattern in binary form (e.g., with one or more respective binary representations substituted for one or more output metadata labels). A hash function may be applied to the input pattern in binary form to generate an address in the selected memory. The rule entry may be stored at that address in the selected memory.

The inventor has recognized and appreciated that a rule collision may occur in such an implementation. For instance, a rule entry having a first input pattern may be installed into the rule table 144. Subsequently, the rule table 144 may be queried with a second input pattern, which may be different from the first input pattern, but may hash to the same address. The rule table 144 may retrieve the rule entry from the selected memory, only to determine that the second input pattern does not match the first input pattern stored in the retrieved rule entry. Thus, the retrieved rule entry may be inapplicable, and the illustrative policy processor 150 in the example of FIG. 1 may be queried with the second input pattern.

The inventor has recognized and appreciated that rule collisions may result in a performance degradation, especially if multiple collisions happen in close succession. For example, two concrete rules that are triggered frequently may happen to have input patterns that hash to the same address. This may cause thrashing, where the two rules may alternately cause each other to be evicted from the rule table 144, even if other addresses in the rule table 144 may still be available to store concrete rules.

Moreover, the inventor has recognized and appreciated that implementing a rule table in hardware may be costly in terms of chip area. For instance, an input pattern may be stored for each concrete rule installed into the rule table, which may use a significant amount of RAM. As a result, more chip area may be used to provide the RAM.

Accordingly, in some embodiments, techniques are provided for determining, based on an input pattern in binary form, whether an instruction giving rise to the input pattern is allowed, without using a rule table.

The inventor has recognized and appreciated that a rule table may be viewed as a hardware implementation of a function that maps input patterns in binary form to one or more results, such as the following: (i) the instruction is disallowed without any error message, (ii) the instruction is disallowed with one or more error messages, (iii) the instruction is allowed without any output metadata label, and/or (iv) the instruction is allowed with one or more output metadata labels. Such a function may be referred to herein as a “policy check function.”

Indeed, a rule table may implement a policy check function by storing input patterns and corresponding results as ordered pairs (both in binary form), so that an application of the policy check function may involve looking up an input pattern in the set of ordered pairs stored in the rule table.

The inventor has recognized and appreciated that such a storage-and-lookup approach may be inefficient in terms of power consumption, performance, and/or chip area. For example, consider the function f(x)=2*x. This function may be implemented in hardware by storing the following ordered pairs in a cache (where all values are in binary form).

| Input x | Output f(x) = 2*x |
|---|---|
| 0 | 0 |
| 1 | 10 |
| 10 | 100 |
| 11 | 110 |
| 100 | 1000 |
| Etc. | Etc. |

In some implementations, each cache lookup may involve computing a hash of an input value x, using the hash to locate an entry in a cache memory, and determining if the input value x matches the located entry. That may lead to increased power consumption and/or decreased performance. Moreover, if a number of possible input values is large, a significant amount of chip area may be used to store all possible ordered pairs. To reduce chip area, only some (but not all) possible ordered pairs may be stored in the cache. However, as a result, a miss may occur, namely, looking up an input value x that is not present in the cache. In response, a software function may be invoked to compute f(x). That may also lead to increased power consumption and/or decreased performance (e.g., due to overhead involved for exception processing, context switching, etc.).

By contrast, it may be much more efficient to implement the function f(x)=2*x in hardware, for example, with programmable or fabricated logic configured to compute f(x) (e.g., by performing a left shift on an input value x, with or without handling any most significant bit being shifted off). In this manner, no cache lookup (and hence no hashing) may be performed, which may decrease power consumption and/or increase performance. Furthermore, ordered pairs are no longer stored, and therefore chip area may be significantly reduced. Further still, miss processing may not be performed, which may also decrease power consumption and/or increase performance.

Thus, the inventor has recognized and appreciated that it may be desirable to implement a policy check function in hardware, for example, with programmable or fabricated logic configured to compute a result from an input pattern in binary form. This may allow a rule table to be eliminated, or significantly reduced in size.

However, the inventor has also recognized and appreciated that different policy check functions may arise depending on which one or more policies are being enforced. Therefore, it may be desirable to provide processing hardware that is programmable to compute different policy check functions.

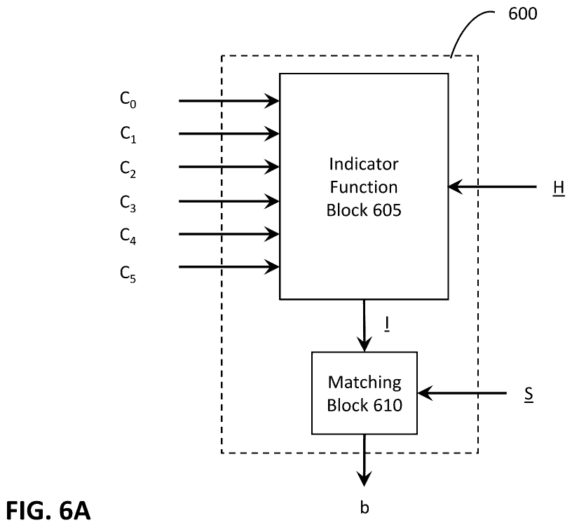

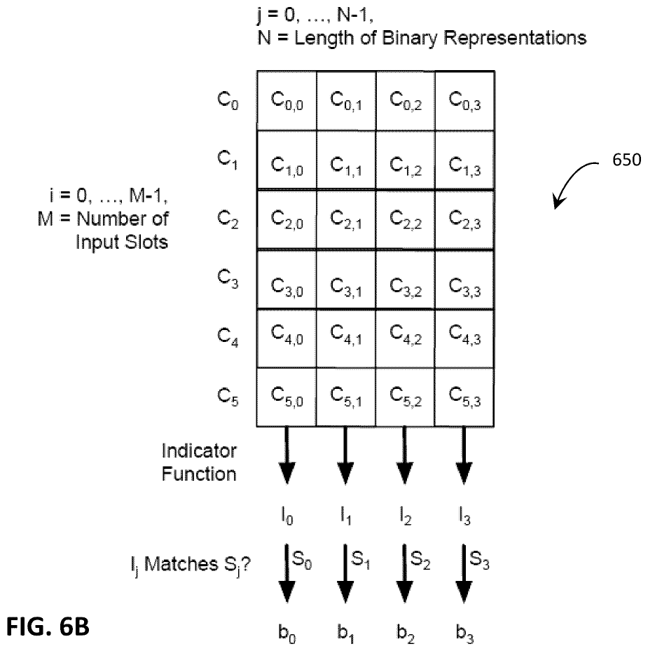

FIG. 6A shows an illustrative hardware block 600 implementing a policy check function, in accordance with some embodiments. In this example, there are six input slots, and there is no output slot. Accordingly, an input pattern may include up to six metadata labels, one for each input slot. A result may include one bit indicating whether an instruction giving rise to the input pattern is allowed.

Thus, the policy check function may map a sextuple of bit strings, <C₀, . . . , C₅>, to a single bit, b. Each bit string Cᵢ (i=0, . . . , 5) may be a binary representation of a metadata label Lᵢ for a corresponding input slot. The bit b may indicate whether an instruction giving rise to the input pattern, <L₀, . . . , L₅>, is allowed.

In the example of FIG. 6A, the hardware block 600 includes an indicator function block 605 and a matching block 610. The indicator function block 605 may be configured to process the input bit strings C₀, . . . , C₅, and output an indicator I. An illustrative implementation of the indicator function block 605 is described below in connection with the example of FIG. 6B.

In some embodiments, the matching block 610 may be configured to determine if the indicator I matches a parameter S. For instance, the matching block 610 may be configured to check if the indicator I equals the parameter S. However, it should be appreciated that aspects of the present disclosure are not limited to checking for equality. For instance, in some embodiments, the matching block 610 may be configured to perform one or more other comparison operations (e.g., greater than or less than) to the indicator I and the parameter S.

In some embodiments, the parameter S may be chosen based on one or more policies being enforced, and may be updated dynamically. By contrast, in some embodiments, the indicator function block 605 and/or the matching block 610 may be used regardless of which one or more policies are being enforced. For instance, the indicator function block 605 may be implemented via programmable or fabricated logic (or otherwise in hardware), and likewise for the matching block 610.

However, it should be appreciated that aspects of the present disclosure are not limited to choosing the parameter S in any particular manner, or having a parameter S at all. In some embodiments, the matching block 610 may have no parameter. For instance, the matching block 610 may be configured to perform one or more unary operations (e.g., a parity check) on an indicator I.

FIG. 6B shows an illustrative array 650 of bits, in accordance with some embodiments. The array 650 has M rows and N columns, where M is a number of input slot(s), and N is a length of binary representation(s). In this example, there are six input slots (i.e., M=6), and hence there are six rows. These rows may correspond, respectively, to the bit strings C₀, . . . , C₅ in the example of FIG. 6A.

Moreover, in the example of FIG. 6B, each bit string Cᵢ is 4-bit long (i.e., N=4), and hence there are four columns. Such columns may be referred to herein as “bit lanes.”

In some embodiments, a policy check function may compute, for each bit lane j in the array 650, an indicator Iⱼ. The indicator Iⱼ may be compared against a parameter Sⱼ of the policy check function (e.g., at the illustrative matching block 610 in the example of FIG. 6A). If the indicator Iⱼ matches the corresponding parameter Sⱼ for every j=0, . . . , N−1, then the policy check function may return b=1, indicating that the instruction giving rise to the input pattern, <L₀, . . . , L₅>, is allowed. If the indicator Iⱼ does not match the corresponding parameter Sⱼ for any j=0, . . . , N−1, then the policy check function may return b=0, indicating that the instruction giving rise to the input pattern, <L₀, . . . , L₅>, is disallowed.

Given any bit lane j=0, . . . , N−1, an indicator Iⱼ may have any suitable number of one or more bits, and likewise for a parameter Sⱼ. The number of bit(s) in the indicator Iⱼ may be the same as, or different from, the number of bit(s) in the parameter Sⱼ.

In some embodiments, an indicator function Ind may be used to compute the indicator Iⱼ for each bit lane j in the array 650. For example, Iⱼ may be computed as Ind(C_{0,j}: . . . : C₅ⱼ), where: denotes concatenation of bits to form a bit string. The inventor has recognized and appreciated that, if the indicator function Ind may be readily computed in hardware, then the resulting policy check function may also be readily computed in hardware.

For instance, given a hardware block implementing the indicator function Ind, the resulting policy check function may be implemented by: (i) duplicating the hardware block N times (if N>1), once for each bit lane j; (ii) comparing an indicator output Iⱼ in each bit lane j against the corresponding parameter Sⱼ; and (iii) combining resulting bits b₀, . . . , b_{N-1} with an AND operator.

An indicator output Iⱼ in a bit lane j may be compared against a corresponding parameter Sⱼ in any suitable manner. In some embodiments, Sⱼ may be a bit string of all zero(s). Accordingly, one or more bits of the indicator output Iⱼ may be combined with an OR operator to determine if each of the one or more bits is 0. Additionally, or alternatively, Sⱼ may be a bit string of all one(s). Accordingly, one or more bits of the indicator output Iⱼ may be combined with an AND operator to determine if each of the one or more bits is 1.

Additionally, or alternatively, the parameter Sⱼ may be stored in a first register, and the indicator output Iⱼ may be stored in a second register. An equality test circuit may be used to determine if the contents of these registers are equal.

The inventor has recognized and appreciated that an indicator function Ind may partition the set of bit strings of length M (in this example, M=6) into a plurality of subsets. For instance, given an indicator value S, there may be a subset of zero or more bit strings X of length 6 such that Ind (X)=S.

Accordingly, the indicator function Ind may induce a partition of the set of N-tuples of bit strings of length M (in this example, N=4 and M=6). For instance, given a quadruple <S₀, . . . , S₃> of indicator values, there may be a subset of quadruples <X₀, . . . , X₃> of bit strings of length 6 such that Ind(Xⱼ)=Sⱼ, for each j=0, . . . , 3. (The function that maps <X₀, . . . , X_{N-1}> to <Ind(X₀), . . . , Ind(X_{N-1})> may be written herein as Ind^{N}.)

Furthermore, the inventor has recognized and appreciated that there may be a one-to-one correspondence (e.g., via transposition) between the set of N-tuples of bit strings of length M and the set of M-tuples of bit strings of length N. Therefore, the indicator function Ind may induce a partition of the set of M-tuples of bit strings of length N. For instance, given an N-tuple S=<S₀, . . . , S_{N-1}> of indicator value(s), there may be a subset of zero or more M-tuples <C₀, . . . , C_{M-1}> of bit string(s) of length N such that:

Ind_{N}(C₀, . . . , C_{M-1})=<Ind(C_{0,0}: . . . : C_{M-1,0}) , . . . , Ind(C_{0,N-1}: . . . : C_{M-1,N-1})>=<S₀, . . . , S_{N-1}>.

Such a subset may be referred to herein as a “pre-image” of S under the function Ind^{N}. Thus, the policy check function described above, parameterized by S, may simply be a membership check for the pre-image of S under the function Ind^{N}.

However, it should be appreciated that aspects of the present disclosure are not limited to checking that an indicator output Iⱼ matches the corresponding parameter Sⱼ for every bit lane j. In some embodiments, the illustrative matching block 610 in the example of FIG. 6A may compare the indicator output Iⱼ against the corresponding parameter Sⱼ in each bit lane j, and then combine the resulting bits b₀, . . . , b_{N-1} using any suitable logical circuit, in addition to, or instead of, an AND operator.

For instance, the matching block 610 may be programmable to implement any logical formula F. In that respect, any logical formula F may be written in disjunctive normal form, F₀∨ . . . ∨ F_{A}, where each Fₐ may be a conjunction of one or more of the bits b₀, . . . , b_{N-1}, ¬b₀, . . . , ¬b_{N-1} (where ¬ denotes negation). The matching block 610 may be programmed to implement the formula F by: (i) for each j, applying an inverter to bⱼ to obtain ¬bⱼ; (ii) for each Fₐ, applying an AND operator to the corresponding one or more of the bits b₀, . . . , b_{N-1}, ¬b₀, . . . ,¬b_{N-1}; and (iii) applying an OR operator to F₀ . . . , F_{A}.

The inventor has recognized and appreciated that a logical formula F may correspond to a subset of M-tuples of bit strings of length N. For instance, for any given bit lane j, bⱼ may correspond to the preimage of the parameter Sⱼ under the indicator function Ind (or Indⱼ, if different indicator functions are used for the different bit lanes, as described below), and ¬bⱼ may correspond to the complement of that preimage. Furthermore, each Fₐ may correspond to an intersection of one or more such preimages and/or complements thereof, and F may correspond to a union of such intersections.

In this manner, the policy check function may be a membership check for the subset of M-tuples of bit strings of length N corresponding to the logical formula F implemented by the matching block 610. In some embodiments, the logical formula F may be treated as a parameter of the policy check function, although aspects of the present disclosure are not so limited.

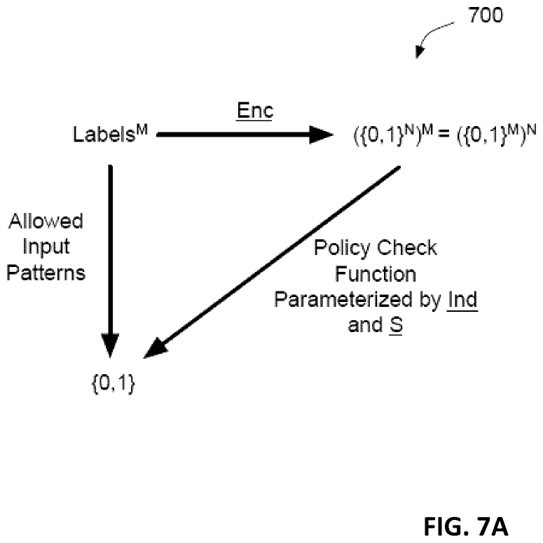

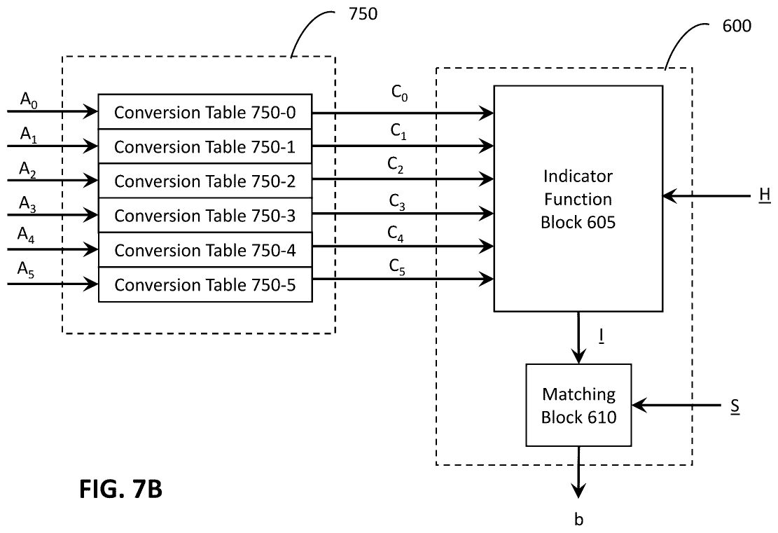

FIG. 7A shows an illustrative arrangement 700 of functions, in accordance with some embodiments. In this example, Labels denotes a set of metadata labels, and Labels denotes a set of input patterns, where each input pattern includes an M-tuple <L₀, . . . , L_{M-1}> of metadata labels (M>=1). The arrow from Labels^{M} to {0,1} may denote a function that maps an input pattern to a bit b indicating whether an instruction giving rise to the input pattern is allowed. Such a function may be determined based on one or more policies to be enforced. For instance, one or more input patterns may be identified that are mapped to 1 (indicating allowed).

In the example of FIG. 7A, Enc denotes an encode function that maps a metadata label L to a corresponding binary representation C (e.g., a bit string of length N, N>=1), and Enc denotes a function that maps an M-tuple <L₀, . . . , L_{M-1}> of metadata label(s) to an M-tuple <C₀, . . . , C_{M-1}> of corresponding binary representation(s), where Cᵢ=Enc(Lᵢ) (i=0, . . . , M−1). Thus, in this example, Enc=Enc^{M}.

The inventor has recognized and appreciated that, if an encode function Enc may be selected such that all allowed input patterns are mapped by Enc_{M} into a pre-image of a single N-tuple S=<S₀, . . . , S_{N-1}> of indicator value(s), then a policy check function parameterized by S may provide correct answers for all binary representations of allowed input patterns. Indeed, given an input pattern <L₀, . . . , L_{M-1}> that is mapped to 1 (indicating allowed), if the corresponding binary representation(s)<C₀, . . . , C_{M-1}> is in the pre-image of S, then the policy check function parameterized by S may map <C₀, . . . , C_{M-1}> to 1 (indicating allowed). This is because, as discussed above, the policy check function parameterized by S may simply be a membership check for the pre-image of S.

Accordingly, in some embodiments, techniques are provided for selecting an encode function Enc and/or an N-tuple S=<S₀, . . . , S_{N-1}> of indicator value(s) such that all allowed input patterns are mapped by Enc^{M} into a pre-image of S under a suitable function Ind. For instance, Ind may be Ind_{N}, for some suitable indicator function Ind.

In some embodiments, an indicator I may be a bit string i₀: . . . : i_{V-1} of length V for some suitable V>=1. Thus, an indicator function Ind may map a bit string X=x₀: . . . : X_{M-1} of length M to a bit string Ind(X)=i₀: . . . : i_{V-1} of length V. For instance, Ind(X) may be computed based on the following equation:

Ind(X)^{T}=HX^{T},

where the superscript T denotes matrix transpose (e.g., flipping a row vector into a column vector, or vice versa), and H is an VxM parity check matrix. Thus, in this example, Ind(X) may be a syndrome of X.

In some embodiments, the following parity check matrix H (where V=3 and M=6) may be used.

| | | | | | |
|---|---|---|---|---|---|
| 1 | 1 | 0 | 1 | 0 | 0 |
| 1 | 0 | 1 | 0 | 1 | 0 |
| 0 | 1 | 1 | 0 | 0 | 1 |

The inventor has recognized and appreciated that the indicator function Ind based on the parity check matrix H may be readily computed in hardware. For instance, matrix multiplication may be implemented in hardware by using an AND operator for multiplication and/or an XOR operator for addition. Thus, as discussed above, the resulting policy check function may also be readily computed in hardware.

In some embodiments, the parity check matrix H may be implemented using V register(s) (e.g., in the illustrative indicator function block 605 in the example of FIG. 6B), where each register may store M bit(s) (e.g., V=3 and M=6). Thus, the parity check matrix H may be programmed by modifying the bit string(s) of length M stored in the V register(s), and the corresponding indicator function Ind may be treated as a parameter of the policy check function.

However, it should be appreciated that aspects of the present disclosure are not limited to treating an indicator function as a parameter. For instance, the inventor has recognized and appreciated that setting aside registers for storing a parity check matrix may increase chip area. Accordingly, in some embodiments, a parity check matrix may be selected ahead of time, and may be fixed in hardware (e.g., in programmable or fabricated logic).

Although certain details of implementation are described in connection with the examples of FIGS. 6A-B and 7A, it should be appreciated that aspects of the present disclosure are not limited to any particular manner of implementation. For instance, aspects of the present disclosure are not limited to using any particular parity check matrix, or any parity check matrix at all, to compute an indicator.

It should also be appreciated that aspects of the present disclosure are not limited to any particular number N of one or more bits in a binary representation of a metadata label, any particular number M of one or more input slots, or any particular number V of one or more bits in an indicator value.

It should also be appreciated that Ind^{N} may be viewed as a product Ind where all component(s) Indⱼ are identical, and Ind may be viewed as a product Ind with just one component. Each of these may be referred to herein as an indicator function, and may be treated as a parameter of a policy check function.

However, aspects of the present disclosure are not limited to using a common indicator function Ind for all bit lanes j=0, . . . , N−1 (where N>1). In some embodiments, different bit lanes j may have different indicator functions Indⱼ, and a product of such indicator functions, Ind =<Ind₀, . . . , Ind_{N-1}>, may be used. For instance, different matrices Hⱼ may be provided for different bit lanes j=0, . . . , N−1. Indⱼ(X) may be computed based on the following equation: Indⱼ(X)^{T}=HⱼX^{T}.

Furthermore, aspects of the present disclosure are not limited to computing a separate indicator for each bit lane j. In some embodiments, the policy check function may have a parameter S, and an indicator function Ind may map an M-tuple <C₀, . . . , C_{M-1}> of bit string(s) of length N to an indicator I, which may be compared against the parameter S. The parameter S may be a tuple of one or more values, and likewise for the indicator I. A length of the indicator I may be the same as, or different from, a length of the parameter S.

For instance, an indicator I may be computed by hashing one or more bits from the bit string(s) C₀, . . . , C_{M-1} to obtain a hash value, and using the hash value to look up a result bit b from a table. As an example, one or more of bitstrings Cᵢ (i=0, . . . , M−1) may be selected, and a substring C′ᵢ may be selected from each of the selected bitstring(s) Cᵢ. The selected substring(s) C′ᵢ may then be concatenated and/or hashed. The selected substring(s) C′ᵢ may be from the same bit position(s) (e.g., the least significant byte) of the selected bit string(s) Cᵢ, or from different bit position(s).

In some embodiments, given a hardware block implementing such an indicator function Ind (e.g., the illustrative indicator function block 605 in the example of FIG. 6A), a resulting policy check function may be implemented simply by adding a comparison circuit (e.g., in the illustrative matching block 610 in the example of FIG. 6A). The comparison circuit may implement an equality check, or some other suitable comparison, between a stored parameter S and an output I of the hardware block implementing the indicator function Ind.

Further still, aspects of the present disclosure are not limited to computing indicators for bit lanes. In some embodiments, one or more indicators may be computed for one or more input slots (e.g., one or more rows in the example of FIG. 6B), in addition to, or instead of, one or more bit lanes (e.g., one or more columns in the example of FIG. 6B).

It should also be appreciated that aspects of the present disclosure are not limited to mapping allowed input patterns into a single pre-image. In some embodiments, a policy check function may check if an input pattern belongs to one of multiple pre-images. For instance, a policy check function may have two parameters S and S′ (e.g., S=<S₀, . . . , S_{N-1}> and S′=<S′₀, . . . , S′_{N-1}>), and the policy check function may check if an input pattern belongs to a pre-image of S or a pre-image of S′.

It should also be appreciated that Enc^{M} may be viewed as a product Enc where all component(s) Encᵢ are identical, and Enc may be viewed as a product Enc with just one component. Each of these may be referred to herein as an encode function.

However, aspects of the present disclosure are not limited to using a common encode function Enc for all input slots (where M>1). In some embodiments, different input slots i may have different encode functions Encᵢ, and a product of such encode functions, Enc=<Enc₀, . . . , Enc_{M-1}>, may be used. For instance, if a metadata label L appears in an input slot i, an encoding of L for the input slot i may be Cᵢ=Encᵢ(L). If the same metadata label L also appears in a different input slot i′, an encoding of L for the input slot i′ may be C_{i′}=Enc_{i′}(L). Thus, the metadata label L may have a different encoding depending on an input slot in which the metadata label L appears.

The inventor has recognized and appreciated that having different encode functions for different input slots may increase degrees of freedom, which may in turn increase a likelihood that a suitable set of encodings for metadata labels may be found. However, it should be appreciated that aspects of the present disclosure are not so limited.

FIG. 7B shows an illustrative conversion block 750, in accordance with some embodiments. For instance, the conversion block 750 may be used to convert an M-tuple <A₀, . . . , A_{M-1}> of bit string(s) of length N′ to an M-tuple <C₀, . . . , C_{M-1}> of bit string(s) of length N, for some suitable M, N, N′>=1. The input M-tuple <A₀, . . . , A_{M-1}> may be a result of applying a suitable encode function Enc to an input pattern <L₀, . . . , L_{M-1}>. For instance, <A₀, . . . , A_{M-1}>=Enc^{M}<L₀, . . . , L_{M-1}>=<Enc(L₀), . . . , Enc(L_{M-1})>. The output M-tuple <C₀, . . . , C_{M-1}> may be provided as input to the illustrative hardware block 600 in the example of FIG. 6A.

In some embodiments, N may be strictly greater than N′, so that the conversion block 750 may be an expansion block. In some other embodiments, N may be strictly less than N′, so that the conversion block 750 may be a compression block. In some other embodiments, N may be equal to N′.

In some embodiments, the conversion block 750 may include a storage (e.g., an on-chip RAM) having M conversion table(s). For instance, in the example of FIG. 7B, there are six conversion tables 750-0, . . . , 750-5. Given an input slot i, the encoding Aᵢ may be used to look up the conversion table 750-i to retrieve a corresponding Cᵢ. Therefore, in this example, Encᵢ may be Enc followed by a mapping implemented by the conversion table 750-i, for each i=0, . . . , M−1.

In an embodiment where N′ is strictly smaller than N, the mapping implemented by the table 750-i (i=0, . . . , M−1) may be viewed as an expansion function Expᵢ. Each such expansion function Expᵢ may have a corresponding compression function Compᵢ that maps a bit string of length N (e.g., Cᵢ) to a bit string of length N′ (e.g., Aᵢ).

It should be appreciated that aspects of the present disclosure are not limited to implementing a conversion table in any particular manner, or at all. In some embodiments, a conversion table 750-i may be populated before run time (e.g., at compile time, link time, and/or load time) by applying a corresponding compression function Compᵢ to binary representations of length N (e.g., Cᵢ) to obtain binary representations of length N′ (e.g., Aᵢ). A binary representation of length N′ may be used as an address from which a corresponding binary representation of length N may be retrieved.

Additionally, or alternatively, a hash function, or some other suitable function implemented in hardware, may be used to map a binary representation of length N′ to an address from which a corresponding binary representation of length N may be retrieved.

Additionally, or alternatively, a binary representation of length N′ may be used to look up an intermediate value from a conversion table 750-i. The intermediate value may in turn be used to compute (e.g., in hardware) a corresponding binary representation of length N.

It should also be appreciated that aspects of the present disclosure are not limited to having multiple conversion tables. In some embodiments, a common conversion table may be used for each i=0, . . . , M−1.

The inventor has recognized and appreciated that a Boolean satisfiability solver may be used to select an encode function Enc and a parameter S such that all allowed input patterns are mapped by Enc into a pre-image of S under some suitable indicator function Ind. For instance, the indicator function Ind may be the illustrative indicator function Ind^{N} described in connection with the example of FIG. 7A, based on the illustrative parity check matrix H.

Referring again to the example of FIG. 6B, the Boolean satisfiability solver may, in some embodiments, be used to select a logical formula F, along with the encode function Enc and parameter S, such that all allowed input patterns are mapped by Enc into a union of intersection(s) of pre-image(s) and/or complement(s) thereof of Sⱼ under Indj (j=0, . . . , N−1).

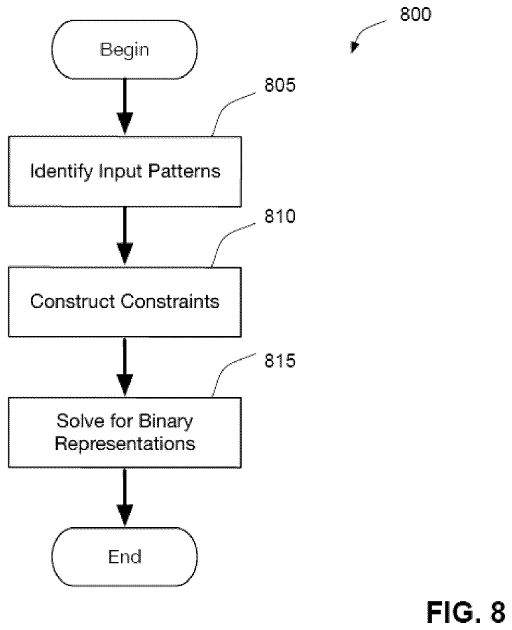

FIG. 8 shows an illustrative process 800 for selecting an encode function and a parameter, in accordance with some embodiments. Part or all of the process 800 may be performed at compile time, link time, and/or load time (e.g., by the illustrative policy compiler 220, the illustrative policy linker 225, and/or the illustrative loader 215 in the example of FIG. 2, respectively). Additionally, or alternatively, part or all of the process 800 may be performed at run time by the illustrative tag processing hardware 140 and/or the illustrative policy processor 150 in the example of FIG. 1. For instance, part or all of the process 800 may be performed when one or more policies being enforced are dynamically updated.

At act 805, some or all allowed input patterns may be identified. For instance, one or more input patterns may be identified that trigger one or more symbolic rules in one or more policies to be enforced. Such input patterns may include one or more input patterns corresponding to allowed instructions and/or one or more input patterns corresponding to explicitly disallowed instructions.

The inventor has recognized and appreciated that run time performance may not be of concern for disallowed instructions. Accordingly, in some embodiments, some or all input patterns corresponding to allowed instructions may be identified, whereas input patterns corresponding to explicitly disallowed instructions may not be included.

In some embodiments, all allowed input patterns may be identified, and a count of such input patterns may be obtained.

At act 810, one or more constraints may be constructed. Such a constraint may include a condition involving one or more variables. For instance, each metadata label L that appears in some input pattern identified at act 805 may be associated with MxN Boolean variable(s) c^{L}_{i,j}, where i=0, . . . , M−1, and j=0, . . . , N−1. If the metadata label L appears in input slot 0, then c^{L}_{0,0}, c^{L}_{0,N-1} may be used to construct one or more constraints. Likewise, if the metadata label L appears in input slot 1, then c^{L}_{1,0}, . . . , c^{L}_{1,N-1} may be used to construct one or more constraints, and so on.

Thus, for an input pattern P=<L₀, . . . , L_{M-1}>, there may also be M×N Boolean variable(s): c^{L_i}_{i,j}, i=0, . . . , M−1, and j=0, . . . , N−1. For instance, if a metadata label L appears in two different input slots (e.g., i and i′), different Boolean variables may be used (e.g., c^{L}_{i,0}, . . . , c^{L}_{i, N-1} and c^{L}_{i′,0}, . . . , c^{L}_{i′,N-1}, respectively).

Additionally, or alternatively, there may be V×N variable(s) s_{i,j}, where i=0, . . . , V−1, and j=0, . . . , N−1.

In some embodiments, a constraint may be constructed for each input pattern identified at act 805. As an example, given an input pattern P=<L₀, . . . , L_{M-1}>, N constraints may be constructed as follows: for each j=0, . . . , N−1,

Ind<c^{L_0}_{0,j}, . . . , c^{L_M-1}_{M-1,j}>=<s_{0,j}, . . . , s_{v-1,j}>,

where Ind is a suitable indicator function. Thus, for each j=0, . . . , N−1, the corresponding constraint may provide that an indicator computed from an assignment of the variable(s) c^{L_0}_{0,j}, . . . , c^{L_M-1}_{M-1, j} matches an assignment of the variable(s) s_{0,j}, . . . , s_{v-1,j}.

As described above, in some embodiments, an indicator function Ind may be provided based on a parity check matrix. For instance, for each j=0, . . . , N−1, the j-th constraint may be provided as follows:

H<c^{L_0}_{0,j}, . . . ,c^{L_M-1}_{M-1,j}>^{T}=<S_{0,j}, . . . ,s_{v-1,j}>^{T},

where the superscript T denotes matrix transpose (e.g., flipping a row vector into a column vector, or vice versa), and H is an V×M parity check matrix.

At act 815, a Boolean satisfiability solver may be used to solve for one or more of the Boolean variables subject to one or more of the constraints constructed at act 810. Any suitable Boolean satisfiability solver may be used, including, but not limited to, a satisfiability modulo theories (SMT) solver.

In some embodiments, a solution returned by the Boolean satisfiability solver may include, for each metadata label L that appears in some input pattern identified at act 805, and each i=0, . . . , M−1, an assignment of the variable(s) c^{L}_{i,0}, . . . , c^{L}_{i,N-1} to truth value(s). A bit string may be obtained by concatenation, and may be used as Encᵢ(L) for the metadata label L.

It should be appreciated that aspects of the present disclosure are not limited to having different encode functions Encᵢ for different input slots i. In some embodiments, a common encode function Enc may be used for all input slots. Thus, each metadata label L may be associated with N Boolean variable(s) c^{L}₀, . . . , c^{L}_{N-1}. For an input pattern P=<L₀, . . . , L_{M-1}>, there may be M×N Boolean variable(s): c^{L_i}ⱼ, i=0, . . . , M−1, and j=0, . . . , N−1. For each j=0, . . . , N−1, the j-th constraint may be provided as follows:

Ind<c^{L_0}ⱼ, . . . , c^{L_M-1}ⱼ>=<s_{0,j}, . . . , s_{v-1,j}>.

Accordingly, a solution returned by the Boolean satisfiability solver may include an assignment of the variable(s) c^{L}₀, . . . , c^{L}_{N-1} to truth value(s). A bit string may be obtained by concatenation, and may be used as Enc(L) for the metadata label L.

The inventor has recognized and appreciated that, by allowing different encode functions Encᵢ for different input slots i, more variables may be introduced (e.g., M×N variables c^{L}_{i,j} for each metadata label L, as opposed to just N variables c^{L}ⱼ). As a result, less restrictive constraints may be constructed at act 810, and a solution may be found more readily at act 815. However, as discussed above, aspects of the present disclosure are not limited to using different encode functions Encᵢ for different input slots i.

In some embodiments, a solution returned by the Boolean satisfiability solver may include, for each j=0, . . . , N−1, an assignment of the variable(s) s_{0,j}, . . . , s_{v-1,j} to truth value(s). A bit string may be obtained by concatenation, and may be used as Sⱼ of S=<S₀, . . . , S_{N-1}>.

It should be appreciated that aspects of the present disclosure are not limited to having a different Sⱼ for each bit lane j=0, . . . , N−1. In some embodiments, there may be only V variable(s) sᵢ, where i=0, . . . , V−1. For each j=0, . . . , N−1, the j-th constraint may be provided as follows:

Ind<c^{L-0}_{0,j}, . . . , c^{L_M-1}_{M-1,j}><s₀, . . . , sᵥ₋₁>.

Accordingly, a solution returned by the Boolean satisfiability solver may include an assignment of the variable(s) s₀, . . . , sᵥ₋₁ to truth value(s). A bit string may be obtained by concatenation, and may be used as the parameter S.

Additionally, or alternatively, there may be 2×V×N variables s_{i,j} and s′_{i,j}, where i=0, . . . , V−1, and j=0, . . . , N−1. For each j=0, . . . , N−1, the j-th constraint may be provided as follows:

(Ind<c^{L_0}_{0,j}, . . . , c^{L_M-1}_{M-1,j}>=<s₀, . . . , sᵥ₋₁>) or

(Ind<c^{L_0}_{0,j}, . . . , c^{L_M-1}_{M-1,j}>=<s′₀, . . . , s′ᵥ₋₁>).

Accordingly, a solution returned by the solver may include, for each j=0, . . . , N−1, an assignment of the variable(s) s_{0,j}, . . . , s_{v-1,j} to truth value(s), as well as an assignment of the variable(s) s′_{0,j}, . . . , s′_{v-1,j} to truth value(s). A bit string may be obtained by concatenation from the assignment of s_{0,j}, . . . , s_{v-1,j}, and may be used as Sⱼ of S=<S₀, . . . , S_{N-1}>. Likewise, a bit string may be obtained by concatenation from the assignment of s′_{c,j}, . . . , s′_{v-1,j}, and may be used as S′j of S′=<S′₀, . . . , S′_{N-1}>.

The inventor has recognized and appreciated that more variables (e.g., 2×V×N variables S_{i,j} and s′_{i,j}, or V×N variables s_{i,j}, as opposed to just V variables sᵢ) may result in less restrictive constraints at act 810, so that a solution may be found more readily at act 815. However, it should be appreciated that aspects of the present disclosure are not limited to using any particular number of variables.

For instance, in some embodiments, the process 800 may be repeated with different values of N (i.e., different lengths for binary representations of metadata labels). As an example, a small N (e.g., N=1, 2, 3, 4, 5, . . . ) may be used initially. If the Boolean satisfiability solver is unable to find a solution, N may be increased (e.g., by 1, 2, . . . ). With each such increase, more variables may be introduced, which may result in less restrictive constraints. This may be repeated until the Boolean satisfiability solver is able to find a solution.

Although certain details of implementation are described in connection with the example of FIG. 8, it should be appreciated that aspects of the present disclosure are not limited to any particular manner of implementation. For instance, aspects of the present disclosure are not limited to using a Boolean satisfiability solver. In some embodiments, one or more exact and/or approximate optimization techniques may be used. For example, a heuristic technique such as simulated annealing may be used to select an encode function Enc and a parameter S so as to increase one or more scores.

Moreover, aspects of the present disclosure are not limited to using a Boolean satisfiability solver to select both an encode function Enc and a parameter S. In some embodiments, an encode function may be selected in another suitable manner, and a Boolean satisfiability solver may be used to select a parameter S, or vice versa. Additionally, or alternatively, a Boolean satisfiability solver may be used to select an indicator function, for instance, by selecting an V×M matrix Hⱼ for each bit lane j=0, . . . , N−1.

The inventor has recognized and appreciated that, although there may be M input slot(s), an input pattern may be encountered that has fewer than M metadata label(s). For instance, an input slot may be used to present a metadata label associated with a storage location (e.g., a register or a memory location) accessed by an instruction, but not every instruction may access a storage location.

Accordingly, in some embodiments, there may be M×N variable(s) t_{i,j}, where i=0, . . . , M−1, and j=0, . . . , N−1. If an input slot i is empty in an input pattern, the variable(s) t_{i,0}, . . . , t_{i,N-1} may be used in constructing one or more constraints at act 810 in the example of FIG. 8.

Additionally, or alternatively, there may be N variable(s) tⱼ, where j=0, . . . , N−1. If any input slot is empty in an input pattern, the variable(s) t₀, . . . , t_{N-1} may be used in constructing one or more constraints at act 810 in the example of FIG. 8.

However, it should be appreciated that aspects of the present disclosure are not limited to having variables that represent an empty input slot. In some embodiments, a selected bit string (e.g., a bit string of N zeros) may be used to represent an empty input slot.

As discussed above, the illustrative constraints constructed at act 810 in the example of FIG. 8 may provide that, for each allowed input pattern P=<L₀, . . . , L_{M-1}>, an indicator computed from an assignment of the variable(s) c^{L_0}_{0,j}, . . . , C^{L_M-1}_{M-1,j} matches an assignment of the variable(s) s_{0,j}, . . . , s_{v-1,j} for bit lane j=0, . . . , N−1. Thus, a policy check function parameterized by Ind and S may provide correct answers for all binary representations of allowed input patterns. That is, given an allowed input pattern P, the policy check function parameterized by Ind and S may map Enc(P) to 1. As a result, the policy check function, when implemented by the illustrative tag processing hardware 140 in the example of FIG. 1, may allow every instruction that should be allowed according to one or more policies being enforced, and therefore may be thought of as a test with no false positive error (i.e., no allowed instruction being incorrectly flagged as a policy violation).

The inventor has recognized and appreciated that it may be desirable to prevent or reduce false negative errors (i.e., failing to flag disallowed instructions as policy violations), in addition to, or instead of, preventing or reducing false positive errors. For instance, it may be desirable to have a policy check function that disallows every instruction that should be disallowed. Stated differently, it may be desirable to have a policy check function that allows only those instructions that should be allowed.

Accordingly, in some embodiments, an evaluation function Eval may be provided based on one or more policies being enforced, such that, given an input pattern P=<L₀, . . . , L_{M-1}>, Eval (P)=1 if and only if an instruction giving rise to the input pattern P is allowed according to the one or more policies.

Accordingly, the following constraint may be provided at act 810 in the example of FIG. 8.

### Illustrative Constraint (6.a)

Eval(P)=(Ind(Enc(P))=S)

Then, at act 815, a Boolean satisfiability solver may be used to select Ind, Enc, and/or S subject to a conjunction of one or more instances of the illustrative constraints (6.a) (e.g., a conjunction over all P in a certain set of input patterns).

However, it should be appreciated that aspects of the present disclosure are not limited to using any particular constraint, or any constraint at all. For instance, as described in connection with the example of FIG. 6B, the policy check function may be parametrized by a logical formula F, in addition to the indicator function Ind and the parameter S. Accordingly, in some embodiments, the following constraint may be provided at act 810 in the example of FIG. 8.

### Illustrative Constraint (6.b)

```
Eval (P) = F (
  (Ind₀(bit_lane_0 (Enc(P))) = S₀),
  ...,
  (Ind_{N-1}(bit_lane_N−1(Enc(P))) = S_{N-1})
  )
```

Then, at act 815, a Boolean satisfiability solver may be used to select Ind, Enc, S, and/or F subject to a conjunction of one or more instances of the illustrative constraints (6.b) (e.g., a conjunction over all P in a certain set of input patterns).

In some embodiments, a type Labels may be provided in an input language of a Boolean satisfiability solver. As an example, Labels may be provided in a recursive manner based on one or more metadata type declarations in a policy language. For instance, Labels may include the empty metadata label { }. Additionally, or alternatively, for every metadata symbol A declared in the policy language, Labels may include a metadata label {A}.

Additionally, or alternatively, given a set W₁ of metadata labels for a first policy and a set W₂ of metadata labels for a second policy, Labels may include all metadata labels of the form L₁ ∪L₂, where L₁ is from X₁, L₂ is from X₂, and ∪ denotes set union.

In some embodiments, Labels may only include metadata labels that are either obtained from an initialization specification, or resulting from a rule.

In some embodiments, an evaluation function Eval: Labels^{M}→{0, 1} may be provided in an input language of a Boolean satisfiability solver. For instance, the function Eval may be provided based on one or more policies written in a policy language. As an example, a first policy may have a corresponding evaluation function Eval₁: Labels^{M}→{0, 1}, and a second policy may have a corresponding evaluation function Eval₂: Labels^{M}→{0, 1}. A combined evaluation function Eval may be provided as follows.

Eval(P)=Eval₁(P) and Eval₂(P)

As another example, a policy may include one or more policy rules R₀, R₁, . . . . Each policy rule R may be translated into a corresponding evaluation function Eval_{R}, and a combined evaluation function Eval may be provided as follows.

Eval(P)=Eval_{R_0}(P) or Eval_{R_1}(P) or . . .

Returning to the example of FIG. 8, a Boolean satisfiability solver may be used, at act 815, to select Ind, Enc, and/or S subject to a conjunction of one or more constraints of the following form.

Eval(P)=(Ind(Enc(P))=S)

In some embodiments, the conjunction of one or more constraints may be taken over all p in Labels^{M}. However, the inventor has recognized and appreciated that Labels^{M} may be a large set. As such, if the above constraint is to be satisfied for all p in Labels^{M}, the Boolean satisfiability solver may be less likely to find a solution, or it may take more processor cycles (e.g., more processor cores and/or more time) to do so.

Accordingly, in some embodiments, the conjunction of one or more constraints may be taken over all p in a subset of Labels^{M} (as opposed to Labels^{M} in its entirety). For instance, the inventor has recognized and appreciated that a significant number of metadata labels in Labels may not actually appear in any allowed input pattern. Accordingly, in some embodiments, a subset Labels′ of Labels may be provided that includes metadata labels appearing in one or more allowed input patterns, such as those identified at act 805 in the example of FIG. 8. The conjunction of one or more constraints may then be taken over all p in Labels′^{M}.

In some embodiments, an indicator function Ind: ({0, 1}^{M})^{N}→{0, 1} ^{V} may be provided in an input language of a Boolean satisfiability solver. As an example, the indicator function Ind may be provided as <Ind₀, . . . , Ind_{N-1}>, where each Indⱼ is provided based on the following equation:

Indⱼ(X)^{T}=HⱼX^{T}

In some embodiments, Hⱼ may be a variable for some bit lane j, so that a solution found by the Boolean satisfiability solver may include a matrix Hⱼ to be used to implement an indicator function Indⱼ for the bit lane j.

In some embodiments, an encode function Enc: Labels^{M}→({0, 1}^{N})^{M} may be provided in an input language of a Boolean satisfiability solver. As an example, the encode function Enc may be provided as <Enc₀, . . . , Enc_{M-1}>, where Encᵢ: Labels→{0, 1}^{N} may be a variable for some input slot i. Thus, a solution found by the Boolean satisfiability solver may include an encode function Encᵢ for the input slot i.

In some embodiments, a parameter s: ({0, 1}^{V})^{N} may be provided in an input language of a Boolean satisfiability solver. As an example, the parameter s may be provided as <S₀, . . . , S_{M-1}>, where Sⱼ: {0, 1}^{V} may be a variable for some bit lane j. Thus, a solution found by the Boolean satisfiability solver may include a parameter Sⱼ for the bit lane j.

The inventor has recognized and appreciated that, given an allowed input pattern P (which is in Labels′^{M}, defined similarly as Labels′^{M}), Eval(P) may be 1 by construction of Eval. The corresponding constraint may provide that (Ind(Enc(P))=S)=Eval(P)=1. As a result, Ind(Enc(P)) may match S, and a policy check function parameterized by Ind and S may map Enc(P) to 1. Hence, the policy check function may have no false positive error.

Conversely, given a disallowed input pattern P in Labels′^{M}, Eval(P) may be 0 by construction of Eval. The corresponding constraint may provide that (Ind(Enc(P))=S)=Eval(P)=0. As a result, Ind(Enc(P)) may not match S, and a policy check function parameterized by Ind and S may map Enc(P) to 0. Hence, the policy check function may have no false negative error in Labels′^{M}.

Although the inventor has recognized and appreciated various advantages of using an evaluation function, aspects of the present disclosure are not so limited. In some embodiments, a constraint for an allowed input pattern P may simply provide that Ind(Enc(P))=S, as described above.

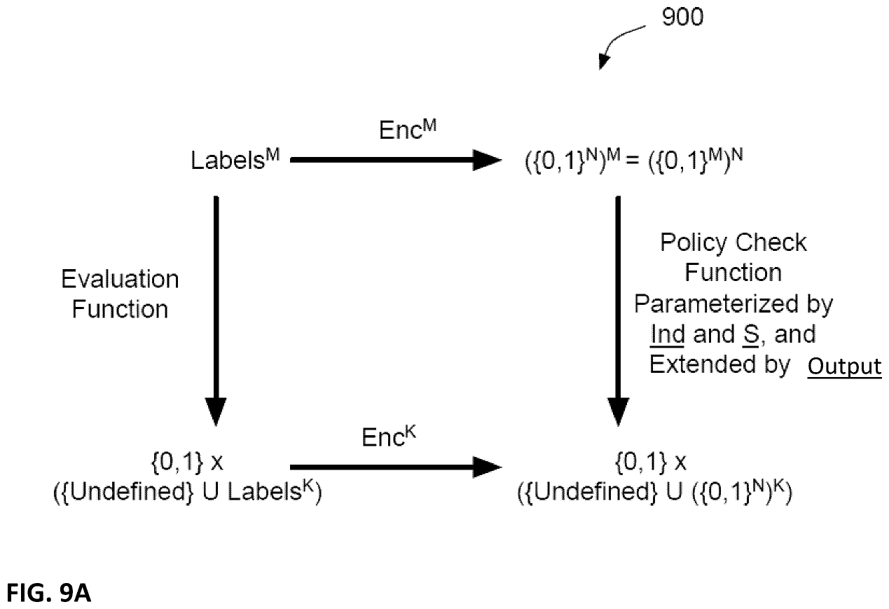

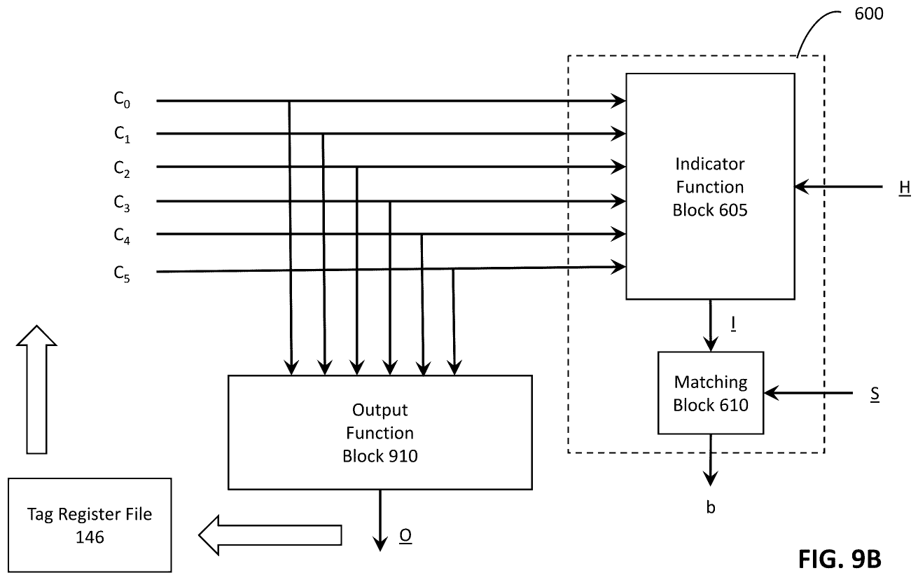

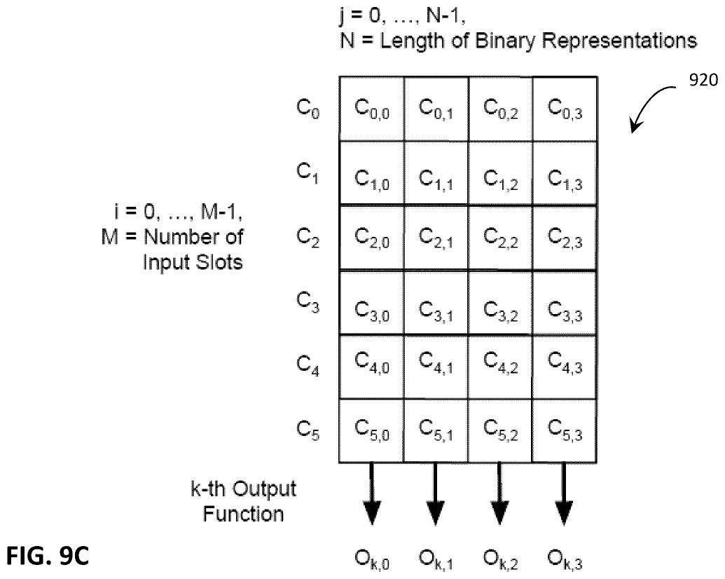

FIG. 9A shows an illustrative arrangement 900 of functions, in accordance with some embodiments. In this example, there are M input slots and K output slots. Accordingly, an input pattern may include up to M metadata labels, one for each input slot. A result may include one bit indicating whether an instruction giving rise to the input pattern is allowed. If the instruction is allowed, the result may also include an output pattern of up to K metadata labels, one for each output slot.

In some embodiments, the arrangement 900 may include an encode function Enc that maps input patterns to N-tuples of bit string(s) of length M. Thus, Enc may also be viewed as a function that maps input patterns to M-tuples of bit string(s) of length N. For instance, the encode function Enc may be Enc^{M} for some suitable Enc that maps metadata labels to bit strings of length N.

The inventor has recognized and appreciated that it may be desirable to extend a binary policy check function (e.g., as described in connection with the examples of FIGS. 6A-B, 7A-B, and 8) with an output function that maps an M-tuple of bit string(s) of length N (or an N-tuple of bit string(s) of length M) to a K-tuple of bit string(s) of length N, where each bit string in the K-tuple may encode an output metadata label.

In some embodiments, an output function may be a partial function. For instance, the output function may be undefined for all disallowed input patterns. Additionally, or alternatively, the output function may be undefined for one or more allowed input patterns (e.g., an input pattern corresponding to an allowed instruction without any metadata update).

In some embodiment, the illustrative evaluation function Eval described in connection with the example of FIG. 8 may be extended to output zero or more metadata labels. For instance, given an input pattern P=<L₀, . . . , L_{M-1}>, Eval(P) may include a pair of values. The first value may be a bit indicating whether an instruction giving rise to P is allowed. If the first value is 0 (indicating the instruction is disallowed), then the second value may be a default value, such as Undefined. If the first value is 1 (indicating the instruction is allowed), but there is no metadata update, then the second value may also be Undefined. On the other hand, if the first value is 1 (indicating the instruction is allowed), and there is at least one metadata update, then the second value may include an output pattern Q=<U₀, . . . , U_{K-1}>.

Referring to the example of FIG. 8, a Boolean satisfiability solver may be used, at act 815, to select Ind, Enc, and/or S subject to a conjunction of one or more constraints of the following form.

(Proj₀(Eval(P))=(Ind(Enc^{M}(P))=S)) and

(Enc^{K}(Proj₁(Eval(P)))=Output(Enc^{M}(P)))

Here Proj₀ and Proj₁ denote projection functions for ordered pairs. For instance, if Eval(P)=<b,Q>, then Proj₀(Eval(P))=b and Proj₁(Eval(P))=Q. Thus, the above constraint may also be written as follows.

### Illustrative Constraint (7)

(Eval(P)=<b,Q>) and

(b=(Ind(Enc^{M}(P))=S)) and

(Enc^{K}(Q)=Output(Enc^{M}(P)))

The inventor has recognized and appreciated that, in some instances, the above constraint may be restrictive, and it may be challenging to find a solution at act 815 in the example of FIG. 8.

The inventor has further recognized and appreciated that, because an output function may be undefined for all disallowed input patterns, the above constraint may be relaxed as follows.

### Illustrative Constraint (8)

(Eval(P)=<b,Q>) and

(b=(Ind(Enc^{M}(P))=S)) and

((not b) or (Enc^{K}(Q)=Output(Enc^{M}(P))))

This relaxed constraint does not require Enc^{K}(Q) to match Output (Enc^{M}(P)) if Ind(Enc^{M}(P)) does not match S. Thus, a solution may be found more readily, thereby improving performance and/or reducing resource consumption (e.g., power, memory, etc.).

It should also be appreciated that aspects of the present disclosure are not limited to using a Boolean satisfiability solver to select all of Ind, Enc, and S. Any one or more of these may be selected in another suitable manner. Additionally, or alternatively, one or more of the output functions Outputₖ(k=0, . . . , K−1) may treated as parameter(s), and a Boolean satisfiability solver may be used to select such an output function Outputₖ.

As described above, a Boolean satisfiability solver may, in some embodiments, search for a solution subject to a conjunction of constraints. For example, an individual constraint may be an instance of the illustrative constraint (7) or (8), and a conjunction may be taken over all p in Labels^{M} or a subset thereof (e.g., Labels′^{M}).

The inventor has recognized and appreciated that Labels^{M} (or, in some instances, even Labels′^{M}) may be a very large set. As such, a conjunction over all p in Labels^{M} (or Labels′^{M}) may be restrictive, and it may be challenging for a Boolean satisfiability solver to find a solution. Accordingly, in some embodiments, the conjunction of constraints may be taken over one or more allowed input patterns, such as those identified at act 805 in the example of FIG. 8. Since a set of allowed input pattern(s) may be much smaller than Labels^{M} (or Labels′^{M}), a solution may be found more readily at act 815 in the example of FIG. 8, thereby improving performance and/or reducing resource consumption (e.g., power, memory, etc.).

However, the inventor has recognized and appreciated that, if a conjunction is taken only over one or more allowed input patterns, one or more false negative errors may occur. Accordingly, in some embodiments, a solution found by a Boolean satisfiability solver may be validated to confirm whether there is any false negative error.

For instance, given a solution Ind, Enc, S, and Output, a set of encodings may be obtained by applying Enc to all labels in Labels. In some embodiments, the solution may have been found subject to an additional constraint that Enc is an injective function. Accordingly, there may be as many encodings of labels as there are labels in Labels.

Additionally, or alternatively, a pre-image of S under Ind may be identified. As described above, the pre-image of S under Ind may be a set of M-tuples <C₀, . . . , C_{M-1}> of bit string(s) of length N such that Ind(C₀, . . . , C_{M-1})=S, for some suitable M, N>=1.

The pre-image of S under Ind may be identified in any suitable manner. For instance, for each j=0, . . . , N−1, a pre-image of Sⱼ under Indⱼ may be identified. An element of the pre-image of S under Ind may be constructed as an array of bits similar to the illustrative array 650 in the example of FIG. 6B, using a sequence of bit string(s) <X₀, . . . , X_{N-1}>, where each Xⱼ is from the preimage of Sⱼ under Indⱼ.

In some embodiments, the pre-image of S under Ind may be filtered to remove one or more M-tuples. For instance, given an M-tuple <C₀, . . . , C_{M-1}> in the pre-image, each Cᵢ (i=0, . . . , M−1) may be examined to determine if Cᵢ=Enc(L) for some L in Labels. If, for any i=0, . . . , M−1, there is no L in Labels such that Cᵢ=Enc(L), then the M-tuple <C₀, . . . , C_{M-1}> may be removed.

The inventor has recognized and appreciated that, if Enc is a one-to-one function, then so is Enc^{M}. Thus, there may be as many encodings of allowed input patterns as there are allowed input patterns. Accordingly, once all M-tuples in the pre-image have been examined and filtered, a count of remaining M-tuples may be obtained and compared against a count of all allowed input patterns (e.g., as determined at act 805 in the example of FIG. 8). If the count of remaining M-tuples is greater than the count of all allowed input patterns, then there may be a false negative error, and the solution may be invalidated. Otherwise, the solution may be accepted.

It should be appreciated that aspects of the present disclosure are not limited to validating a solution in any particular manner, or at all. In some embodiments, a solution may be validated by iterating over one or more input patterns in Labels^{M}. For instance, given an input pattern P, Enc^{M}(P) may be computed and checked against S. If Enc^{M}(P) does not match S, then P may be skipped.

If, on the other hand, Enc^{M}(P) matches S, then Eval(P) may be computed. If Eval(P)=1, then a next input pattern P′ may be checked. Otherwise, the solution may be invalidated. If all input patterns have been checked successfully, then the solution may be accepted.

The inventor has recognized and appreciated that it may be computationally intensive to check all input patterns in Labels^{M}. Accordingly, in some embodiments, one or more heuristics may be used to reduce a number of input patterns to be checked.

For instance, it may be known that certain labels may never be presented in certain input slot(s), or may only be presented in the input slot(s). An input pattern with a metadata label appearing in an unexpected slot, or outside one or more expected slots, may be skipped.

In some embodiments, if a solution is invalidated, the Boolean satisfiability solver may be used to search for another solution. The new solution may be validated in a similar manner. This process may be repeated until a valid solution is found.

The inventor has recognized and appreciated that, if a binary policy check function and an output function are both readily computed in hardware, then an extended policy check function obtained therefrom may also be readily computed in hardware.

FIG. 9B shows an illustrative output function block 910, in accordance with some embodiments. In this example, the output function block 910 is configured to process input bit strings C₀, . . . , C₅ (which are also provided to the illustrative indicator function block 605 in the example of FIG. 6A). In some embodiments, the input bit strings C₀, . . . , C₅ may be output by the illustrative conversion block 750 in the example of FIG. 7B.

Thus, the output function block 910 may operate in parallel with the illustrative hardware block 600 in the example of FIG. 6A. Together, the hardware block 600 and the output function block 910 may implement an extended policy check function.

In some embodiments, the output function block 910 may process an M-tuple <C₀, . . . , C_{M-1}> of bit string(s) of length N, and may output a K-tuple <O₀, . . . , O_{K-1}> of bit string(s) of length N, for some suitable M, K>=1. An illustrative implementation of the output function block 910 is described below in connection with the example of FIG. 9C.

In some embodiments, the bit string(s) O₀, . . . , O_{K-1} may be stored in a register file, such as the illustrative tag register file 146 in the example of FIG. 1. Such a bit string Oₖ may be a binary representation of an output metadata label, which may subsequently be used as an input metadata label (e.g., to construct an input pattern for a subsequently executed instruction). Thus, the bit string Oₖ may be accessed from the tag register file 146, and may be provided to the indicator function block 605, the conversion block 750, and/or the output function block 910 as input.

FIG. 9C shows an illustrative array 920 of bits, in accordance with some embodiments. Like the illustrative array 650 in the example of FIG. 6B, the array 920 has M rows and N columns, where M is a number of input slots, and N is a length of binary representations. In this example, there are six input slots (i.e., M=6), and hence there are six rows. These rows may correspond, respectively, to bit strings C₀, . . . , C₅. Moreover, each bit string Cᵢ in this example is 4-bit long (i.e., N=4), and hence there are four columns.

In some embodiments, an output function Outputₖ (k=0, . . . , K−1) may be provided for each output slot k. The inventor has recognized and appreciated that, if each output function Outputₖ is readily computed in hardware, then a combined output function Output=<Output₀, . . . , Output_{K-1}> may also be readily computed in hardware. For instance, given K hardware blocks implementing, respectively, the output functions Output₀, . . . , Output_{K-1}, respectively (where K>1), the combined output function Output may be implemented simply by placing the K hardware blocks in parallel.

In some embodiments, an output function Outputs may compute, for each bit lane j in the array 920, an output bit O_{k,j}. Thus, the output function Outputₖ may map an M-tuple of bit string(s) of length N (i.e., C₀, . . . , C_{M-1}) to another bit string of length N. For instance, the output bit O_{k,j} may be computed by combining C_{0,j}, . . . , C_{M-1,j} with an exclusive OR (XOR) operator. Thus, the output bit O_{k,j} may be a parity bit for the bit string C_{0,j}: . . . : C_{M-1,j}.

It should be appreciated that aspects of the present disclosure are not limited to having multiple output slots. In some embodiments, K may be 1, so there may be only one output slot.

As discussed above, in some embodiments, if a binary policy check function maps an M-tuple of bit string(s) of length N to 0 (indicating that an instruction giving rise to the M-tuple is disallowed), an output function may map the M-tuple of bit string(s) of length N to Undefined. Thus, it may be desirable to compute the binary policy check function first. If the binary policy check function outputs 0, the output function may not be computed, which may lead to increased performance and/or reduced power consumption.

However, it should be appreciated that aspects of the present disclosure are not limited to computing a binary policy check function and an output function in any particular order. In some embodiments, an output function Output may be computed first, and a result of the output function Output may be used to look up a parameter S from a table stored in a selected memory (e.g., an on-chip RAM). The parameter S may then be compared against a result of an indictor function Ind to provide a result of the binary policy check function.

In this manner, different parameters S may be used for different output patterns, respectively. This may increase degrees of freedom, which may in turn increase a likelihood that a suitable solution may be found by a Boolean satisfiability solver. However, it should be appreciated that aspects of the present disclosure are not so limited.

The inventor has recognized and appreciated that, to reduce memory usage, it may be desirable to store binary representations of metadata labels in a compressed form (e.g., in the illustrative metadata memory 125 in the example of FIG. 1). However, the inventor has also recognized and appreciated that performing compression at run time may increase power consumption and/or decrease performance. Accordingly, in some embodiments, an output function may be used that outputs bit strings of length N′, for some N′<N.

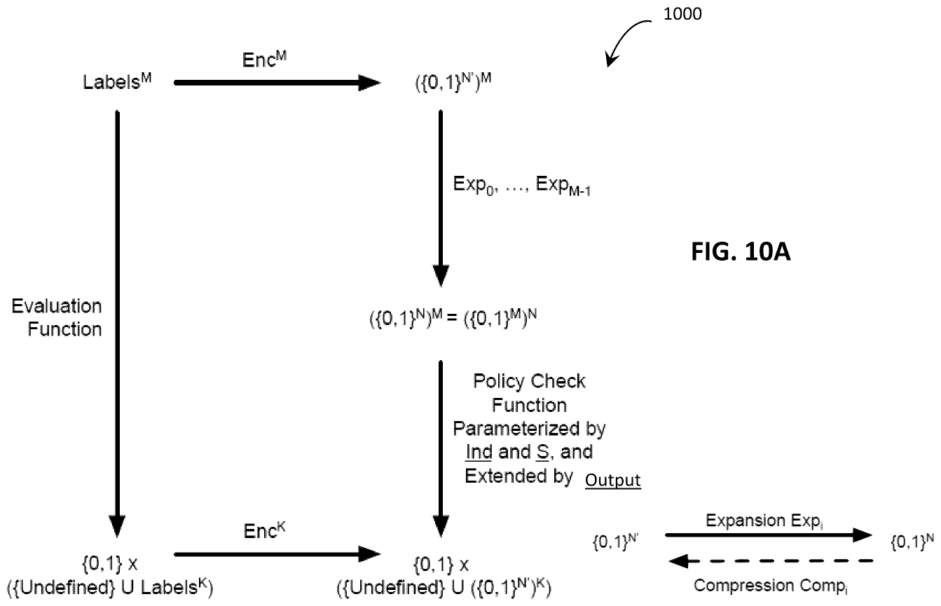

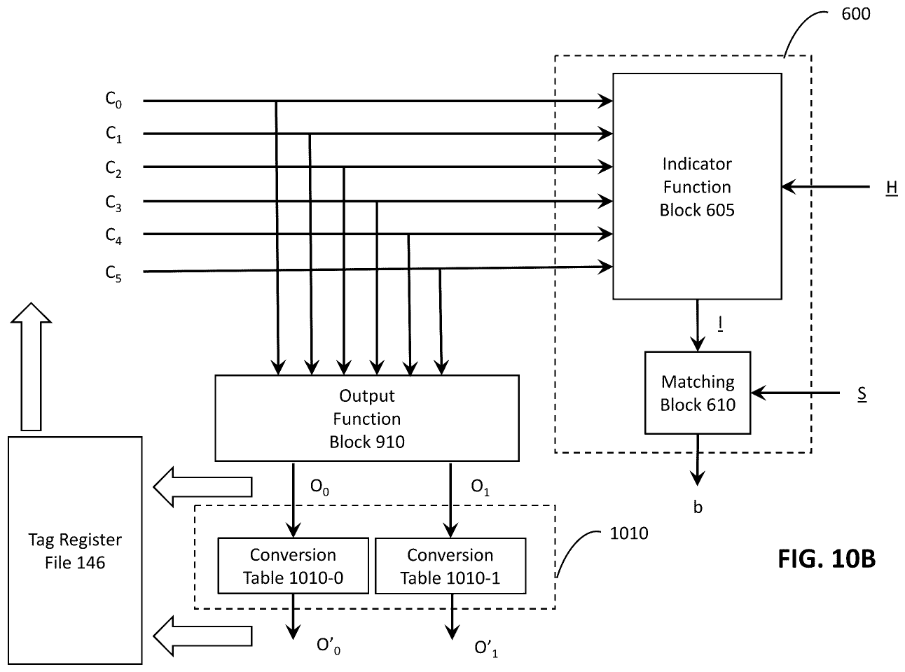

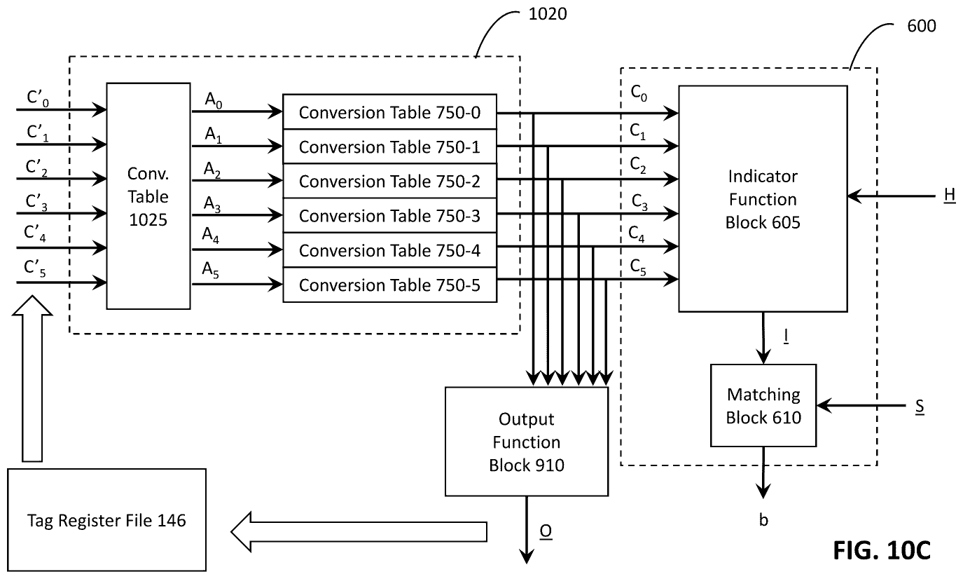

FIG. 10A shows an illustrative arrangement 1000 of functions, in accordance with some embodiments. In this example, an encode function Enc is provided as <Enc₀, . . . , Enc_{M-1}>, where each Encᵢ (i=0, . . . , M−1) may be Enc followed by Expᵢ, for some suitable encode function Enc and some suitable expansion function Expᵢ. For instance, each expansion function Expᵢ may be implemented by a conversion table that maps bit strings of length N′ to bit strings of length N, for some N′<N (e.g., as described in connection with the example of FIG. 7B).

In some embodiments, an output function Output may output a bit string of length N′, instead of length N. For instance, each bit string Cᵢ may be four bytes long (i.e., N=32), and there may be four output functions Outputₖ (k=0, . . . , 3), each outputting a bit string of length N′=8, instead of length N=32.

Such an output function Outputₖ may be implemented in any suitable manner. For instance, an output function Outputs may compute parity bit(s) for only a subset of bit lane(s). As an example, an output bit Oⱼ may be computed for each bit lane j by combining C_{0,j}, . . . , C_{M-1,j} with an exclusive OR (XOR) operator, and Output₀ may output O₀: . . . : O₇, Output₁ may output O₈: . . . : O₁₅, Output₂ may output O₁₆: . . . : O₂₃, and Output₃ may output O₂₄: . . . : O₃₁. Thus, each output function Outputₖ may compute parity bits for one of the four bytes of Cᵢ (i=0, . . . , M−1).

It should be appreciated that aspects of the present disclosure are not limited to partitioning bit lanes in any particular manner, or at all. In some embodiments, two output functions may be based on, respectively, two overlapping sets of one or more bit lanes. Indeed, two output functions may be based on a common set of one or more bit lanes, but may manipulate such input bits differently to produce different output bits. Additionally, alternatively, two output functions may be based on, respectively, two sets having different numbers of bit lanes.

It should also be appreciated that aspects of the present disclosure are not limited to implementing output functions in any particular manner, or at all. In some embodiments, one or more of the output function(s) Outputₖ (k=0, . . . , K−1) may treated as parameter(s), and a Boolean satisfiability solver may be used to select such an output function Outputₖ.

Referring again to the example of FIG. 8, a Boolean satisfiability solver may be used, at act 815, to select Ind, Enc, S, and/or Output subject to a conjunction of one or more constraints of the following form.

(Proj₀(Eval(P))=(Ind(Exp(Enc^{M}(P)))=S)) and

(Enc^{k}(Proj₁(Eval(P)))=Output(Exp(Enc^{M}(P))))

The above constraint may also be written as follows.

(Eval(P)=<b,Q>) and

(b=(Ind(Exp(Enc^{M}(P)))=S)) and

(Enc^{K}(Q)=Output(Exp(Enc^{M}(P))))

Here Exp denotes expansion function(s)<Exp₀, . . . , Exp_{M-1}>, for example, as described in connection with the example of FIG. 7B.

For reasons similar to those explained in connection with the example of FIG. 9A, the above constraint may be relaxed as follows.

(Eval(P)=<b,Q>) and

(b=(Ind(Exp(Enc^{M}(P)))=S)) and

((not b) or (Enc^{K}(Q)=Output(Exp(Enc^{M}(P)))))

However, it should be appreciated that aspects of the present disclosure are not limited to using any particular relaxed constraint, or any relaxed constraint at all.

As described in connection with the example of FIG. 9A, a conjunction of constraints may, in some embodiments, be taken over one or more allowed input patterns, and a resulting solution may be validated to confirm whether there is any false negative error.

It should be appreciated that aspects of the present disclosure are not limited to using a Boolean satisfiability solver to select all of Ind, Enc, S, and Output. Any one or more of these may be selected in another suitable manner. Additionally, or alternatively, one or more of the expansion function(s) Expᵢ (i=0, . . . , M−1) may be treated as parameter(s). For instance, for some i=0, . . . , M−1, the expansion function Expᵢ may be provided as a variable in an input language of a Boolean satisfiability solver, so that a solution found by the Boolean satisfiability solver may include a solution for Expᵢ.

It should also be appreciated that aspects of the present disclosure are not limited to using an expansion function Expᵢ for every input slot i, or for any input slot i. The inventor has recognized and appreciated that, for some input slot i and/or corresponding output slot k, binary representations of metadata labels may remain in a register (e.g., in the illustrative tag register file 146 in the example of FIG. 1), without ever being written to any memory. Thus, in some embodiments, for such an input slot i and/or corresponding output slot k, an encode function may be used that maps metadata labels to binary representations of length N, as opposed to length N′.

The inventor has recognized and appreciated that, in some instances, multiple allowed input patterns may be mapped to a common output pattern. Thus, a number of possible allowed input patterns may be greater than a number of possible output patterns.

The inventor has further recognized and appreciated that if two different input patterns P₀ and P₁ are similar (e.g., differing only by one metadata label), a Boolean satisfiability solver may, in some instances, be unable to find a solution for an evaluation function Eval such that Eval(P₀)=Eval(P₁).

Accordingly, in some embodiments, a conversion block may be provided to convert bit strings of length N for one or more output slots k, k=0, . . . , K. This may increase degrees of freedom, which may in turn increase a likelihood that a suitable solution may be found by a Boolean satisfiability solver. However, it should be appreciated that aspects of the present disclosure are not so limited.

FIG. 10B shows an illustrative conversion block 1010, in accordance with some embodiments. For instance, the conversion block 1010 may be used to convert a K-tuple <O₀, . . . , O_{K-1}> of bit string(s) of length N to a K-tuple <O′₀, . . . , O′_{K-1}> of bit string(s) of length N′, for some suitable K, N, N′>=1.

In some embodiments, N′ may be strictly less than N, so that the conversion block 1010 may be a compression block. For instance, the compressed bit strings O′₀, . . . , O′_{K-1} may be stored in a metadata memory (e.g., the illustrative metadata memory 125 in the example of FIG. 1), which may reduce memory usage. However, it should be appreciated that aspects of the present disclosure are not so limited. In some embodiments, N′ may be strictly greater than, or equal to, N.

In the example of FIG. 10B, the K-tuple <O₀, . . . , O_{K-1}> is output by the illustrative output function block 910 in the example of FIG. 9B. The output function block 910 may receive an input pattern <C₀, . . . , C_{M-1}> for some suitable M>=1, where each input bit string may be of length N.

In some embodiments, the conversion block 1010 may include a conversion table 1010-k for each k=0, . . . , K−1. Such a conversion table may be similarly implemented as the illustrative conversion table(s) 750−i (i=0, . . . , M−1) in the example of FIG. 7B.

Referring again to the example of FIG. 8, a Boolean satisfiability solver may be used, at act 815, to select Ind, Enc, S, Exp, and/or O subject to a conjunction of one or more constraints of the following form.

(Proj₀(Eval(P))=(Ind(Exp(Enc^{M}(P)))=S)) and

(Enc^{k}(Proj₁(Eval(P)))=Com(Output(Exp(Enc^{M}(P)))))

This constraint may also be written as follows.

(Eval(P)=<b,Q>) and

(b=(Ind(Exp(Enc^{M}(P)))=S)) and

(Enc^{k}(Q)=Com(Output(Exp(Enc^{M}(P)))))

Here Exp denotes expansion function(s)<Exp₀, . . . , Exp_{M-1}>, for example, as described in connection with the example of FIG. 7B, whereas Com denotes compression function(s) <Com₀, . . . , Com_{K-1}> that each map bit strings of length N to bit strings of length N′.

For reasons similar to those explained in connection with the example of FIG. 9A, the above constraint may be relaxed as follows.

(Eval(P)=<b,Q>) and

(b=(Ind(Exp(Enc^{M}(P)))=S)) and

((not b) or (Enc^{K}(Q)=Com(Output(Exp(Enc^{M}(P))))))

However, it should be appreciated that aspects of the present disclosure are not limited to using any particular relaxed constraint, or any relaxed constraint at all.

As described in connection with the example of FIG. 9A, a conjunction of constraints may, in some embodiments, be taken over one or more allowed input patterns, and a resulting solution may be validated to confirm whether there is any false negative error.

It should be appreciated that aspects of the present disclosure are not limited to using a Boolean satisfiability solver to select all of Ind, Enc, S, Output, and Exp. Any one or more of these may be selected in another suitable manner. Additionally, or alternatively, one or more of the compression function(s) Comₖ (k=0, . . . , K−1) may be treated as parameter(s). For instance, for some k=0, . . . , K−1, the compression function Comₖ may be provided as a variable in an input language of a Boolean satisfiability solver, so that a solution found by the Boolean satisfiability solver may include a solution for Comₖ. Such a solution may then be implemented by the conversion block 1010.

It should also be appreciated that aspects of the present disclosure are not limited to implementing a conversion table in any particular manner, or at all. For instance, for some input slot i and/or corresponding output slot k, binary representations of metadata labels may remain in a register (e.g., in the illustrative tag register file 146 in the example of FIG. 1), without ever being written to any memory. Thus, in some embodiments, for such an input slot i and/or corresponding output slot k, an encode function may be used that maps metadata labels to binary representations of length N, as opposed to length N′. As such, no compression block may be used following the output function block 910.

FIG. 10C shows an illustrative conversion block 1020, in accordance with some embodiments. For instance, the conversion block 1020 may be similar to the illustrative conversion block 750 in the example of FIG. 7B, except the conversion table(s) 750-i (i=0, . . . , M−1, M>=1) may be preceded by another conversion table 1025. Additionally, or alternatively, the M-tuple <C₀, . . . , C_{M-1}> output by the conversion block 1025 may be provided to the illustrative output function block 910 in the example of FIG. 9B.

In some embodiments, the conversion table 1025 may be configured to convert an M-tuple <C′₀, . . . , C′_{M-1}> of bit string(s) of length N to an M-tuple <A₀, . . . , A_{M-1}> of bit string(s) of length N′, for some suitable N, N′>=1. Such a conversion table may be similarly implemented as the conversion table(s) 750-i (i=0, . . . , M−1).

In some embodiments, N′ may be strictly less than N, so that the conversion table 1025 1010 may be a compression table. However, it should be appreciated that aspects of the present disclosure are not so limited. In some embodiments, N′ may be strictly greater than, or equal to, N.

Referring again to the example of FIG. 8, a Boolean satisfiability solver may be used, at act 815, to select Ind, Enc, S, Exp, and/or Output subject to a conjunction of one or more constraints of the following form.

(Proj₀(Eval(P))=(Ind(Exp(Com(Enc^{M}(P))))=S)) and

(Enc^{K}(Proj₁(Eval(P)))=Output(Exp(Enc^{M}(P))))

This constraint may also be written as follows.

(Eval(P)=<b,Q>) and

(b=(Ind(Exp(Com(Enc^{M}(P))))=S)) and

(Enc^{K}(Q)=Output(Exp(Enc^{M}(P))))

Here Exp denotes expansion function(s)<Exp₀, . . . , Exp_{M-1}>, for example, as described in connection with the example of FIG. 7B, whereas Com denotes a compression function that each map bit strings of length N to bit strings of length N′.

For reasons similar to those explained in connection with the example of FIG. 9A, the above constraint may be relaxed as follows.

(Eval(P)=<b,Q>) and

(b=(Ind(Exp(Com(Enc^{M}(P))))=S)) and

((not b) or (Enc^{K}(Q)=Output(Exp(Enc^{M}(P)))))

However, it should be appreciated that aspects of the present disclosure are not limited to using any particular relaxed constraint, or any relaxed constraint at all.

As described in connection with the example of FIG. 9A, a conjunction of constraints may, in some embodiments, be taken over one or more allowed input patterns, and a resulting solution may be validated to confirm whether there is any false negative error.

It should be appreciated that aspects of the present disclosure are not limited to using a Boolean satisfiability solver to select all of Ind, Enc, S, Output, and Exp. Any one or more of these may be selected in another suitable manner. Additionally, or alternatively, the compression function Com may be treated as a parameter. For instance, the compression function Com may be provided as a variable in an input language of a Boolean satisfiability solver, so that a solution found by the Boolean satisfiability solver may include a solution for Com. Such a solution may then be implemented by the conversion table 1025.

The inventor has recognized and appreciated that degrees of freedom may be increased by inserting a compression function (e.g., the conversion table 1025) followed by an expansion function (e.g., one of the conversion table(s) 750-i, i=0, . . . , M−1) into a data path of metadata labels. This may in turn increase a likelihood that a suitable solution may be found by a Boolean satisfiability solver.

For instance, two different bit strings O and O′ of length N may be mapped by the conversion table 1025 to a common bit string A of length N′. This may allow the output function block 910 to use O and O′ as different binary representations of a common metadata label.

However, it should be appreciated that aspects of the present disclosure are not limited to using any particular conversion block, or any conversion block at all.

The inventor has recognized and appreciated that, in some instances, a common allowed input pattern may correspond to different output patterns. For example, if an instruction giving rise to the input pattern is of a first type (e.g., arithmetic operation), the input pattern may be mapped to a first output pattern. By contrast, if an instruction giving rise to the input pattern is of a second type (e.g., load) different from the first type, the input pattern may be mapped to a second output pattern different from the first output pattern.

Accordingly, in some embodiments, there may be different output functions for different instruction types, respectively. A set of one or more constraints similar to those described above may be provided for each instruction type, and a solution returned by a Boolean satisfiability solver may satisfy all such constraints. At run time, instruction type information may be used to select a hardware component implementing an appropriate output function.

Additionally, or alternatively, each output function Output′ associated with a given instruction type may be obtained as a common output function Output followed by a suitable operation (e.g., XOR) that applies one or more selected salt values associated with the instruction type. Thus, at run time, instruction type information may be used to select one or more salt values to be applied to a result of the common output function.

However, it should be appreciated that aspects of the present disclosure are not limited to having different output functions for different instruction types. In some embodiments, an input slot may be provided for presenting a metadata label indicative of an instruction type. For instance, with reference to the example of FIG. 7B, an encoding of a metadata label indicative of an instruction type may be presented as input Aᵢ for some i=0, . . . , M−1. In this manner, given input patterns P and P′ that differ only at the i-th input, P and P′ may be mapped to different output patterns.

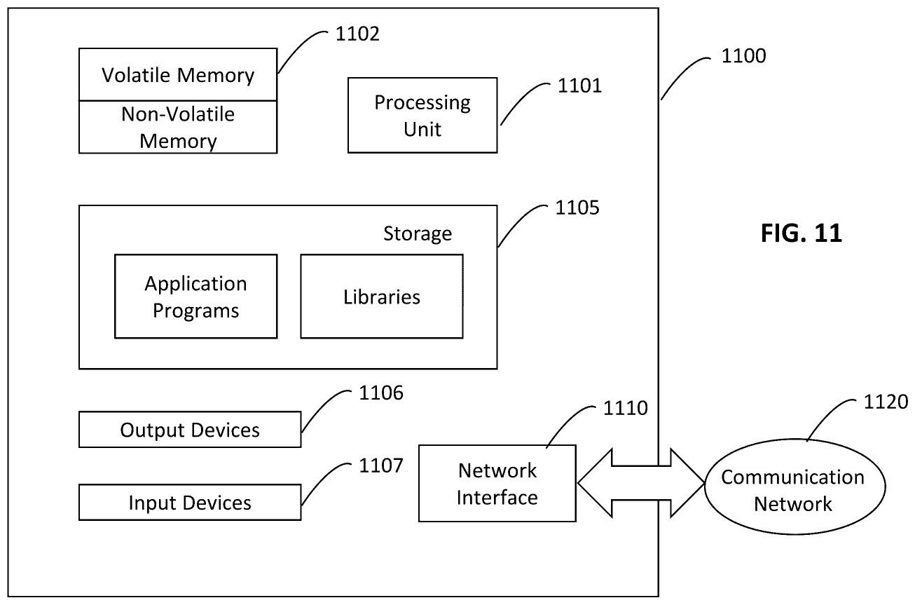

FIG. 11 shows, schematically, an illustrative computer 1100 on which any aspect of the present disclosure may be implemented. In the example of FIG. 11, the computer 1100 includes a processing unit 1101 having one or more processors and a computer-readable storage medium 1102 that may include, for example, volatile and/or non-volatile memory. The memory 1102 may store one or more instructions to program the processing unit 1101 to perform any of the functions described herein. The computer 1100 may also include other types of computer-readable medium, such as storage 1105 (e.g., one or more disk drives) in addition to the system memory 1102. The storage 1105 may store one or more application programs and/or resources used by application programs (e.g., software libraries), which may be loaded into the memory 1102.

The computer 1100 may have one or more input devices and/or output devices, such as output devices 1106 and input devices 1107 illustrated in FIG. 11. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 1107 may include a microphone for capturing audio signals, and the output devices 1106 may include a display screen for visually rendering, and/or a speaker for audibly rendering, recognized text.

In the example of FIG. 11, the computer 1100 may also include one or more network interfaces (e.g., network interface 1110) to enable communication via various networks (e.g., communication network 1120). Examples of networks include local area networks (e.g., an enterprise network), wide area networks (e.g., the Internet), etc. Such networks may be based on any suitable technology, and may operate according to any suitable protocol. For instance, such networks may include wireless networks and/or wired networks (e.g., fiber optic networks).

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer, or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple non-transitory computer-readable media) (e.g., a computer memory, one or more floppy discs, compact discs, optical discs, magnetic tapes, flash memories, circuit configurations in field-programmable gate arrays or other semiconductor devices, or other tangible computer-readable media) encoded with one or more programs that, when executed on one or more processors, perform methods that implement the various embodiments of the present disclosure described above. The computer-readable medium or media may be transportable, such that the program or programs stored thereon may be loaded onto one or more different computers or other processors to implement various aspects of the present disclosure as described above.

The terms “program” or “software” are used herein to refer to any type of computer code or set of computer-executable instructions that may be employed to program one or more processors to implement various aspects of the present disclosure as described above. Moreover, it should be appreciated that according to one aspect of this embodiment, one or more computer programs that, when executed, perform methods of the present disclosure may not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium that convey how the fields are related. However, any suitable mechanism may be used to relate information in fields of a data structure, including through the use of pointers, tags, or other mechanisms that how the data elements are related.

Various features and aspects of the present disclosure may be used alone, in any combination of two or more, or in a variety of arrangements not specifically discussed in the foregoing, and are therefore not limited to the details and arrangement of components set forth in the foregoing description or illustrated in the drawings. For example, aspects described in one embodiment may be combined in any manner with aspects described in other embodiments.

Also, the techniques disclosed herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

What is claimed is:

1. A method comprising acts of:
in response to receiving a compartment update request, determining, by compartment check hardware, a target compartment of a compartment transition triggering the compartment update request; and
loading, by the compartment check hardware, a compartment configuration corresponding to the target compartment, wherein the compartment configuration indicates at least one address range associated with the target compartment.

2. The method of claim 1, wherein:
the target compartment of the compartment transition is determined at least in part by:
determining, based on the compartment update request, a local identifier of the target compartment relative to a source compartment of the compartment transition; and
using a compartment configuration corresponding to the source compartment to map the local identifier of the target compartment to a global identifier of the target compartment, wherein:
the compartment configuration corresponding to the target compartment is loaded based on the global identifier of the target compartment.

3. The method of claim 2, wherein:
the global identifier of the target compartment comprises a memory address at which the compartment configuration corresponding to the target compartment is stored.

4. The method of claim 1, wherein:
the at least one address range associated with the target compartment comprises at least one address range that an instruction executing in the target compartment is allowed to access.

5. The method of claim 1, wherein:
the compartment transition comprises a branch instruction;
the target compartment of the compartment transition is determined at least in part by:
determining, based on the compartment update request, a target address of the branch instruction; and
matching the target address of the branch instruction to the target compartment.

6. The method of claim 1, wherein:
the compartment update request is received from tag processing hardware configured to check instructions executed by a host system; and
the method further comprises acts of, by the tag processing hardware:
detecting the compartment transition, at least in part by determining that an instruction executed by the host system represents a transfer of control from a source compartment to the target compartment; and
issuing the compartment update request in response to detecting the compartment transition.

7. The method of claim 6, wherein:
the tag processing hardware determines that the instruction represents a transfer of control at least in part by determining that the instruction matches at least one rule of a compartmentalization policy.

8. The method of claim 7, wherein:
the compartmentalization policy comprises a compartment entry rule and/or a compartment exit rule.

9. The method of claim 7, wherein:
the method further comprises an act of constructing, by the tag processing hardware, an input pattern based on metadata selected from a group consisting of:
an instruction type of the instruction; and
metadata associated with the instruction;
the input pattern is used to determine whether the instruction matches at least one rule of the compartmentalization policy.

10. The method of claim 1, wherein:
the method further comprises an act of determining whether the compartment transition is allowed; and
the act of loading the compartment configuration corresponding to the target compartment is performed in response to determining that the compartment transition is allowed.

11. The method of claim 10, wherein:
the act of determining whether the compartment transition is allowed comprises determining whether a compartment transition graph includes a transition from a source compartment of the compartment transition to the target compartment of the compartment transition.

12. The method of claim 1, wherein:
the compartment configuration corresponding to the target compartment is loaded prior to receiving the compartment update request; and
the method further comprises acts of:
predicting, by the compartment check hardware, one or more compartment configurations that are likely to be encountered;
loading, by the compartment check hardware, the one or more predicted compartment configurations; and
determining, by the compartment check hardware, whether any of the one or more predicted compartment configurations is associated with the target compartment of the compartment transition triggering the compartment update request.

13. The method of claim 1, further comprising acts of:
in response to receiving a compartment check request, determining, by the compartment check hardware, a memory address associated with an instruction triggering the compartment check request;
determining, by the compartment check hardware, based on a current compartment configuration, one or more address ranges; and
checking the memory address associated with the instruction triggering the compartment check request against the one or more address ranges determined based on the current compartment configuration.

14. The method of claim 13, wherein:
the memory address associated with the instruction comprises a memory address from which the instruction is fetched; and
the memory address from which the instruction is fetched is checked against a code address range in the current compartment configuration.

15. The method of claim 13, wherein:
the memory address associated with the instruction comprises a memory address that the instruction is attempting to access; and
the memory address that the instruction is attempting to access is checked against a data address range in the current compartment configuration.

16. The method of claim 1, wherein:
the compartment update request comprises a first compartment update request; and
the method further comprises acts of:
determining, based on a second compartment update request, information relating to an address range that is dynamically allocated for a compartment to which the second compartment update request pertains; and
using the information relating to the address range to update a compartment configuration for the compartment to which the second compartment update request pertains.

17. The method of claim 18, wherein:
the information relating to the address range comprises a start address, an end address, and/or a size of the address range.

18. The method of claim 16, wherein:
the second compartment update request is triggered as a result of a host system executing a runtime library function allocating the address range for the compartment to which the second compartment update request pertains;
the runtime library function presents the information relating to the address range on a data bus of the host system; and
the act of determining the information relating to the address range comprises, in response to the second compartment update request, capturing the information relating to the address range from the data bus of the host system.

19. The method of claim 1, wherein:
the compartment update request is sent by a host processor as a result of executing one or more instructions in a source compartment, the one or more instructions configured to cause the host processor to provide, to the compartment check hardware, a global identifier for a source compartment of the compartment transition, a global identifier for the target compartment of the compartment transition, and/or a local identifier for the target compartment relative to the source compartment.

20. A system comprising processing hardware, wherein:
the processing hardware comprises compartment check hardware implemented by one or more processors programmed by executable instructions, one or more programmable logic devices programmed by bitstreams, and/or one or more logic circuits fabricated into semiconductors; and
the compartment check hardware is configured to:
in response to receiving a compartment update request, determine a target compartment of a compartment transition triggering the compartment update request;
load a compartment configuration corresponding to the target compartment, wherein the compartment configuration indicates at least one address range associated with the target compartment.
